(19) United States
(12) Patent Application Publication
(10) Pub. No.: US 2019/0278102 A1
(43) Pub. Date: Sep. 12, 2019

(54) OPTICAL DEVICE FOR ENHANCING RESOLUTION OF AN IMAGE USING MULTISTABLE STATES

(71) Applicant: OPTOTUNE AG, Dietikon (CH)

(72) Inventors: Marcel SUTER, Zurich (CH); Manuel ASCHWANDEN, Allenwinden (CH); David NIEDERER, Kuttigen (CH); Damian SCHNEIDER, Winterthur (CH); Matthias WALSER, Zurich (CH); Roman PATSCHEIDER, Winterthur (CH); Stephan SMOLKA, Zurich (CH)

(73) Assignee: OPTOTUNE AG, Dietikon (CH)

(21) Appl. No.: 16/320,487

(22) PCT Filed: Jul. 25, 2017
(86) PCT No.: PCT/EP2017/068763

§ 371 Date: Jan. 25, 2019

(30) Foreign Application Priority Data
Jul. 25, 2016 (EP) 16181121.1
Oct. 19, 2016 (EP) 16194487.1

(51) Int. Cl. G02B 27/64; G02B 26/08; H04N 5/349

(52) U.S. Cl. CPC G02B 27/646; H02K 41/0354; H04N 5/349; G02B 26/0875

(57) ABSTRACT

The invention relates to an optical device (1) (e.g. for enhancing the resolution of an image), comprising: a transparent plate member (55) configured for refracting a light beam (L) passing through the plate member (55), which light beam (L) projects an image comprised of rows and columns of pixels (40), and a carrier (30) to which said transparent plate member (55) is rigidly mounted, wherein the carrier (30) is configured to be moved between a first and a second state, whereby said projected image (30) is shifted by a fraction (ΔP) of a pixel, particularly by a half of a pixel, along a first direction (x). According to the invention, the carrier (30) is configured to be multistable (e.g. bistable or tristable), wherein said first and said second state are stable states of the multistable (e.g. bistable or tristable)carrier (30), and wherein the optical device (1) comprises an actuator means (66) that is configured to force or initiate a transition of the carrier (30) from the first stable state to the second stable state and vice versa.

The present invention relates to an optical device for enhancing resolution of an image according to claim 1.

Such an optical device usually comprises a transparent plate member (e.g. glass window) configured for refracting a light beam passing through the plate member, which light beam can project an image comprised of rows and columns of pixels, as well as a carrier to which said transparent plate member is rigidly mounted, wherein the carrier is configured to be tilted between a first and a second position about a first axis, such that the plate member is tilted back and forth between the first and the second position about the first axis, whereby said light beam is shifted (e.g. said projected image is shifted by a fraction of a pixel (usually by a half of a pixel) along a first direction). The device further comprises an actuator means that is configured to tilt the carrier and therewith the plate member between the first and the second position about said first axis. Optical devices of this kind are for instance disclosed in U.S. Pat. No. 7,279,812 as well as in U.S. Pat. No. 5,402,184.

The afore-mentioned enhancement of an image by overlapping of pixels is also known as super resolution projection or imaging. Here, e.g. a temporal sequence of frames is split into two sub-frames, wherein to successive sub-frames may be displaced with respect to each other by a fraction of a pixel (e.g. one-half or one-third). The sub-frames are projected in a sufficiently fast manner so that they appear to the human eye as if they are being projected simultaneously and superimposed. For instance, in case the sub-frames are aligned such that the corners of the pixels in one sub-frame are projected on the centers of the next sub-frame and so on, the illusion of a resolution can be achieved that seems twice as high. These kind of pixel shifting can be performed in one dimension (e.g. shifting in x-direction), but may also be performed in two dimensions (2D), e.g. shifting in x-as well as in y-direction of the image (i.e. shifting along the rows and columns of the digital image or shifting the pixel diagonally).

Based on the above the problem underlying the invention is to provide an improved optical device for generating such a super resolution image which requires only a relatively small amount of energy for pixel shifting.

This problem is solved by an optical device having the features of claim 1. According thereto, an optical device for enhancing the resolution of an image is disclosed, comprising:
a transparent plate member configured for refracting a light beam passing through the plate member, which light beam may project an image comprised of rows and columns of pixels,
a carrier to which said transparent plate member is rigidly mounted, wherein the carrier is configured to be moved between at least a first and a second state, whereby said light beam is shifted e.g. along a first direction (e.g. said projected image is shifted by a fraction of a pixel, particularly by a half of a pixel along the first direction),
wherein the carrier is configured to be multistable (e.g. bistable, tristable or quadristable), wherein said first and said second state are stable states of the mutltistable (e.g. bistable or tristable) carrier, and wherein the optical device comprises an actuator means that is configured to force or initiate a transition of the carrier from the first stable state to the second stable state (or between any two stable states of the multistable carrier) and vice versa.

Of course, in case of a tristable carrier (see also below) any transition between the three stable states (first, second and third stable state) may be possible in an embodiment (e.g. forced or initiated by the actuator means).

Particularly, the actuator means may comprise a clamping means for holding the carrier in the first or second stable state (or any other stable state of a multistable carrier) as well as a disengaging means for overcoming the effect of the clamping means so that a transition between the first and the second stable state is triggered.

The actuator means may further comprise a rest position defining means for defining a rest position of the carrier in the first or second stable state. Further, in certain embodiments it is also possible to have four stable states and corresponding rest positions, wherein the rest position defining means is than configured to define corresponding rest positions for the four stable states. Particularly, the rest position defining means are configured to provide/generate supporting points for the carrier when the latter is positioned in a rest position. The notion supporting point does not necessarily mean that a physical contact is provided. A supporting point may also be provided by means of a suitable force or by means of suitable forces without a mechanical contact.

The actuator means may further comprise a damping means for dissipating energy of the carrier, particularly upon arrival of the carrier in the first or second stable state (or upon arrival in any stable state of a multistable carrier). Further details of these means are described below.

Particularly, for refracting the light beam, the plate member may have a refractive index of about n=1.5 as an example. Other suitable values may also be used.

Particular embodiments of the present invention are stated in the sub-claims and are described below.

Particularly, the optical device according to the invention can be used in (e.g. super resolution) imaging and projection. In these contexts, the optical device presented here may form a component in a camera or a projector. In a camera, an image is projected onto an image sensor of the camera which image sensor comprises a plurality of pixels.

Further, according to an embodiment of the present invention, said transition between said two stable states corresponds to a tilting movement of the carrier and of the plate member about a first axis, wherein the carrier (and the plate member) resides in a first position when the carrier is in the first stable state, and wherein the carrier resides in a second position when the carrier is in the second stable state.

Further, according to an embodiment of the present invention, the first and the second stable state each correspond to a local minimum of the potential energy of the carrier wherein said two stable states have the same potential energy or at least substantially the same potential energy.

This is advantageous since a transition between the stable states thus cost minimal or no energy at all.

Here, particularly, substantially the same potential energy means that said potential energies deviate less than 50%, particularly less than 30%, particularly less than 20%, particularly less than 10%, particularly less than 5%, 2%, 1%, 0.1%.

Further, according to an embodiment of the present invention, said local minima (i.e. said stable states) are each formed by a potential well, wherein each potential well has a depth corresponding to an activation energy.

Further, according to an embodiment of the present invention, the optical device is configured such that its potential energy comprises a at least one local maximum separating said two stable states of the carrier so as to prevent spontaneous transitions between the two stable states. Particularly, when the carrier is bistable, there is a single local maximum separating the two local minima (i.e. stable states). Further, in case the carrier is tristable, there is a global minimum of the potential energy between the two stable states, wherein said two stable states are each separated from said global minimum by a local maximum.

Further, according to an embodiment of the present invention, said actuator means is configured to a force a transition between the two stable states (i.e. from the first stable state to the second stable state or vice versa) by one of: merely lowering a potential energy barrier between the first and the second stable state; reducing a potential energy barrier between the first and the second stable state to a smaller value and by adding an amount of energy to the kinetic energy of the carrier; adding an amount of energy to the kinetic energy of the carrier that corresponds to a potential energy barrier between the first and the second stable state.

Further, according to an embodiment of the present invention, the first and the second stable state are preferably connected by a path of minimal or zero energy losses.

Further, according to an embodiment of the present invention, the first and the second stable state are sharply defined by two steep minima of the potential energy of the carrier.

Further, according to an embodiment of the present invention said actuator means is configured to a force a transition between the two stable states by adding energy to the carrier that exceeds the respective activation energy by an excess energy, which activation energy corresponds to the potential energy barrier between the two stable states. This allows one to initiate fast transitions between the first and the second stable state.

Further, according to an embodiment of the present invention said optical device is configured to dissipate said excess energy (e.g. by using viscous damping) after every single transition from one stable state to the other stable state, particularly so as to prevent uncontrolled transitions between the first and the second stable state.

Further, according to an embodiment of the present invention said optical device is configured to dissipate that added energy (e.g. by using viscous damping) after every transition from the first stable state to the second stable state and vice versa, particularly so as to damp, ideally over-damp free oscillations of the carrier around the locally stable first and second state.

Further, according to an embodiment of the present invention the optical device is configured to initiate cyclic transitions between said two stable states.

Further, according to an embodiment of the present invention, the carrier is tristable, wherein said two stable states are connected via an intermediate stable state in the form of an intermediate potential well of the potential energy of the carrier, which intermediate potential well comprises a local intermediate minimum of the potential energy of the carrier (e.g. a quadratic minimum), and wherein said intermediate potential well comprises a depth.

Further, according to an embodiment of the present invention, said local intermediate minimum of the intermediate potential well is a global minimum, which could be, but not necessarily must be, the idle-state of the carrier of the optical device (e.g. after power-off and/or shock impact and/or any other malfunction of the device).

Further, according to an embodiment of the present invention, said activation energy is at least 2 times, particularly at least 10 times, particularly at least 100 times smaller than the depth of the intermediate potential well, such that particularly a transition time T0 between said first and said second stable state of the carrier is mainly determined by the potential energy in the potential well, wherein f0=1/T0 is an oscillator frequency of the carrier.

Further, according to an embodiment of the present invention the optical device is configured to repeatedly initiate transitions between said first and said second stable state at a frequency f1 being at least 2 times, particularly at least 10 times, particularly at least 100 times, particularly at least 1000 times lower than said oscillator frequency f0 of the carrier. In other words, switching between said first and second stable state is conducted at a frequency much lower than the resonance or natural frequency f0 of the carrier. This lower frequency f1 is particularly achieved by holding the carrier in the reversal points for a waiting time of particularly 0.5/f1.

Further, according to an embodiment of the present invention the actuator means is configured to apply a static potential to force or initiate said transition from the first or second stable state to the respective other (i.e. second or first) stable state such that the local minimum of the respective initial stable state is raised and the initial stable state is transformed into an unstable state which triggers a transition of the carrier to said other stable state. Particularly, according to an embodiment, the actuator means is further configured to disengage said static potential when the carrier has passed said single local maximum (in case of a bistable carrier) or said local maximum separating the initial stable state from the intermediate stable state (in case of a tristable carrier). Since a static potential is applied this switching between the first and the second stable state of the carrier is also denoted as static switching. Further, according to an embodiment of the present invention, said static potential is an electromagnet potential, wherein particularly the actuator means comprises at least one coil and at least one magnet (see also below) for applying said static potential.

Of course, according to an embodiment the holding in the fixed position (e.g. in one of the stable states) can also be done by means of an electrostatic charge. Further, according to an embodiment of the present invention the actuator means is configured to apply an acceleration pulse to the carrier (e.g. on a time scale of about 4 milliseconds, or 1 millisecond, or 500 microseconds to force said transition from the first or second stable state to the respective other (i.e. second or first) stable state such that the carrier obtains kinetic energy to climb out of the local minimum of the respective initial stable state and to overpass said local maximum which triggers a transition of the carrier to said other stable state, wherein optionally residual kinetic energy of the carrier is used to maintain some speed of the carrier upon overpassing of said local maximum. This is also denoted as dynamic switching between said stable first and second state.

Particularly, the actuator means comprises at least one coil as well as at least one magnet for applying said acceleration pulse to the carrier Further, according to an embodiment of the present invention the actuator means of the optical device is configured to generate at least one actuation (e.g. force) pulse or a plurality of actuation (e.g. force) pulses to force a transition of the carrier from the intermediate stable state to the first or second stable state.

Further, according to an embodiment of the present invention the actuator means is configured to generate a single actuation (e.g. force) pulse that transfers a minimal energy to the carrier sufficient to directly force a transition of the carrier from the intermediate stable state to the first or to the second stable state of the carrier.

Further, according to an embodiment of the present invention, particularly for conducting a start sequence of the optical device, the actuator means of the optical device is configured to transfer a minimal energy to the carrier sufficient to force or initiate a transition of the carrier from the intermediate stable state to the first or to the second stable state of the carrier in portions using said plurality of actuation (e.g. force) pulses. This is preferably done utilizing resonant amplification.

Further, according to an embodiment of the present invention, particularly for conducting a start sequence of the optical device, the actuator means is configured to generate a periodic excitation, in particular a resonant excitation (e.g. a harmonic excitation, a pulse train, or any other periodic excitation, namely particularly at said oscillator frequency f0 or close to said frequency f0), so as to force a transition from the intermediate stable state to the first or second stable state by feeding incremental amounts of energy into the carrier until its kinetic energy is high enough to climb out of the intermediate potential well and to settle into one of the two stable states.

Further, according to an embodiment of the present invention the optical device is configured to additionally lower the potential energy barrier (e.g. by means of an electromagnetic field/force) during said at least one actuation (e.g. force) pulse or said plurality of actuation (e.g. force) pulses or said single actuation (e.g. force) pulse or during said periodic excitation, so that less kinetic energy has to be accumulated to escape the intermediate potential well.

Particularly, a train of at least two (e.g. square) force pulses or multiple of said force pulses, spaced by regular intervals of approximately time T0 can be used to drive the carrier of the optical device from the intermediate state to the first or second stable state.

Further, according to an embodiment of the present invention, the actuator means comprises a clamping means configured to clamp the carrier in the first stable state and/or in the second stable state by exerting a clamping force on the carrier that particularly over-compensates a spring force generated by the carrier or by at least one or several springs that may connect the carrier to a support (e.g. support frame). The spring(s) may be integrally formed with the carrier.

According to an embodiment of the optical device according to the invention, the clamping means comprises at least one magnet, particularly a permanent magnet that is configured to exert a clamping force on the carrier, e.g. on a soft magnet or magnetizable material part of the carrier.

Further, according to an embodiment of the present invention the actuator means comprises a disengaging means that is configured to cancel said clamping of the carrier in the first and/or second stable state.

According to an embodiment of the optical device according to the invention, the disengaging means comprises one of:
at least one coil (e.g. arranged on the support frame) and at least one corresponding magnet (e.g. arranged on the carrier) for generating a Lorentz force for cancelling said clamping of the carrier,
at least one coil and a magnetic flux return structure provided on the carrier for generating a reluctance force for cancelling said clamping of the carrier,
at least one coil being configured to superimpose a magnetic field of said at least one magnet of the clamping means for reducing an attractive reluctance force between the carrier and said at least one magnet so as to cancel said clamping of the carrier,
at least one coil and an electrically conducting structure on the carrier for generating a Lorenz force by means of eddy currents induced in said structure so as to cancel said clamping of the carrier, or
an actuator being configured to exert a force on the carrier for cancelling said clamping of the carrier, particularly one of: a piezoelectric actuator, a magnetostrictive actuator, a phase change material, shape memory alloy (e.g. Nitinol or a similar alloy), an electroactive polymer, or a bimetal.

Further, according to an embodiment of the present invention the optical device comprises a damping means configured to dissipate kinetic energy of the carrier upon movement of the carrier into one of the stable states (see also above).

Further, according to an embodiment, the damping means comprises at least one of:
a mechanical damper,
an eddy current damper (e.g. comprising a magnet for generating a Lorentz force due to eddy currents in a structure of the optical device facing the moving carrier/magnet),
a magnetic damper (e.g. comprising magnets for generating a magnetic damping force),
an active damper (e.g. comprising a coil interacting with a magnet of the active damper for generating a damping force).

Furthermore, according to an embodiment of the optical device according to the present invention, the actuator means comprises a rest position defining means wherein the rest position defining means is configured to provide supporting points for the carrier in the respective rest position of the carrier, which respective rest position corresponds to a stable state of the carrier.

Furthermore, according to an embodiment of the optical device according to the present invention, the respective rest position defining means comprises at least one spring and/or a stop, or a means for generating a force for engaging the carrier in the respective rest position providing a supporting point.

Further, in an embodiment, the rest position defining means are formed by the clamping means.

Further, in an embodiment, the damping means is integrated into the clamping means.

Further, in an embodiment, the clamping means comprises a magnetic flux guiding structure for guiding the magnetic flux of at least one magnet, which structure forms gaps with a magnetic flux guiding portion of the carrier in order to generate a reluctance force that holds the carrier in the respective stable state, wherein particularly said magnetic flux guiding structure comprises a spring via which the carrier is connected to a support of the optical device.

Furthermore, in an embodiment, the rest position defining means is designed to provide one or several pairs of supporting points, wherein in each pair the supporting points are arranged on top of one another along the optical axis of the optical device along which said light beam passes through the plate member. Further, particularly, the rest position defining means that provide a supporting point respectively may be arranged on top of one another along said optical axis. Alternatively, the rest position defining means is designed to provide supporting points that face each other in a direction perpendicular to said optical axis. Particularly, the rest position defining means may here face each other in a direction perpendicular to said optical axis.

According to a further embodiment of the optical device according to the invention, the rest position defining means together with one of: a universal joint (e.g. a joint providing a universal-mounted carrier, e.g. a carrier that can be tilted about two independent axes), a rotational axis, at least one spring, is configured to fix the carrier in each rest position (i.e. provide corresponding supporting points) corresponding to one of the stable states of the carrier in at least or exactly three different points in space. Here, the carrier may be movably connected via said rotational joint or axis or said spring(s) to a support (e.g. support frame) of the optical device, so that the carrier can be moved between said (e.g. first and second) stable states. Further, the carrier can be tilted as a whole about the first axis and a second axis, whereby said light beam/projected image is shifted (e.g. by a fraction of a pixel, particularly by a half of a pixel) along a corresponding direction.

Further, in an embodiment, the carrier of the optical device comprises at least four rest positions, each corresponding to a stable state of the carrier (i.e. the carrier has four stable states in total), as well as four supporting points, wherein each supporting point is arranged at an associated edge region of the carrier, and wherein the carrier is supported by means of a universal joint (may be formed by springs), particularly in an area spanned by the carrier, and wherein the actuator means comprises at least two disengaging means, particularly four disengaging means.

Particularly, in case the optical device comprises two disengaging means they are preferably configured as push-pull means which can pull the carrier and push the carrier for triggering a transition between two stable states. Such disengaging means are preferably arranged between two supporting points along an associated edge region, but preferably not on diagonally opposing corner regions of the carrier.

In case the optical device comprises four disengaging means, many different positions are possible. Particularly, the respective disengaging means may be arranged at the respective supporting point. Further, each disengaging means may be arranged at an associated corner region of the carrier. Further, each disengaging means may be arranged adjacent an associated supporting point. Generally, according to an embodiment, said two or four (or even more, e.g. eight) disengaging means are arranged such that they can trigger (e.g. as a whole) a transition between each two stable state of the four stable states.

Further, particularly, according to an embodiment, the optical device may here comprise at least four clamping means for clamping the carrier in the rest positions. For instance when triggering a transition between two stable states one of the clamping means can maintain clamping the carrier so as to provide a defined rotation axis together with the universal joint. Alternatively, the clamping means can be arranged close to the corner regions of the carrier. Here, one would simply release the clamping means for the transition.

Further, according to another embodiment, the carrier of the optical device comprises four rest positions, each corresponding to a stable state of the carrier, as well as two pairs of supporting points, wherein in each pair the two supporting points are arranged on top of one another (e.g. as described above), and wherein said pairs are arranged at opposing edge regions or corner regions of the carrier, and wherein the carrier is supported by means of a universal joint, particularly in an area spanned by the carrier or outside said carrier, and wherein the actuator means comprises at least two disengaging means which are arranged at or adjacent an associated supporting point.

Further, here, particularly, the optical device comprises at least two clamping means for clamping the carrier in the rest positions, which clamping means are arranged at or adjacent an associated supporting point.

Further, according to another embodiment, the carrier of the optical device comprises at least four rest positions, each corresponding to a stable state of the carrier, as well as four pairs of supporting points, wherein in each pair the two supporting points are arranged on top of one another, and wherein each pair is arranged at an associated edge region of the carrier, and wherein the actuator means comprises at least four disengaging means, wherein each disengaging means is arranged at an associated edge region of the carrier (here, particularly only four combinations of rest positions may be used, e.g. rotating permutations of up, up, down, down).

Further, here, particularly, at or adjacent each supporting point a clamping means is arranged for clamping the carrier in the respective rest position.

Further, according to yet another embodiment, the carrier of the optical device comprises two rest positions, each corresponding to a stable state of the carrier, as well as two supporting points and a rotational axis (e.g. formed by two aligned springs) crossing an area spanned by the carrier, wherein the supporting points are arranged on opposite sides of the rotation axis, wherein each supporting point is arranged at an associated edge region or corner region of the carrier, and wherein the actuator means comprises at least one disengaging means arranged on an edge region of the carrier.

Here, the optical device particularly comprises two clamping means for clamping the carrier in the respective rest position, wherein each clamping means is arranged at or adjacent an associated supporting point. Alternatively, two clamping means may be arranged at one of the supporting points on top of each other for providing clamping for each of the two rest positions.

Further, according to another embodiment, the carrier of the optical device comprises two rest positions, each corresponding to a stable state of the carrier, as well as two supporting points arranged on top of one another, and a rotational axis (e.g. formed by two aligned springs) crossing an area spanned by the carrier or extending outside of the carrier, wherein the supporting points are arranged at an edge region or corner region of the carrier (and particularly not on the rotation axis, e.g. spaced apart from the latter axis), wherein each supporting point is arranged at an associated edge region or corner region of the carrier, and wherein the actuator means comprises at least one disengaging means arranged at an edge region or corner region of the carrier.

Here, particularly, the optical device comprises two clamping means for clamping the carrier in the respective rest position, wherein each clamping means is arranged at or adjacent an associated supporting point. Particularly, the clamping means can be arranged on top of one another for providing double clamping on one side/edge region of the carrier.

Further, according to another embodiment, the carrier of the optical device comprises two rest positions, each corresponding to a stable state of the carrier, as well as two pairs of supporting points, wherein in each pair the two supporting points are arranged on top of one another, and wherein each pair is arranged at an associated edge region or corner region of the carrier, and wherein the actuator means comprises at least two disengaging means, wherein each disengaging means is arranged at an associated edge region or corner region of the carrier.

Here, the clamping means may be arranged at or adjacent each supporting point. Particularly, clamping means can be arranged on top of one another in pairs for providing double clamping on the respective side/edge region of the carrier.

Further, according to an embodiment of the present invention the carrier is connected via springs (that can be integral regions of the carrier) to a support frame so that the carrier can be tilted about a first axis between said first and said second state with respect to said support frame.

Further, according to an embodiment of the present invention, the carrier comprises a first part that is connected via said springs (particularly two springs, particularly two torsion beams) to said support frame and a second part that is connected via springs (particularly two springs, particularly two torsion bars) to the first part of the carrier, so that the first and second part can be tilted as a whole about a first axis and that the second part can be tilted about a second axis with respect to the first part between a first and a second state whereby said light beam/projected image is shifted (e.g. by a fraction of a pixel, particularly by a half of a pixel) along a second direction, and wherein the transparent plate member is rigidly mounted to the second part of the carrier (i.e. the plate member can thus be tilted about the two axis independently), wherein said second part of the carrier is configured to be bistable or tristable (or otherwise multistable), too, wherein said first and said second state of the second part are stable states of the bistable or tristable second part of the carrier, and wherein the actuator means is configured to force or initiate a transition of the second part of the carrier from its first stable state to its second stable state and vice versa.

Thus, here, the carrier having said first and said second part comprises at least four stable states in total.

Particularly, the second part of the carrier can be switched between its stable states in the same manner as the first part of the carrier

Further, according to an embodiment of the present invention, the actuator means comprises a plurality of electrically conducting coils and a corresponding plurality of magnets.

Further, according to an embodiment of the present invention the coils are arranged on the support frame and that the magnets are arranged on the carrier. In case the carrier comprises said first and second part, the magnets are arranged on the first and the second part, so that said tilting about the two axes can be performed.

Further, according to an embodiment of the present invention each magnet used for triggering transitions between stable states (disengaging means) is associated to exactly one of the coils and faces its associated coil, wherein the respective magnet is centered with respect to its associated coil.

However, the respective magnet may also be arranged slightly off-center so as to provide space for a further component, particularly a damping element such as an electromagnet damping element, a mechanical damping element, a magnetic damping element, or an eddy current brake.

Thus, when a current is applied to the respective coil, a Lorentz force is generated that initiates a transition between the first and second stable states of the carrier (e.g. of the first and second part together in the form of a tilting about the first axis, or of only the second part in the form of a tilting of the latter about the second axis).

However, in certain embodiments the actuator means may also comprise magnets that do not face a coil and may be used to realize a clamping means. Here, a disengaging means of the actuator means that is used for triggering transitions between stable states of the carrier may use separate coil-magnet pairs.

Further, according to an embodiment of the optical device according to the invention, a magnetic flux guiding member is attached to a face side of the respective magnet, which face side faces the associated coil, and wherein said magnetic flux guiding member forms a magnetic flux return structure (closure) for the magnetic field of the respective magnet with a region of the carrier, and wherein particularly the respective magnetic flux guiding member is arranged in a central opening of the associated coil. Particularly, due to the magnetic flux guiding member, the magnetic field of the respective magnet extends parallel to the face side of the magnet at the face side.

Further, according to an embodiment of the optical device according to the invention, the respective magnet does not comprise a magnetic flux guiding member attached to its face side but is configured to generate a magnetic field that is oriented essentially parallel to a winding axis of the associated coil at the face side of the respective magnet.

Further, according to an embodiment of the optical device according to the invention, the actuator means is a mechanical bistable actuator means that comprises a middle plate that is connected, particularly integrally connected, via two angle plates to a support such that the middle plate is bistable and comprises two stable states corresponding to two different positions of the middle plate with respect to the support (and corresponding to different angle positions of the angle plates), wherein the middle plate is connected (particularly integrally connected) to the carrier, and wherein an actuator is provided that is configured to force a transition of the middle plate from one stable state to the other stable state of the middle plate which yields a corresponding transition of the carrier between its two stable states.

Further, according to an embodiment of the optical device according to the invention, the carrier is connected, particularly integrally connected, to a support of the optical device such that it is bistable and comprises two positions with respect to the support corresponding to a first and a second stable state, or that it is quadristable and comprises four positions with respect to the support corresponding to four stable states.

Further, according to an embodiment of the optical device according to the invention, the carrier is connected (particularly integrally connected) on a side of the carrier via a joint to an angle plate which in turn is connected (particularly integrally connected) via a further joint to the support, and wherein the carrier is connected on an opposing side (particularly integrally connected) via a single joint and a spring to the support, wherein particularly said spring may be integrally formed with said single joint.

Further, according to an embodiment of the optical device according to the invention, the carrier is connected (particularly integrally connected) on a side of the carrier via a joint to an angle plate which in turn is connected (particularly integrally connected) via a further joint to the support, and wherein the carrier is connected (particularly integrally connected) on an opposing side via a joint to an angle plate which in turn is connected (particularly integrally connected) via a further joint to the support, wherein particularly a spring may connect the further joint to the support or may be integrally formed with the support, or may be formed integrally with the joint and/or the further joint on said opposing side of the carrier.

Further, according to yet another embodiment of the optical device according to the invention, said joints may each comprise at least one torsion beam, wherein the pivoting of the angle plates predominantly corresponds to a torsional movement of the torsion beams and wherein a bending movement of these beams predominantly generates the function of the (integrated) springs.

According to a further embodiment of the optical device, the actuator means comprises at least one electropermanent magnet that forms a gap with a magnetic flux guiding region of the carrier for holding the carrier in one of the stable states by exerting a force on said region of the carrier.

In the following embodiments, this force of the respective electromagnet actuator can be a reluctance force and/or a magnetic force (e.g. magnetic dipol-dipol interaction, e.g. with a permanent magnet arranged on the carrier).

Preferably, in said stable state, said force of the electropermanent magnet balances a counterforce, which counterforce acts on the carrier such that the electropermanent magnet does not contact said flux guiding region of the carrier, and particularly such that when the reluctance force is turned off, the carrier is moved to the other stable state (or one of the other stable states) by means of said counterforce.

The counterforce comprises at least a spring force component generated by one or several springs via which the carrier is connected to a support frame, wherein the spring(s) can also be an integral part of the carrier or of a component of the carrier. The counterforce may also comprise a magnet force component that tends to widen said cap, e.g. due to said first and/or second permanent magnets, see below).

Particularly, the (e.g. reluctance) force can be turned off by switching the magnetization of the second magnet such that no magnetic flux is guided via said gap. This also applies to the other electropermanent magnets described below.

Alternatively, instead of electropermanent magnets, also electromagnets or voice coil motors can be used.

Particularly, according to an embodiment of the optical device according to the present invention, the actuator means comprises at least one electromagnet that forms a gap with a magnetic flux guiding region of the carrier for holding the carrier in one of the stable states by exerting a reluctance force on said magnetic flux guiding region of the carrier, wherein particularly in said stable state said reluctance force balances a counterforce acting on the carrier such that the electromagnet does not contact said magnetic flux guiding region, and particularly such that when the reluctance force is turned off the carrier is moved to the other stable state by means of said counterforce.

Particularly, according to an alternative embodiment of the optical device according to the present invention, the actuator means comprises at least one voice coil motor, the voice coil motor comprising a coil and an associated magnetic structure comprising two permanent magnets arranged on top of one another or two (e.g. integrally connected) adjacent sections arranged on top of one another (here the magnetic structure forms a single permanent magnet), wherein the magnetic structure is connected to the carrier, wherein the voice coil motor is configured to hold the carrier in one of the stable states by exerting a Lorentz force on said carrier, wherein particularly in said stable state said Lorentz force balances a counterforce acting on the carrier, particularly such that when the Lorentz force is turned off the carrier is moved to the other stable state by means of said counterforce. Particularly, the two magnets or sections comprise a counter polarization or anti-parallel magnetization, wherein the magnetic structure is connected to the carrier, and wherein the coil is connected to a support frame. Particularly, the coil comprises an electrical conductor wound about a coil axis to form said, wherein the coil axis extends parallel to the two (anti parallel) magnetizations of the sections or magnets.

Furthermore, particularly, a magnetic flux return structure is arranged on a side of the magnetic structure that faces away from the coil, wherein the magnetic flux return structure connects the two magnets/sections. Particularly, the magnetic flux return structure is formed out of a soft magnetic material, particularly a ferromagnetic material.

In the following, individual electropermanent magnets are described as actuators. However, each of these actuators may also be replaced by an electromagnet or a voice coil motor.

According to an embodiment of the optical device, the actuator means comprises a first electropermanent magnet that forms a first gap with a first magnetic flux guiding region of the carrier for holding the carrier in the first stable state by exerting a force on said first region of the carrier, wherein particularly in said first stable state said force balances a counterforce that acts on the carrier such that the first electropermanent magnet does not contact said first magnetic flux guiding region of the carrier, and particularly such that when the force is turned off, the carrier is moved to the second stable state by means of said counterforce. Particularly, said counterforce comprises at least a spring force component generated by said springs via which the carrier is connected to the support frame. Further, the counterforce may also comprise a magnet force component that tends to widen said first gap, e.g. due to said first and/or second permanent magnets, see below.

Further, according to an embodiment of the optical device, the actuator means comprises a second electropermanent magnet that forms a second gap with a second magnetic flux guiding region of the carrier for holding the carrier in the second stable state by exerting a force on said second region of the carrier, wherein particularly in said second stable state said force balances a counterforce that acts on the carrier such that the second electropermanent magnet does not contact said second magnetic flux guiding region, and particularly such that when the force is turned off the carrier is moved to the first stable state by means of said counterforce. Particularly, said counterforce comprises at least a spring force component generated by said springs via which the carrier is connected to the support frame.

Further, the counterforce may also comprise a magnet force component that tends to widen said second gap, e.g. due to said first and/or second permanent magnets, see below.

Further, according to an embodiment of the optical device, the actuator means comprises a third electropermanent magnet that forms a third gap with a third magnetic flux guiding region of the second part of the carrier for holding the second part of the carrier in its first stable state by exerting a force on said third magnetic flux guiding region of the second part of the carrier, wherein particularly in said first stable state said force balances a counterforce, that acts on the second part of the carrier such that the third electropermanent magnet does not contact said third magnetic flux guiding region, and particularly such that when the force is turned off, the second part of the carrier is moved to the second stable state by means of said counter force. Particularly, said counterforce comprises at least a spring force component generated by said springs via which the second part of the carrier is connected to said first part of the carrier. Further, the counterforce may also comprise a magnet force component that tends to widen said third gap, e.g. due to said first and/or second permanent magnets, see below.

Further, according to an embodiment of the optical device, the actuator means comprises a fourth electropermanent magnet that forms a fourth gap with a fourth magnetic flux guiding region of the second part of the carrier for holding the second part of the carrier in the second stable state by exerting a force on said fourth magnetic flux guiding region of the second part of the carrier, wherein particularly in said second stable state said force balances a counterforce that acts on the second part of the carrier such that the fourth electropermanent magnet does not contact said fourth magnetic flux guiding region, and particularly such that when the force is turned off the second part of the carrier is moved to the first stable state by means of said counterforce. Particularly, said counterforce comprises at least a spring force component generated by said springs via which the second part of the carrier is connected to said first part of the carrier. Further, the counterforce may also comprise a magnet force component that tends to widen said fourth gap, e.g. due to said first and/or second permanent magnets, see below.

Furthermore, instead of a carrier that comprises parts that can be tilted about two different axes, the optical device may also comprise two stacked transparent plate members that can each be tilted about an axis, wherein these axis are non-parallel, particularly orthogonal so that a light beam that passes both plate members can be shifted in two dimensions (i.e. along two different directions). Thus, according to an embodiment of the optical device, the optical device comprises a further carrier to which a further transparent plate member is rigidly mounted, wherein the further carrier is configured to be moved between at least a first and a second state, whereby said light beam or projected image is shifted, particularly by a fraction of a pixel, particularly by a half of a pixel, e.g. along a second direction (being particularly different from said first direction, see above), and wherein the further carrier is configured to be multistable, particularly bistable or tristable, wherein said first and said second state are stable states of the multistable further carrier, and wherein said actuator means is configured to force a transition of the further carrier from the first stable state to the second stable state of the further carrier and vice versa, and wherein said further carrier is connected via springs to the support frame so that the further carrier can be tilted about a second axis between said first stable state and said second stable state of the further carrier with respect to said support frame, whereby particularly said light beam or projected image is shifted, particularly by a fraction of a pixel, particularly by a half of a pixel, e.g. along a second direction.

Further, according to an embodiment of the optical device, the actuator means comprises a third electropermanent magnet that forms a third gap with a third magnetic flux guiding region of the further carrier for holding the further carrier in its first stable state by exerting a force on the said third magnetic flux guiding region of the further carrier, wherein particularly in said first stable state said force balances a counterforce that acts on the further carrier such that the third electropermanent magnet does not contact said third magnetic flux guiding region, and particularly such that when the force is turned off the further carrier is moved to the second stable state by means of said counterforce. Particularly, said counterforce comprises at least a spring force component generated by said springs via which the further carrier is connected to said support frame. Further, the counterforce may also comprise a magnet force component that tends to widen said third gap, e.g. due to said first and/or second permanent magnets, see below.

Further, according to an embodiment of the optical device, the actuator means comprises a fourth electropermanent magnet that forms a fourth gap with a fourth magnetic flux guiding region of the further carrier for holding the further carrier in the second stable state by exerting a force on said fourth region of the further carrier, wherein particularly in said second stable state said force balances a counterforce that acts on the further carrier such that the fourth electropermanent magnet does not contact said fourth magnetic flux guiding region, and particularly such that when the force is turned off the further carrier is moved to the first stable state by means of said counterforce. Particularly, said counterforce comprises at least a spring force component generated by said springs via which the further carrier is connected to said support frame. Further, the counterforce may also comprise a magnet force component that tends to widen said fourth gap, e.g. due to said first and/or second permanent magnets, see below.

Furthermore, according to an embodiment of the optical device the respective electropermanent magnet (e.g. said at least one electroperment magnet or said first, second, third or fourth electropermanent magnet) comprises a first magnet having a first coercivity and a second magnet having a second coercivity being smaller than the first coercivity, and wherein an electrically conducting conductor is wound around the second magnet and/or around at least a portion of a magnetic flux guiding structure of the respective electropermanent magnet to form a coil enclosing the second magnet/and or said portion, so that when a voltage pulse is applied to the coil the magnetization of the second magnet is switched and a magnetic flux is generated that generates said (e.g. reluctance and/or magnetic) force.

Further, according to an embodiment of the optical device, the second magnet of the respective electropermanent magnet extends around the first magnet. Particularly, the second magnet may form an annular (hollow cylindrical magnet) defining a central recess in which the first magnet is arranged. However, the first magnet may also extend around the second one.

Further, according to an embodiment of the optical device, the said conductor is also wound around the first magnet so that said coil encloses the second magnet and the first magnet. Particularly, the conductor may comprise section that cross each other between the two magnets so that the wound coil comprises the shape of an eight.

Further, according to an embodiment of the optical device, a further separate conductor is wound around the first magnet to form a further coil enclosing the first magnet of the respective electropermanent magnet.

Further, according to an embodiment of the optical device, the respective electropermanent magnet comprises a magnetic flux guiding structure connected to the magnets, which magnetic flux guiding structure forms the respective gap (e.g. said gap, or said first, second, third or fourth gap) with the respectively associated magnetic flux guiding region (e.g. said magnetic flux guiding region or said first, second, third or fourth magnetic flux guiding region, see above).

Further, according to an embodiment of the optical device, the magnetic flux guiding structure comprises two spaced apart elements between which said first magnet and said second magnet of the respective electropermanent magnet is arranged, such that the first and the second magnet contact both elements of the magnetic flux guiding structure or are connected in a magnetic flux guiding manner to both elements, wherein each element comprises a face side facing the respective magnetic flux guiding region, which face sides form the respective gap with the respectively associated magnetic flux guiding region.

Further, according to an embodiment of the optical device, the respective electropermanent magnet comprises a further first magnet, wherein the second magnet is arranged between the two first magnets, and wherein the second and the two first magnets are arranged on a magnetic flux guiding structure with a bottom side, respectively, and wherein the second and the two first magnets each comprise an opposing top side, which top sides form the respective gap with the respectively associated magnetic flux guiding region.

Further, according to an embodiment of the optical device, the second and the first magnet of the respective electropermanent magnet are arranged on a magnetic flux guiding structure with a bottom side, respectively, and wherein the second and the first magnet each comprise an opposing top side, which top sides particularly form the respective gap with the respectively associated magnetic flux guiding region.

Further, according to an embodiment of the optical device, the magnetic flux guiding structure comprises lateral portions, wherein said second and first magnet of the respective electropermanent magnet are arranged between said lateral portions, and wherein said lateral portions form the respective gap with the respective magnetic flux guiding region.

Further, according to an embodiment of the optical device, the top side of the second magnet covers the top side of the first magnet.

Further, according to an embodiment of the optical device, the second and the first magnet each of the respective electropermanent magnet comprise a top side and an opposing bottom side, wherein the top side of the second magnet covers the top side of the first magnet and wherein the bottom side of the second magnet covers the bottom side of the first magnet such that second magnet encloses the first magnet completely, wherein the top side of the second magnet forms the respective gap with the respectively associated magnetic flux guiding region.

Further, according to an embodiment of the optical device, the respective electropermanent magnet is arranged between a first and a second member of the respective magnetic flux guiding region so that the respective electropermanent magnet forms the respective gap with the first member and a further gap with said second member. Here, particularly, the generated reluctance force will tend to close the smaller gap of said two gaps.

Further, according to an embodiment of the optical device, at least one first permanent magnet is connected to the respective magnetic flux guiding region or to the carrier for generating a repulsive or attractive force that moves the respective magnetic flux guiding region or the carrier away from the respectively associated electropermanent magnet or towards the latter.

Further, according to an embodiment of the optical device, the respective electropermanent magnet is connected to a support, particularly said the support frame.

Further, according to an embodiment of the optical device, the at least one second permanent magnet is connected to the support (e.g. support frame) adjacent the respective electropermanent magnet for generating a repulsive force that pushes the respective region or the carrier away from the respective electropermanent magnet.

Further, according to an embodiment, the first magnet is formed as a ring magnet comprising a central opening in which a magnetic flux guiding element is arranged, wherein the coil is wound around the second magnet that is arranged below said element, and wherein the coil is enclosed by a circumferential wall of a magnetic flux guiding structure, and wherein the coil is arranged below said ring magnet in said magnetic flux guiding structure.

It is to be noted that the positions of the magnetic flux guiding regions and the electropermanent magnets can be interchanged, i.e., the electropermanent magnets can be mounted on the carrier, further carrier or on said first and second part of the carrier, while the associated magnetic flux guiding regions are then arranged on the support frame or formed by the latter.

Further, according to an embodiment, the optical device comprises at least one voltage source for generating said voltage pulse used to switch the e.g. second magnet's magnetization.

Further, according to an embodiment of the optical device, the optical device comprises at least four switches via which the voltage source is connectable to the coil (so called H bridge driver)

Further, according to an embodiment of the optical device, the optical device comprises at least six switches via which the voltage source is connectable to the coil and/or to the further coil. Further, according to an embodiment of the optical device, the voltage source is configured to control the magnetization of the second magnet by altering the length of the voltage pulses applied to the coil and/or to the further coil, or alternatively by altering the voltage of these voltage pulses while keeping the pulse length constant.

Further, according to an embodiment of the optical device, the voltage source is configured to shape the current in said coil and/or further coil so as to achieve noise reduction of the optical device, particularly by applying pulse-width modulation to the voltage applied to the coil and/or further coil.

Particularly, according to an embodiment, the voltage source is configured to apply a voltage pulse to the further coil when applying said voltage pulse to said coil so that during switching of the magnetization of the second magnet the magnetic flux through the respective magnetic field guiding region of the carrier is reduced or turned off. This can be utilized to avoid shocks on the carrier upon switching the respective electropermanent magnet and therefore to reduce noise of the device.

Further, said coil and said further coil can be connected in an electrically conducting manner.

In the above described embodiments using electropermanent magnets, the carrier is preferably tilted without making mechanical contact with the respective electropermanent magnet or other stops e.g. on the support frame. However, in alternative embodiment, the carrier may also be stopped mechanically, e.g. by butting against some associated stop of the device.

According to a further embodiment of the optical device according to the present invention, the carrier is again connected via springs (e.g. torsion bars) to a support frame (that may also be denoted as base) so that the carrier can be tilted about a first axis between said first and said second state with respect to said support frame.

Furthermore, particularly, the carrier comprises a first part that is connected via said springs to said support frame and a second part that is connected via springs to the first part, so that the second part can be tilted about a second axis with respect to the first part between a first and a second state of the second part whereby particularly said light beam is shifted, and wherein the transparent plate member is rigidly mounted to the second part of the carrier, wherein said second part is configured to be bistable or tristable, too, and wherein said first and said second state of the second part are stable states of the bistable or tristable second part of the carrier, and wherein the actuator means is configured to force or initiate a transition of the second part of the carrier from its first stable state to its second stable state and vice versa.

Here, particularly, according to a further embodiment of the optical device according to the present invention, the carrier comprises a spring structure, which spring structure comprises an outer frame, wherein said springs that connect the carrier (particularly first part of the carrier) to the support frame are integrally connected to the outer frame of the spring structure.

Further, according to an embodiment, said springs that connect the carrier to the support frame are formed by two first torsion bars, wherein one first torsion bar protrudes from a first arm of the outer frame of the spring structure while the other first torsion bar protrudes from a second arm of the outer frame of the spring structure, wherein said second arm opposes the first arm of the spring structure. Further, particularly, said first torsion bars are aligned with each other and define said first axis. Furthermore, said first and said second arm of the outer frame of the spring structure can extend parallel and particularly perpendicular to the first axis and are preferably integrally connected by a third arm and a fourth arm of the outer frame of the spring structure. Particularly, also the third and the fourth arm of the outer frame of the spring can extend parallel to one another.

Furthermore, according to an embodiment, the spring structure comprises an inner frame, wherein the outer frame of the spring structure surrounds the inner frame of the spring structure, and wherein said springs that connect the second part of the carrier to the first part of the carrier integrally connect the inner frame of the spring structure to the outer frame of the spring structure.

Furthermore, according to an embodiment, said springs that connect the inner frame of the spring structure/second part of the carrier to the outer frame of the spring structure/first part of the carrier are formed by two second torsion bars, wherein one second torsion bar extends from a first arm of the inner frame of the spring structure to the third arm of the outer frame of the spring structure, and wherein the other second torsion bar extends from a second arm of the inner frame of the spring structure to the fourth arm of the outer frame of the spring structure. Further, particularly, said second torsion bars are aligned with each other and define said second axis. Further, particularly, the first and the second arm of the inner frame of the spring structure are integrally connected by a third arm and by a fourth arm of the inner frame of the spring structure, wherein the fourth arm of the inner frame of the spring structure opposes the third arm of the inner frame of the spring structure.

Particularly, said first and said second arm of the inner frame extend parallel and particularly perpendicular to the second axis. Particularly also the third and the fourth arm of the inner frame extend parallel to one another.

Particularly, in an embodiment, the first arm of the outer frame of the spring structure extends along the third arm of the inner frame of the spring structure, the second arm of the outer frame of the spring structure extends along the fourth arm of the inner frame of the spring structure. Further, particularly, the third arm of the outer frame of the spring structure extends along the first arm of the inner frame of the spring structure, and the fourth arm of the outer frame of the spring structure extends along the second arm of the inner frame of the spring structure.

Particularly, the entire spring structure comprising inner and outer frame as well as the first and second torsion bars is formed as a flat plate member which is cut, particularly stamped, laser cut, or etched from a flat metal blank, to form said integral structure comprising said inner and outer frame as well as said first and second torsion bars. Particularly, in case of stamping, all torsion springs are coined to increase their lifetime while tilting around their respective axis. Particularly the first and second torsion bars generate a counter force when the first part/second part of the carrier is tilted that tries to tilt the respective part of the carrier back.

Further, according to an embodiment of the optical device according to the present invention, each first torsion bar is integrally connected to a fastening region, wherein the carrier is connected via said fastening regions to the support frame.

Particularly, in an embodiment, one of said fastening regions comprises elongated holes for mounting this fastening region to the support frame, while the other fastening region comprises a marker, particularly in form of a recess, particularly for identifying the orientation of the spring structure when mounting the latter to the support frame of the optical device. Further, particularly, the other fastening region comprising the marker comprises circular holes for mounting this fastening region to the support frame of the optical device. Particularly, according to an embodiment, the fastening regions are fastened to the support frame using screws that extend through said elongated holes. Due to the elongated holes stress can be minimized as the tolerances on the spatial distances between the holes have less of an impact when mounting the fastening regions to the support frame of the optical device.

According to a further embodiment of the optical device according to the present invention, the carrier comprises a reinforcing structure that is connected to the spring structure, particularly so as to increase rigidity and stiffness of the outer and inner frame of the spring structure and particularly to reduce noise generated by the optical device.

According to an embodiment, the reinforcing structure comprises an outer reinforcing frame and an inner reinforcing frame, wherein the inner reinforcing frame is connected to the inner frame of the spring structure, and wherein the outer reinforcing frame is connected to the outer frame of the spring structure.

Particularly, according to an embodiment of the present invention, the plate member is connected, particularly glued or laser-welded, to the inner reinforcing frame. Particularly, the plate member can be a glass member. Further, particularly, plate member/glass member can comprise a thickness that is smaller than or equal to 5 mm, particularly smaller than or equal to 2 mm, particularly smaller than or equal to 0.5 mm.

According to a further embodiment of the optical device according to the present invention, the outer reinforcing frame is connected to the outer frame of the spring structure by one of: a glue connection, a weld connection, screws, rivets; and/or wherein the inner reinforcing frame is connected to the inner frame of the spring structure by one of: a glue connection, a weld connection, screws, rivets.

Particularly, as glue for forming the glue connection, a soft glue is used, which particularly means that the glue connection comprises an elongation at break that is larger than 5%, particularly larger than 50%, particularly larger than 100%. Furthermore, particularly, the glue connection may comprise a shore hardness A being smaller than 90, particularly smaller than 60, particularly smaller than 40.

Furthermore, in an embodiment, the outer reinforcing frame comprises a first arm and an opposing second arm, wherein the first and the second arm of the outer reinforcing frame are connected by a third and a fourth arm of the outer reinforcing frame.

According to an embodiment at least one arm, particularly two opposing arms, or each arm of the outer reinforcing frame comprises an angled section having a height, which height is larger than a thickness of the angled section perpendicular to said height.

Furthermore, according to an embodiment, a top side of the first arm of the outer reinforcing frame is connected to a bottom side of the first arm of the outer frame of the spring structure, a top side of the second arm of the outer reinforcing frame is connected to a bottom side the second arm of the outer frame of the spring structure, a top side of the third arm of the outer reinforcing frame is connected to a bottom side of the third arm of the outer frame of the spring structure, and a top side of the fourth arm of the outer reinforcing frame is connected to a bottom side of the fourth arm of the outer frame of the spring structure.

Furthermore, according to an embodiment of the optical device according to the present invention, the inner reinforcing frame comprises a first arm and an opposing second arm, wherein the first and the second arm of the inner reinforcing frame are connected by a third and a fourth arm of the inner reinforcing frame.

Further, according to an embodiment, at least one arm, particularly two opposing arms, or each arm of the inner reinforcing frame comprises an angled section having a height, which height is larger than a thickness of the angled section perpendicular to said height.

Particularly, according to an embodiment, a top side of the first arm of the inner reinforcing frame is connected to a bottom side of the first arm of the inner frame of the spring structure, a tops side of the second arm of the inner reinforcing frame is connected to a bottom side the second arm of the inner frame of the spring structure, a top side of the third arm of the inner reinforcing frame is connected to a bottom side of the third arm of the inner frame of the spring structure, and a top side of the fourth arm of the outer reinforcing frame is connected to a bottom side of the fourth arm of the inner frame of the spring structure.

According to a further embodiment of the optical device according to the present invention, an inner edge of the outer reinforcing frame comprises recesses for welding the outer reinforcing frame to the outer frame of the spring structure.

Further, in an embodiment, an outer edge of the inner reinforcing frame comprises recesses for welding the inner reinforcing frame to the inner frame of the spring structure.

Alternatively, according to an embodiment, said inner and outer edges can also be straight and a distance of outer edge of the inner reinforcing frame to the inner edge of outer reinforcing frame is then chosen such that a welding seam fits into a gap between said inner and outer edges.

Particularly, according to an embodiment, the inner and the outer frame are made out of a non-magnetic material to avoid a magnetic coupling between an actuator (e.g. electromagnet, electropermanent magnet, voice coil motor etc.), the spring structure and the support frame so as to increase the actuator performance.

Furthermore, according to an embodiment, an inner edge of the outer reinforcing frame comprises two opposing recesses for avoiding a contact between the first torsion bars and the outer reinforcing frame. This allows to increase the lifetime of the springs/first torsion bars since less stress on the spring results.

According to a further embodiment of the optical device according to the present invention, the optical device comprises at least one Hall sensor for determining the spatial position of the plate member (or of any other component moving with the plate member such as the inner frame of the spring structure or the inner reinforcing frame). Particularly, the at least one Hall sensor is connected to the support frame and configured to sense a magnetic field generated by a magnet of the optical device, wherein the at least one Hall sensor faces said magnet, and wherein the magnet is connected to the carrier.

Particularly, the at least one Hall sensor can be arranged on a printed circuit board that is connected to the support frame.

Thus, when the plate member is tilted the magnet moves with respect to the at least one Hall sensor and the at least one Hall sensor is configured to generate an output signal, wherein the optical device is configured to use this output signal as a feedback signal in a closed-loop control of an actuator (e.g. electromagnet, electropermanent magnet, voice coil motor etc.) that is configured to tilt the plate member (e.g. so that the feedback signal approaches a desired reference value) as will be described further below.

Further, according to an embodiment, the inner reinforcing frame comprises at least one wing protruding from the third or from the fourth arm of the inner reinforcing frame, wherein said magnet is arranged on said at least one wing.

Particularly, the optical device comprises four Hall sensors for determining the spatial position of the plate member (or of any other component moving with the plate member such as the inner frame of the spring structure or the inner reinforcing frame), wherein said Hall sensors are connected to the support frame. Particularly, each of these Hall sensors is configured to sense a magnetic field generated by an associated magnet of the optical device, wherein the respective Hall sensor faces the respective associated magnet.

Here, particularly, the inner reinforcing frame comprises four wings, wherein each of said magnets is connected to an associated wing (of said four wings). Particularly, there are two opposing wings protruding from the third arm of the inner reinforcing frame as well as two opposing wings protruding from the fourth arm of the inner reinforcing frame.

Particularly, each of these two wings protrudes from an end section of the third arm, wherein particularly the third arm is connected via one of these end sections to the first arm of the inner reinforcing frame, and wherein particularly the third arm is connected via the other end section to the second arm of the inner reinforcing frame.

Further, particularly, each of the two other opposing wings protrude from an end section of the fourth arm of the inner reinforcing frame, wherein particularly the fourth arm of the inner reinforcing frame is connected via one of these end sections to the first arm of the inner reinforcing frame, and wherein particularly the fourth arm of the inner reinforcing frame is connected via the other end section to the second arm of the inner reinforcing frame.

Alternatively, for controlling the tilting of the carrier about the first and/or second axis, the optical device is configured to measure an inductance of one or several of the coils of the actuators/electromagnets (see below) partically, by means of an inductance to digital converter (LCD) chip or inductance to digital converter circuit (e.g. like LDC1612, LDC1614 by Texas Instruments). The LDC is further configured to generate a corresponding output signal indicative of said inductance, wherein the optical device is configured to use this output signal as a feedback signal in a closed-loop control of an actuator (e.g. electromagnet, electropermanent magnet, voice coil motor etc.) that is configured to tilt the plate member (e.g. so that the feedback signal approaches a desired reference value) as will be described further below.

Furthermore, alternatively, for controlling the tilting of the carrier about the first and/or second axis, the optical device is configured to measure the position of the said plate member optically by using a light source that illuminates the plate member (e.g. glass plate) and/or the tilting carrier under an angle, and to measure the reflected or transmitted light from the plate member or the tilting carrier of said light source with an optical means (e.g. a photo diode, or a photosensitive device, or some other optical position sensitive device (e.g. PSD, CCD camera) or similar).

Particularly, said optical means is configured to generate an output signal, wherein the optical device is configured to use this output signal as a feedback signal in a closed-loop control of an actuator (e.g. electromagnet, electropermanent magnet, voice coil motor etc.) that is configured to tilt the plate member (e.g. so that the feedback signal approaches a desired reference value) as will be described further below.

Furthermore, according to an embodiment of the optical device according to the present invention, the support frame comprises a first arm and an opposing second arm, wherein the first and the second arm of the support frame are connected by a third and a fourth arm, and wherein one of said fastening regions is connected to the first arm of the support frame while the other fastening region is connected to the second arm of the support frame.

Particularly, according to an embodiment, the third and the fourth arm of the support frame each comprise an (e.g. elongated) opening for increasing the field of view of light incident on the optical device (particularly incident on the plate member).

Further, according to an embodiment, the first arm of the support frame and the second arm of the support frame each comprise a bulge on which the respective fastening region is mounted. Alternatively, one of the fastening regions can be mounted via an intermediate plate to the first arm of the support frame while the other fastening region can be mounted via an intermediate plate to the second arm of the support frame of the optical device.

Furthermore, according to an embodiment of the optical device according to the present invention, the support frame comprises four legs for mounting the support frame to a further part, wherein two opposing legs protrude from the first arm of the support frame, and wherein two further opposing legs protrude from the second arm of the support frame. Particularly, each leg protrudes from an associated end section of the respective arm of the support frame.

Particularly, according to an embodiment, each leg comprises a mounting portion for mounting the support frame to said further part and a bridge portion integrally connected to the mounting portion, wherein the mounting portion is connected to the support frame via the bridge portion. Further, particularly, the bridge portion comprises a width that is smaller than a width of the mounting portion so that particularly the legs are configured to flex with respect to the respective arm of the support frame for noise decoupling and/or mechanic stress release upon mounting of the support frame to said further part.

Furthermore, according to an embodiment, each mounting portion comprises a recess for receiving a grommet, through which a screw may extend for fasting the respective mounting portion to a further part using said screw. Particularly, the grommet surrounds the screw and particularly serves for noise reduction/damping mechanical vibrations. The grommet can be formed out of an elastic material, such as e.g. silicone, EPDM, a rubber, FKM, NBR etc.

According to a further embodiment of the optical device according to the present invention, at least one separate mass body is mounted on the support frame for increasing the mass and thus the moment of inertia of the support frame and therewith stability of the optical device. Particularly, in an embodiment, the optical device comprises two mass bodies, wherein one mass body is mounted to the first arm of the support frame and the other mass body is mounted to the second arm of the support frame.

Particularly, according to an embodiment, the support frame is made out of a non-magnetic material to avoid a magnetic coupling between an actuator (e.g. electromagnet, electropermanent magnet, voice coil motor etc.), the spring structure and the support frame so as to increase the actuator performance.

Further, particularly, according to an embodiment, the support frame is made out of a material having good thermal conductivity to transfer the heat away from the actuators as well as from the spring structure (heat impact due to incident light is possible).

Furthermore, according to an embodiment of the optical device according to the present invention, the actuator means comprises a first electromagnet that forms a first gap with a first magnetic flux guiding region of the carrier for holding the carrier in the first stable state by exerting a reluctance force on said first magnetic flux guiding region of the carrier, wherein particularly in said first stable state said reluctance force balances a counterforce that acts on the carrier such that the first electromagnet does not contact said first magnetic flux guiding region, and particularly such that when the reluctance force is turned off, the carrier is moved to the second stable state by means of said counterforce. Particularly, the first magnetic flux guiding region protrudes from the third arm of the outer frame of the spring structure and is particularly integrally connected to said third arm of the outer frame of the spring structure.

Furthermore, according to an embodiment of the optical device according to the present invention, the actuator means comprises a second electromagnet that forms a second gap with a second magnetic flux guiding region of the carrier for holding the carrier in the second stable state by exerting a reluctance force on said second magnetic flux guiding region of the carrier, wherein particularly in said second stable state said reluctance force balances a counterforce that acts on the carrier such that the second electromagnet does not contact said second magnetic flux guiding region, and particularly such that when the reluctance force is turned off, the carrier is moved to the first stable state by means of said counterforce. Particularly, the second magnetic flux guiding region protrudes from the fourth arm of the outer frame of the spring structure and is particularly integrally connected to said fourth arm of the outer frame of the spring structure.

Furthermore, according to an embodiment of the optical device according to the present invention, the actuator means comprises a third electromagnet that forms a third gap with a third magnetic flux guiding region of the second part of the carrier for holding the second part of the carrier in its first stable state by exerting a reluctance force on said third magnetic flux guiding region of the second part of the carrier, wherein particularly in said first stable state said reluctance force balances a counterforce that acts on the second part of the carrier such that the third electromagnet does not contact said third magnetic flux guiding region, and particularly such that when the reluctance force is turned off, the second part of the carrier is moved to its second stable state by means of said counterforce. Particularly, the third magnetic flux guiding region protrudes from the third arm of the inner frame of the spring structure and is particularly integrally connected to said third arm of the inner frame of the spring structure.

Furthermore, according to an embodiment of the optical device according to the present invention, the actuator means comprises a fourth electromagnet that forms a fourth gap with a fourth magnetic flux guiding region of the second part of the carrier for holding the second part of the carrier in the second stable state by exerting a reluctance force on said fourth magnetic flux guiding region of the second part of the carrier, wherein particularly in said second stable state said reluctance force balances a counterforce that acts on the second part of the carrier such that the fourth electro magnet does not contact said fourth magnetic flux guiding region, and particularly such that when the reluctance force is turned off, the second part of the carrier is moved to its first stable state by means of said counterforce. Particularly, the fourth magnetic flux guiding region protrudes from the fourth arm of the inner frame of the spring structure and is particularly integrally connected to said fourth arm of the inner frame of the spring structure.

Particularly, in the above, the respective electromagnet comprises an electrically conducting coil wound around a coil core (which coil core is preferably formed out of a magnetically soft material), wherein the coil core comprises two opposing end sections forming a pole shoe, respectively, which end sections form the respective gap with the associated magnetic flux guiding region.

Particularly, the respective coil core can be formed out of or comprise one of the following materials: ferrits, ceramic ferrits, iron powder, stainless steel, e.g. of DIN types 1.4004-1.4040 or their international equivalents such as SUS410-SUS440, or similar.

Furthermore, according to an embodiment, the respective counterforce is configured such that the respective gap is prevented from being closed completely. Thus a contact of the respective magnetic flux guiding region to the end sections (pole shoes) of the respective coil core is always prevented. For this, said springs (e.g. first and/or second torsion bars) are designed such that in the vicinity of a contact between the respective magnetic flux guiding region and the end sections of the associated coil core, the counterforce is larger than the reluctance force so that the contact cannot occur or a snap-in cannot occur.

Particularly, according to an embodiment, the respective coil core is connected to the support frame, wherein particularly the respective coil core is glued, screwed or welded to the support frame.

Particularly, according to an embodiment, the coil core of the first electromagnet is connected to the third arm of the support frame. Further, particularly, the coil core of the second electromagnet is connected to the fourth arm of the support frame. Further, particularly, the coil core of the third electromagnet is connected to the first arm of the support frame. Furthermore, particularly, the coil core of the fourth electromagnet is connected to the second arm of the support frame.

Furthermore, particularly, the glue can be applied merely to the end sections of the coil core or to an entire bottom side of the respective electromagnet, i.e. to the end sections and a bottom side of the coil surrounding the coil core. Particularly, a gap between the coil core and the support frame is smaller than 300 μm according to an embodiment of the optical device.

Furthermore, according to an embodiment, the glue comprises a high heat conductivity, e.g. larger than 0.5 W/mK, particularly larger than 1 W/mK, and a low heat expansion, e.g. smaller than 10 ppm/K, particularly smaller than 100 ppm/K, particularly smaller than 200 ppm/K.

Furthermore, the glue can comprise bodies/particles (spacers) capable of conducting heat and/or having a low heat expansion (see also above).

Furthermore, according to an embodiment, the optical device comprises a rigid substrate, particularly a printed circuit board, e.g. for carrying electrical components of the optical device, which substrate may be connected to the support frame.

Particularly, at least one flexible printed circuit boards protrudes from said substrate, which flexible printed circuit board comprises solder pads for making an electrical connection to an actuator of the optical device, particularly to an electromagnet, electropermanent magnet or voice coil motor. The respective actuator (e.g. electromagnet, electropermanent magnet or voice coil motor) preferably comprises electrically isolated (with respect to each other) contact pads or members via which the respective actuator is soldered to said solder pads. This allows one to automatically solder/connect the individual actuator to its associated solder pads of the associated flexible printed circuit board.

Particularly, the optical device comprises a number of flexible printed circuit boards having such solder pads, which number of flexible printed circuit boards corresponds to the number of actuators (e.g. electromagnets, electropermanent magnets or voice coil motors).

Furthermore, according to an embodiment of the optical device according to the present invention, the optical device is configured apply a holding (electrical) current pulse to the respective coil to generate the respective reluctance force for holding the carrier, particularly its first part, in the respective stable state or for holding the second part of the carrier in the respective stable state (depending on which of the four coils is actually supplied with a holding current pulse).

Particularly, advantageously, having only such holding current pulses to actuate the actuators means that less parameter are needed for calibration of the optical device.

Furthermore, according to an embodiment, the optical device is also configured to apply an accelerating (electrical) current pulse before a holding current pulse to the respective coil to accelerate a transition between two stable states of the first or second part of the carrier.

Further, according to an embodiment, the optical device is configured to apply an accelerating current pulse to the coil of the first electromagnet so as to accelerate a transition of the carrier, particularly of its first part, from the second stable state to the first stable state (e.g. a tilting of the carrier about said first axis). Further, particularly, the optical device is configured to apply an accelerating current pulse to the coil of the second electromagnet so as to accelerate a transition of the carrier, particularly of its first part, from the first stable state to the second stable state (e.g. a tilting of the carrier about said first axis).

Further, according to an embodiment, the optical device is configured to apply an accelerating current pulse to the coil of the third electromagnet so as to accelerate a transition of the second part of the carrier from the second stable state to the first stable state (e.g. a tilting of the second part of the carrier about said second axis). Further, according to an embodiment, the optical device is configured to apply an accelerating current pulse to the coil of the fourth electromagnet so as to accelerate a transition of the second part of the carrier from the first stable state to the second stable state (e.g. a tilting of the second part of the carrier about said second axis).

Further, according to yet another embodiment of the optical device according to the present invention, the optical device is configured to apply a braking (electrical) current pulse before the holding current pulse and after the accelerating current pulse to a coil opposing the respective coil to which said accelerating and/or holding pulse are applied to slow down a transition between two stable states of the carrier (e.g. its first part) or of the second part of the carrier.

Particularly, according to an embodiment, the optical device is configured to apply a braking current pulse to the coil of the first electromagnet so as to decelerate a transition of the carrier, particularly of its first part, from the first stable state to the second stable state (e.g. a tilting of the carrier about said first axis). Further, according to an embodiment, the optical device is configured to apply a braking current pulse to the coil of the second electromagnet so as to decelerate a transition of the carrier, particularly of its first part, from the second stable state to the first stable state (e.g. a tilting of the carrier about said first axis).

Further, according to an embodiment, the optical device is configured to apply a braking current pulse to the coil of the third electromagnet so as to decelerate a transition of the second part of the carrier from the first stable state to the second stable state (e.g. a tilting of the second part of the carrier about said second axis).

Further, according to an embodiment, the optical device is configured to apply a braking current pulse to the coil of the fourth electromagnet so as to decelerate a transition of the second part of the carrier from the second stable state to the first stable state (e.g. a tilting of the second part of the carrier about said second axis). According to a further embodiment of the optical device according to the present invention, the optical device comprises a memory (e.g. semiconductor memory), particularly an EPROM or EEPROM, wherein the start time and the end time of the respective current pulse (e.g. holding, accelerating or braking current pulse) are stored, particularly for each tilting frequency of the carrier (e.g. first part) or second part of the carrier and particularly for a plurality of different (operating) temperatures of the optical device.

Particularly, for each electromagnet (actuator), parameter sets comprising the following parameters may be stored in said memory: tilting frequency, accelerating current pulse start time, accelerating current pulse end time, amplitude of the accelerating current pulse, holding current pulse start time, holding current pulse end time, amplitude of the holding current pulse, braking current pulse start time, braking current pulse end time, amplitude of the braking current pulse.

Furthermore, according an aspect of the present invention a calibration method is disclosed, wherein the optical device is calibrated by using transmission or reflection from a light source or a light pattern on the optical device (e.g. on the plate member) while tilting the carrier (e.g. first part) and/or second part of the carrier and optimizing the parameters regarding the holding, accelerating and or braking current pulses.

Furthermore, according to an embodiment, the optical device is configured to conduct a correction algorithm to compensate shifts of said parameters due to a change in (operating) temperature of the optical device.

The algorithm can use a lookup-table or a function such as polynomial of order n to change the timing and amplitudes of the holding, accelerating and/or braking current pulses.

According to yet another embodiment of the optical device according to the present invention, the optical device is configured to reduce noise generated by the optical device by at least one of:
suppressing higher frequencies of the holding current pulses, the acceleration current pulses, and/or the braking current pulses, particularly using one of a low pass filter, a notch filter, a band pass filter,
using holding current pulses, accelerating current pulses and/or accelerating pulses in the form of a sine signal, particularly in the form of a clipped sine signal.

Furthermore, according to an embodiment of the optical device according to the present invention, the plate member can be a rigid prism for steering of a light beam and particularly changing an angle of incoming light. Additionally, the whole optical device with the prism can be rotated in relation to the incident beam to steer the outcoming light beam in a wider range.

Particularly, the optical device can be used in a wide variety of technical applications, particularly for increasing resolution in 3D scanning of an object or space. Here, the optical device can be used in addition to a mirror to scan smaller areas in more detail.

Furthermore, the optical device according to the present invention can also be used for increasing resolution in 3D-printing as well as to increase resolution of a picture or a video by multiplexing pixels.

Furthermore, the optical device can also be used for speckle reduction. The angle movement/tilting of the plate member (e.g. glass), e.g. about said first and second axes (e.g. normal pixel shift movement or additional movement), reduces laser speckles. The tilting movement of the plate member can correspond to or resemble Lissajous figures.

Furthermore, according to an embodiment of the present invention, the plate member can be a diffuser that may be arranged directly after a laser light source.

Furthermore, the optical device according to the present invention can used in laser cinema and laser television (TV) applications.

Furthermore, particularly according to yet another aspect of the present invention, an optical device for enhancing the resolution of an image is disclosed, comprising:
a transparent plate member configured for refracting a light beam passing through the plate member, which light beam may project an image comprised of rows and columns of pixels,
a carrier to which said transparent plate member is rigidly mounted, wherein the carrier is configured to be moved between at least a first and a second state, whereby said light beam is shifted e.g. along a first direction (e.g. said projected image is shifted by a fraction of a pixel, particularly by a half of a pixel along the first direction),
wherein the optical device comprises an actuator means that is configured to force or initiate a transition of the carrier from the first state to the second state (or between any two states of the carrier) and vice versa.

This aspect of the present invention can be further characterized using the individual features described herein, particularly in the sub-claims relating to claim 1, wherein here the notion “stable state” is substituted by the notion “state”.

In the following, further advantages, features as well as embodiments of the present invention are described with reference to the Figures, wherein:

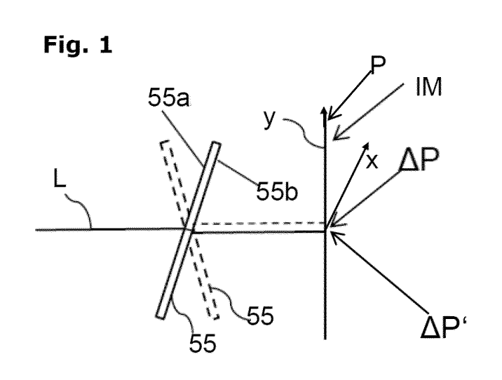

FIG. 1 shows the principle of shifting an image by a fraction of a pixel for a single direction x or in two directions x and y;

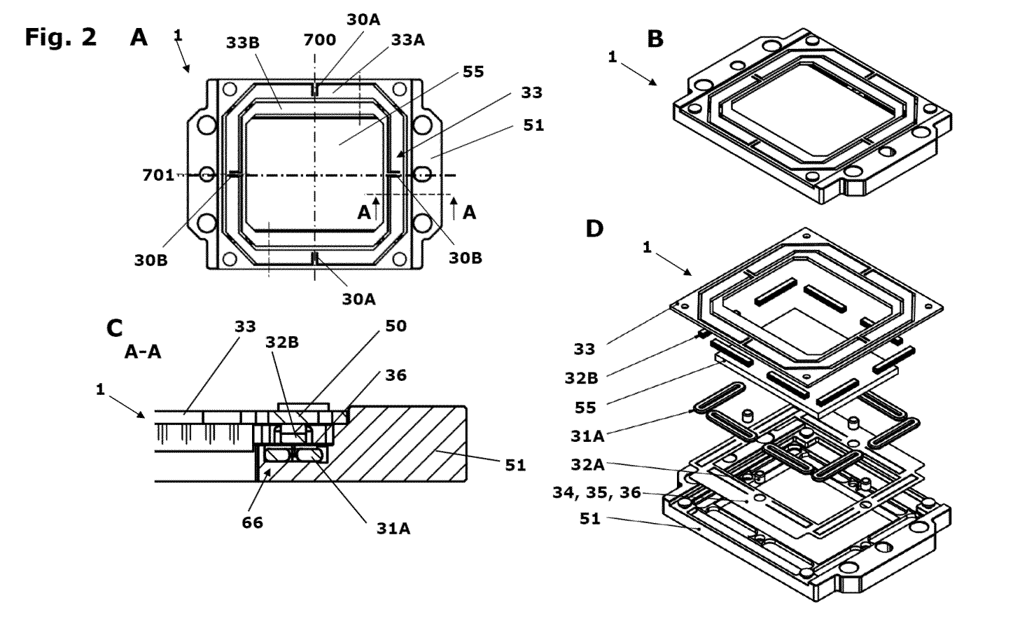

FIGS. 2A-2D shows different views of an embodiment of the optical device according to the invention;

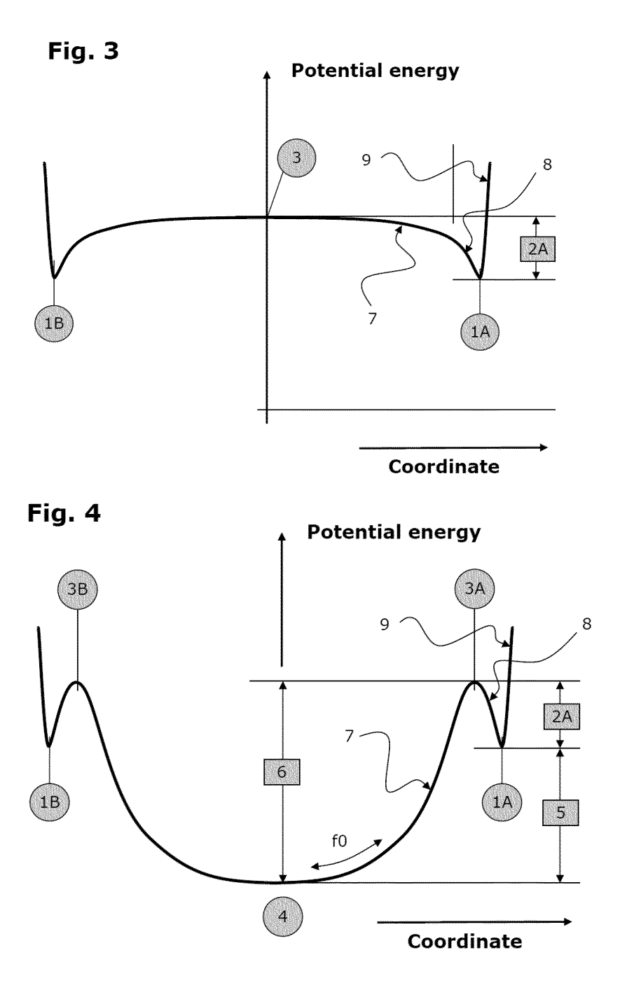

FIG. 3 shows the potential energy of a bistable carrier of the device according to the invention having a first and a second stable state;

FIG. 4 shows the potential energy of a tristable carrier of the device according to the invention having also an intermediate stable state (besides the first and second stable state);

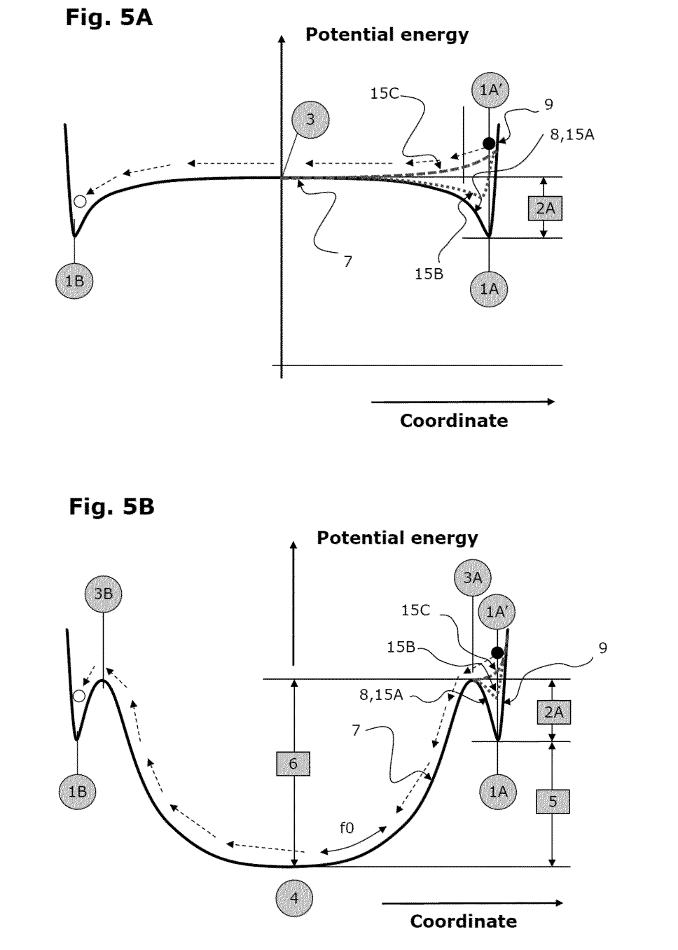

FIG. 5A shows a transition between the two stable states of the bistable carrier of FIG. 3 using static switching of said states;

FIG. 5B shows a transition between the two stable states of the tristable carrier of FIG. 4 using static switching;

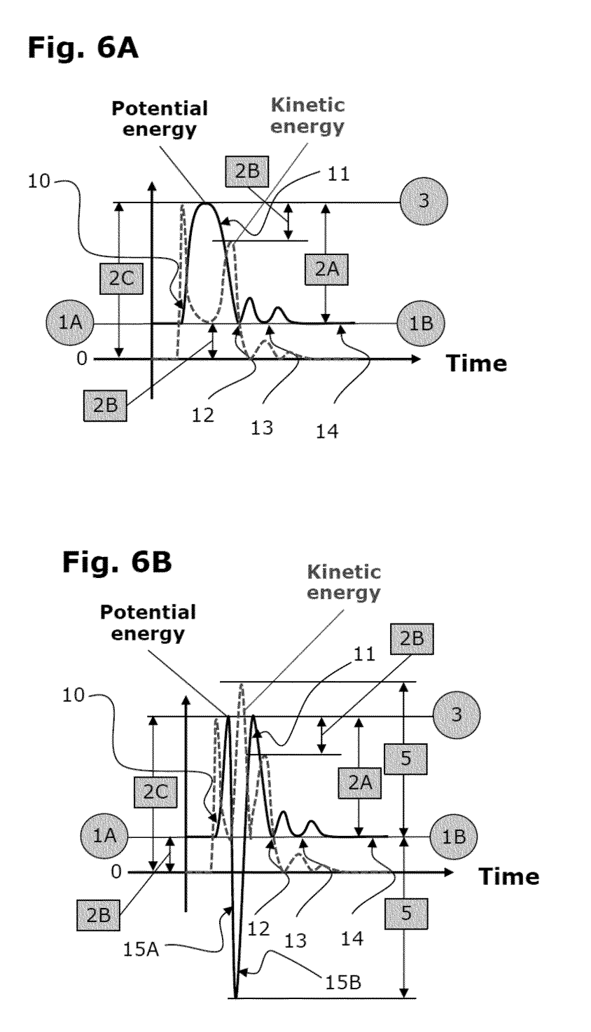

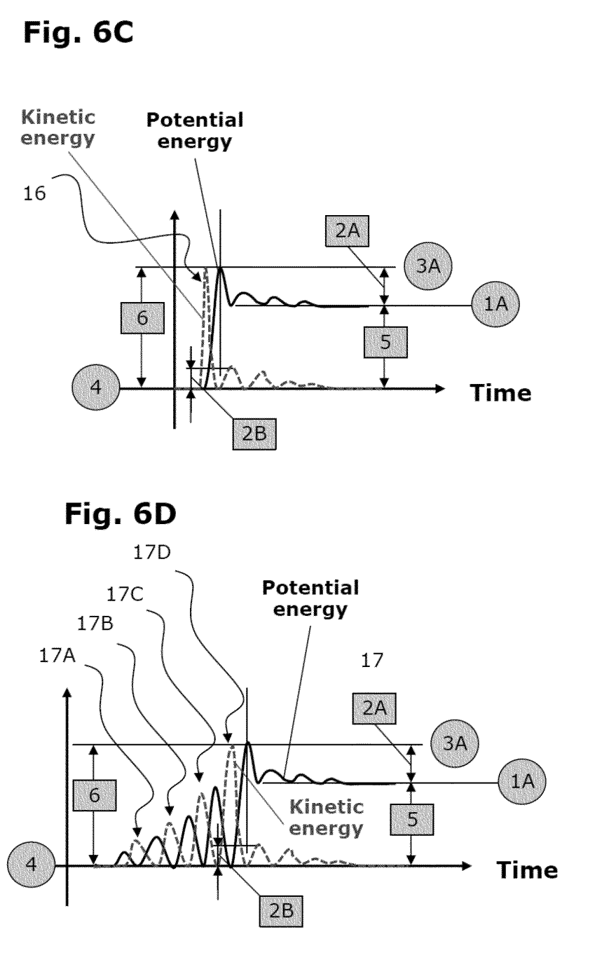

FIG. 6A shows a transition between the two stable states of the bistable carrier of FIG. 3 using dynamic switching of said states;

FIG. 6B shows a transition between the two stable states of the tristable carrier of FIG. 4 using dynamic switching;

FIG. 6C shows a start sequence of the optical device wherein the carrier is brought from the intermediate stable state to the first (or second) stable state by means of a force kick;

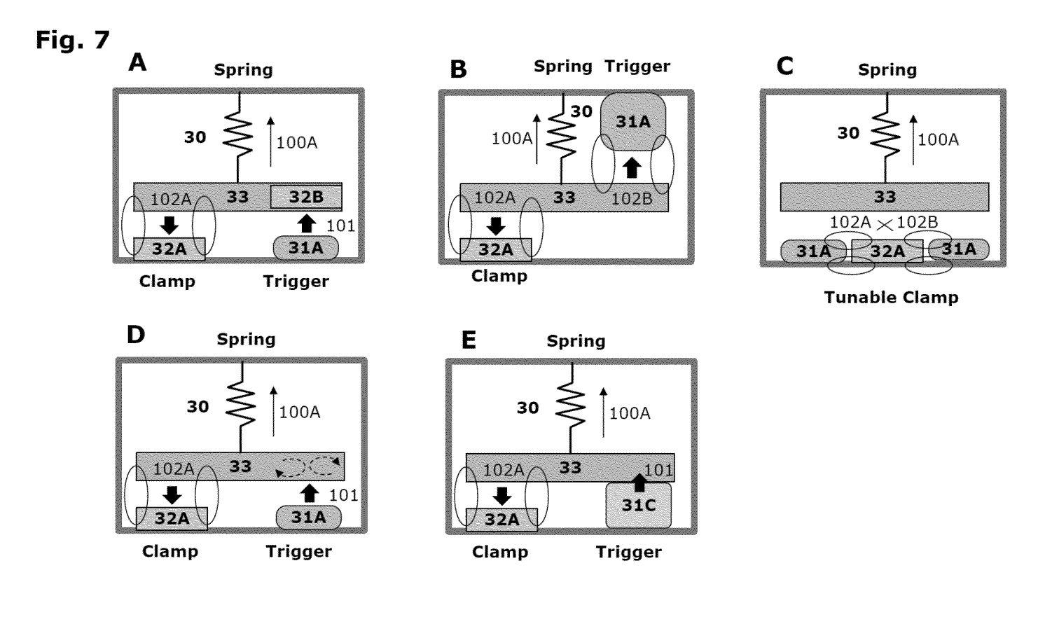

FIG. 6D shows a start sequence of the optical device wherein the carrier is brought from the intermediate stable state to the first (or second) stable state by means of resonant amplification; FIGS. 7A-7E show different embodiments of clamping and disengaging means of the optical device according to the invention;

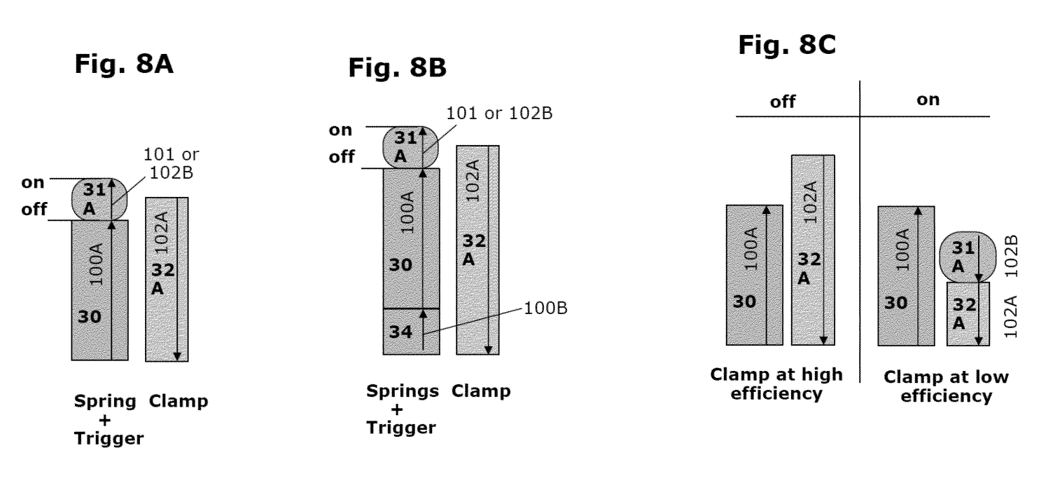

FIGS. 8A-8C show different force balances employed by the clamping and disengaging means of the optical device according to the invention;

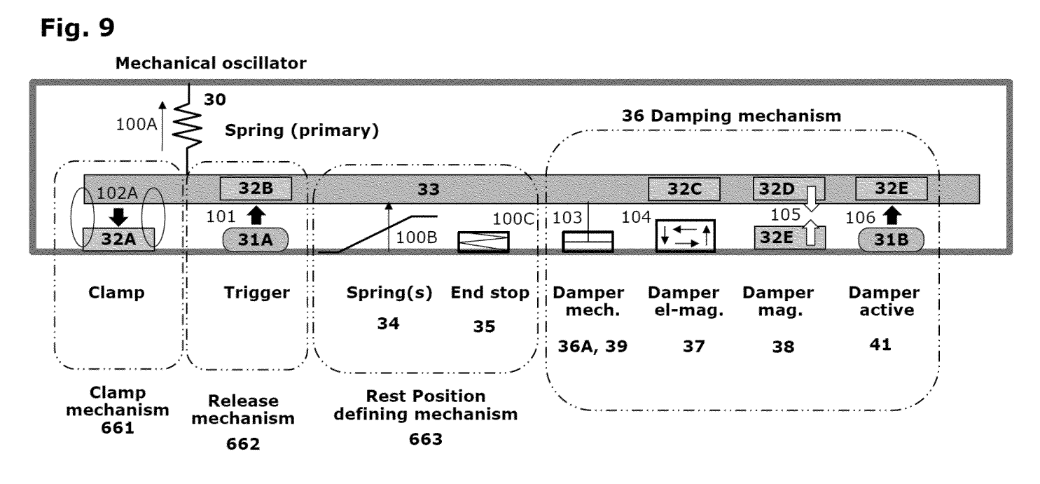

FIG. 9 shows a block diagram of a device according to the invention for one of the stable states, explaining the possible clamp mechanism, release mechanism, mechanical rest position defining mechanism and damping mechanism, wherein a mechanical hard stop is provided for the carrier;

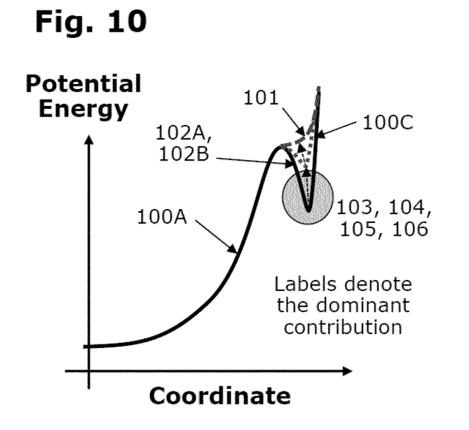

FIG. 10 shows where the individual forces of the embodiment of FIG. 9 act;

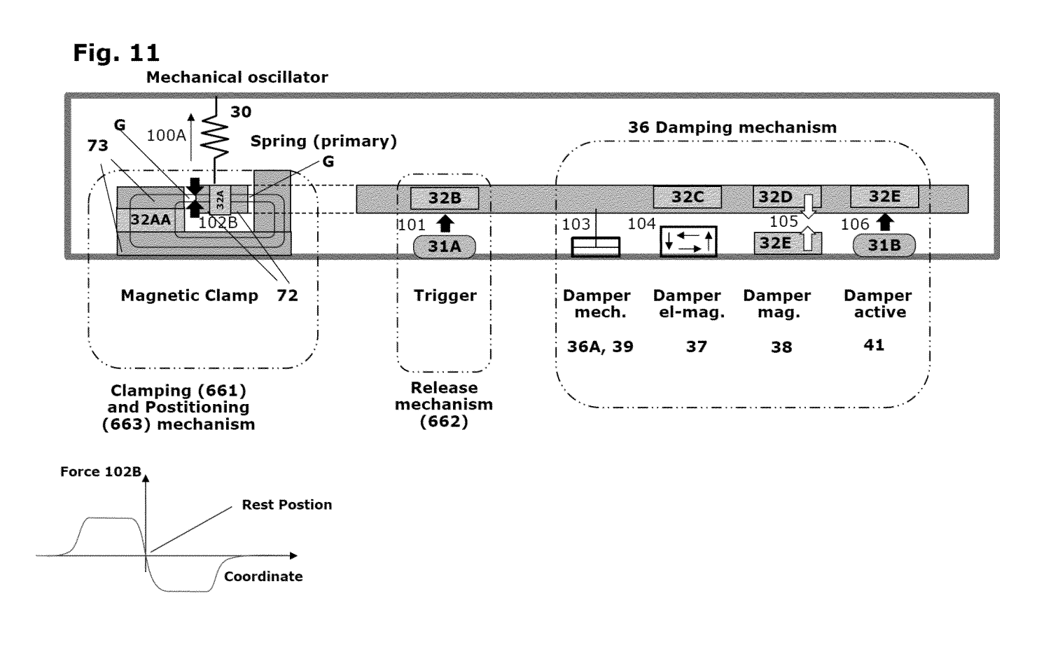

FIG. 11 shows a modification of the embodiment of FIG. 9 (for one stable state), wherein no mechanical stop is provided for the carrier;

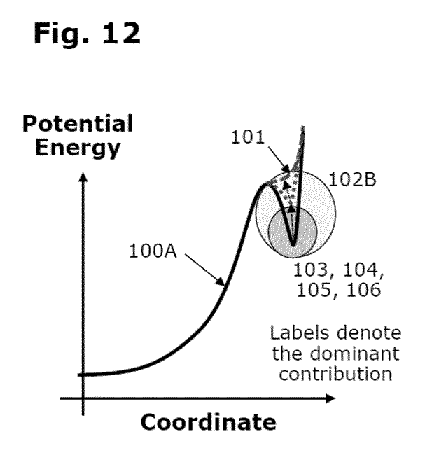

FIG. 12 shows where the individual forces of the embodiment of FIG. 11 act;

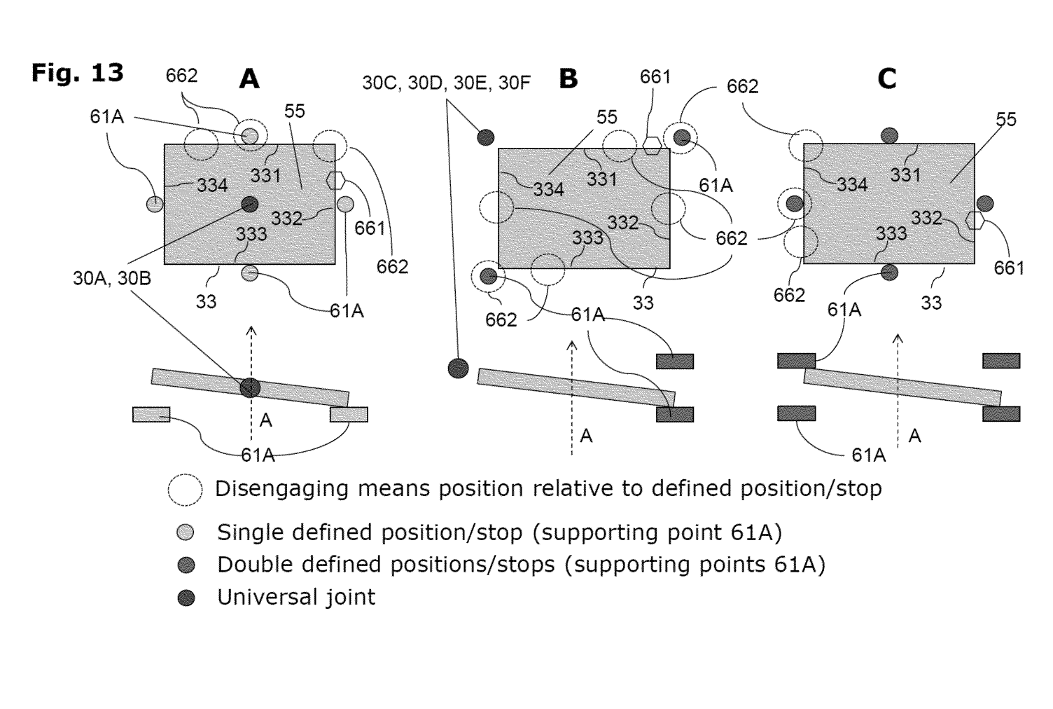

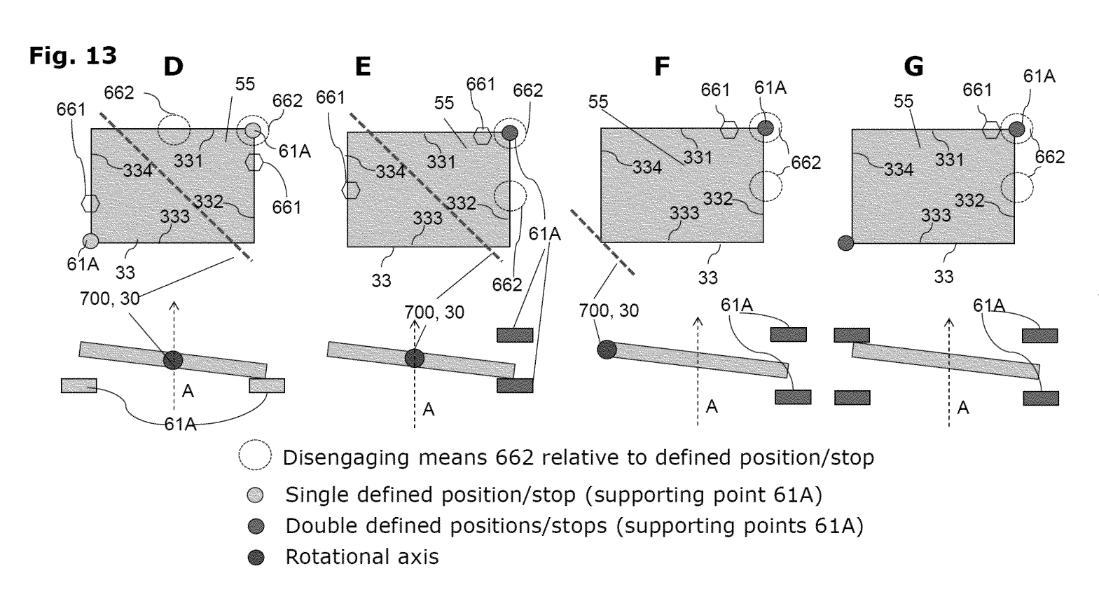

FIGS. 13A-13G shows different embodiments of the optical device according to the invention relating to defined rest positions and actuator positions for four different rest positions/stable states (A to C) and two different rest positions/stable states (D to G);

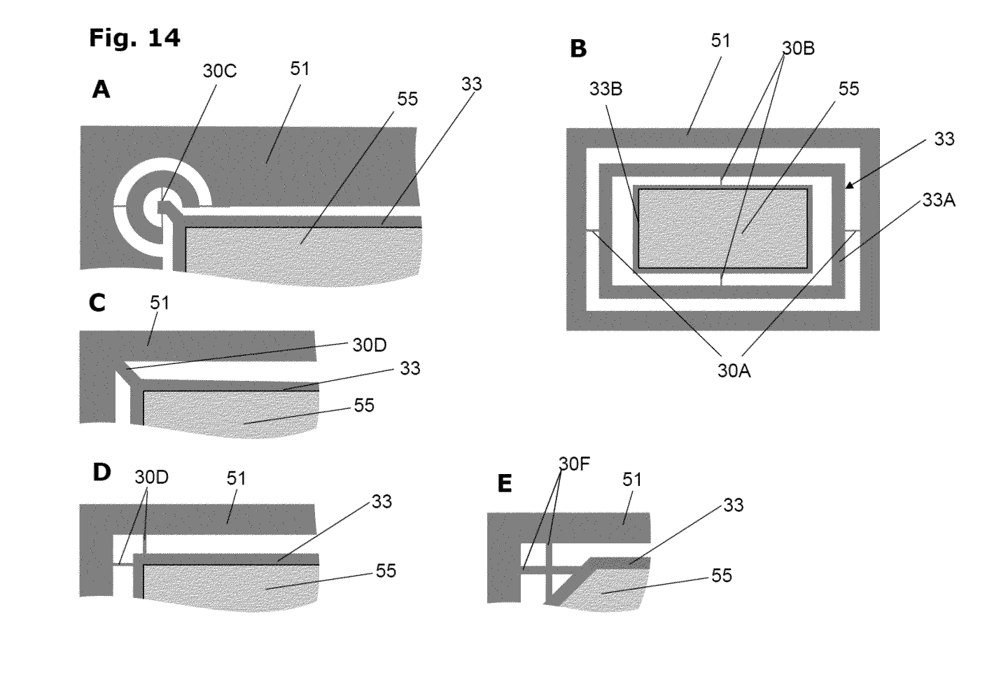

FIGS. 14A-14E shows different embodiments of the optical device according to the invention relating to the position and configuration of springs or rotational joints/flexures via which the carrier is connected to a support frame;

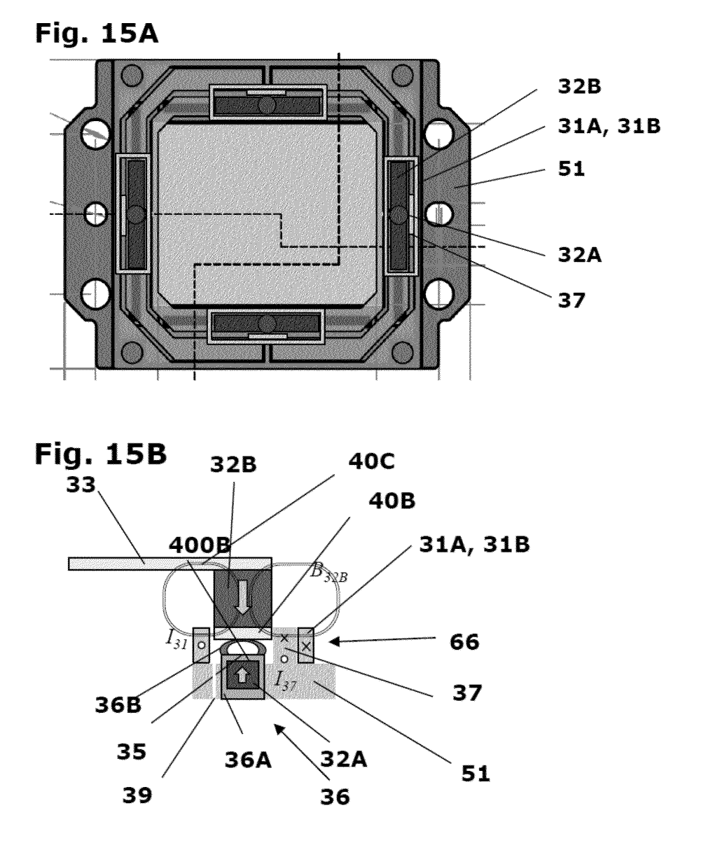

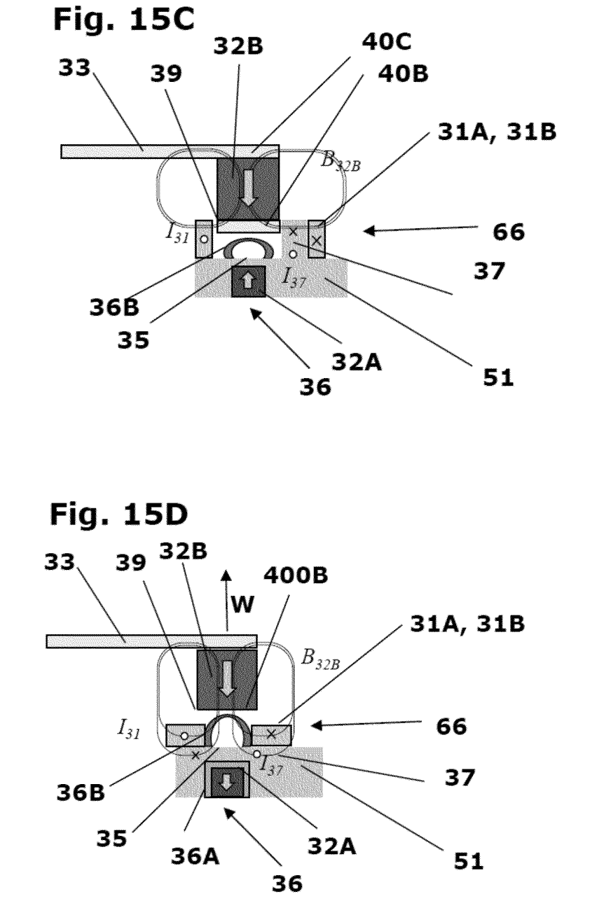

FIGS. 15A-15D shows different embodiments of the optical device as shown in FIG. 15A relating to the configuration of a damping means of the optical device according to the invention as well as the configuration of magnets and coils of the actuator means (disengaging means);

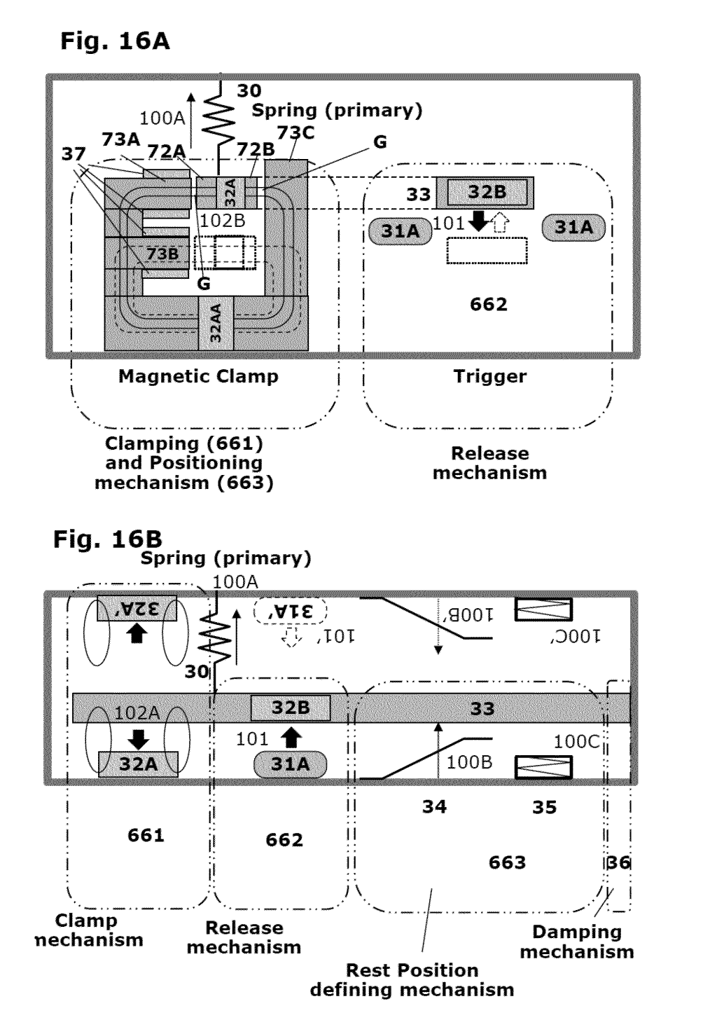

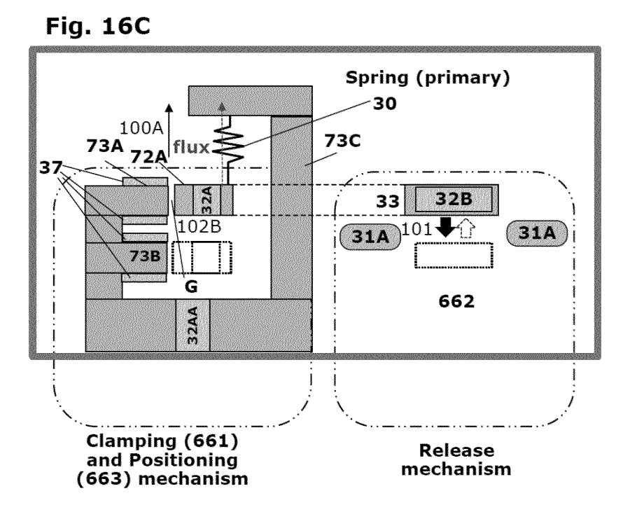

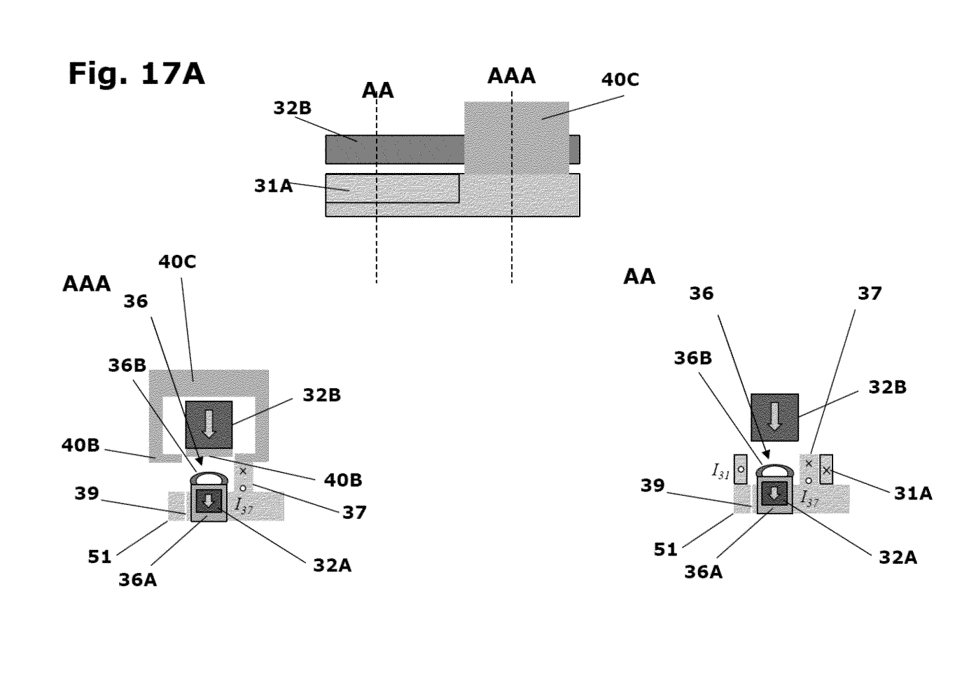

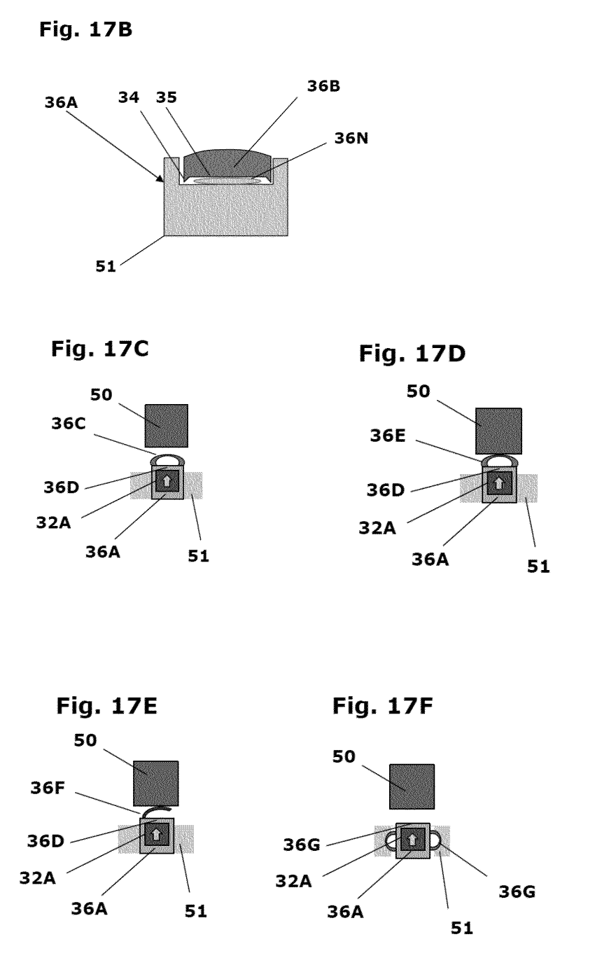

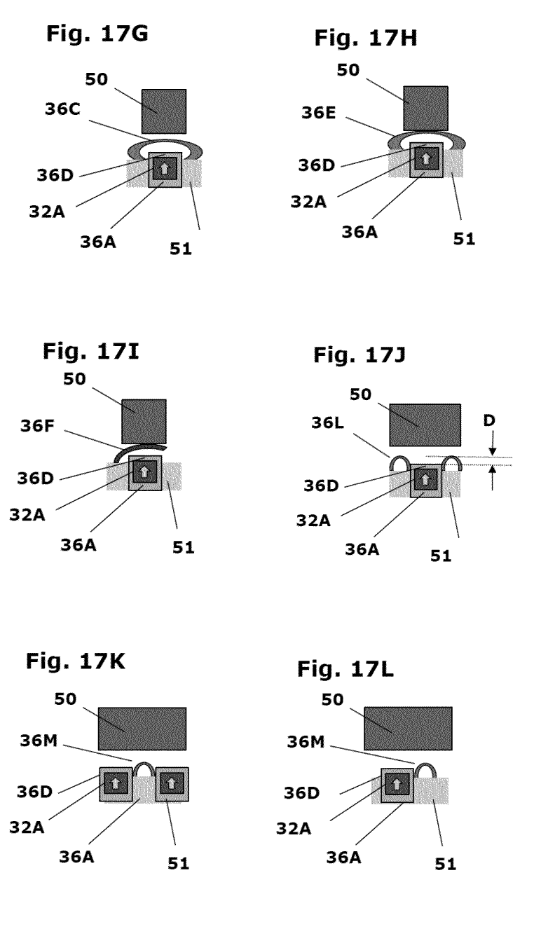

FIGS. 16A-160 show further block diagrams of optical devices according to the invention implementing both stable states; FIGS. 17A-17L shows different embodiments of the optical device according to the invention relating to the configuration of the damping means;

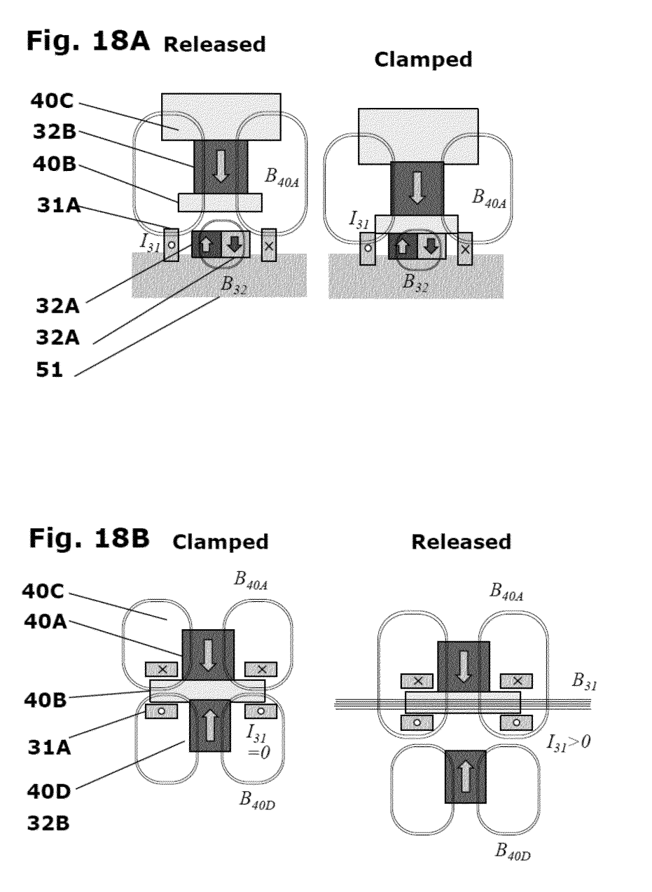

FIG. 18A-18B shows different embodiments of the optical device according to the invention relating to the clamping means and disengaging means;

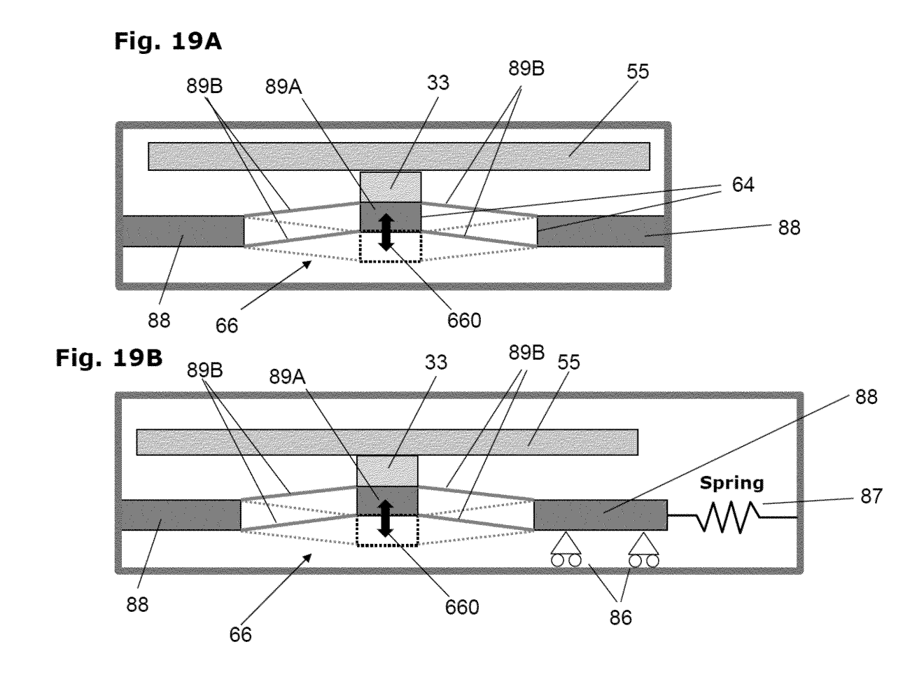

FIG. 19A, 19B shows different embodiments of the optical device according to the invention comprising a bistable mechanical actuator means;

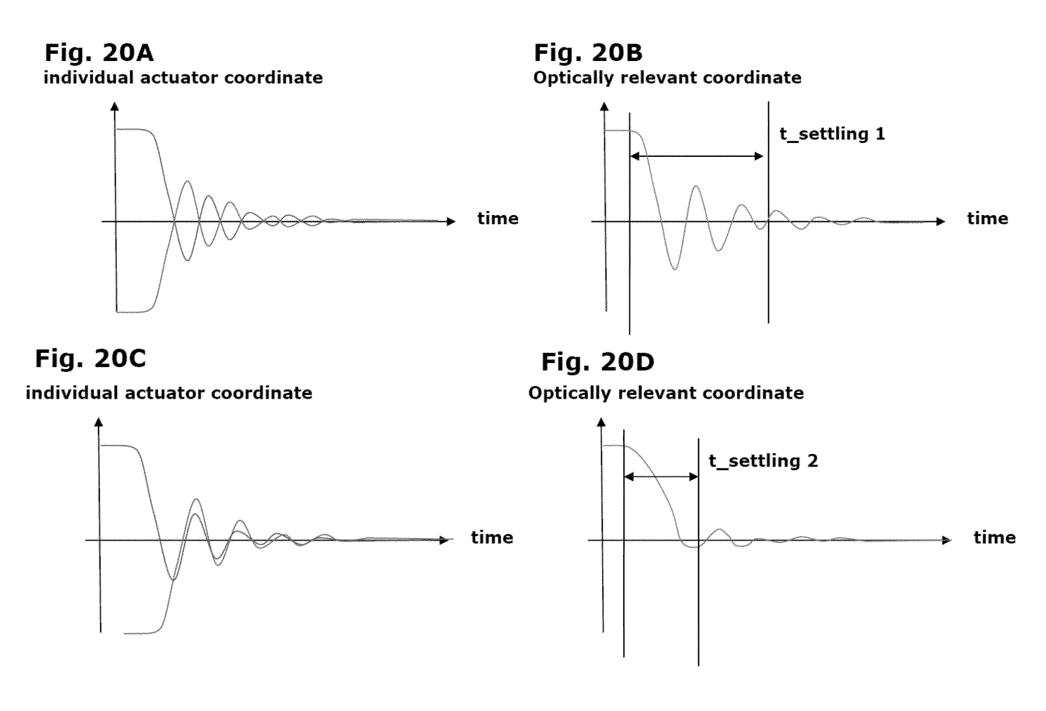

FIG. 20A-20D show how to achieve a reduction of ringing in the embodiment according to FIG. 13C and FIG. 13G;

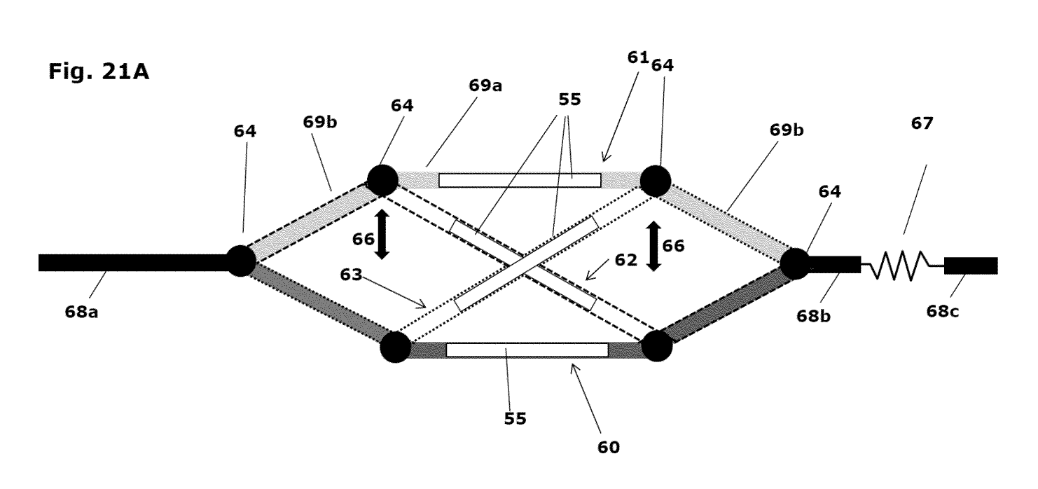

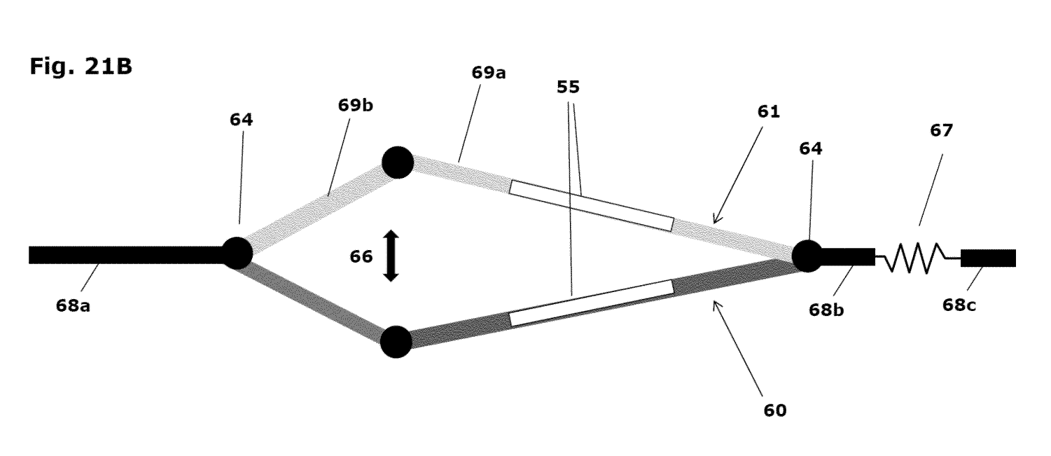

FIG. 21A, 21B show embodiments of the optical device according to invention, wherein the carrier is hinged to a support such that it is quadristable (FIG. 21A) or bistable (FIG. 21B);

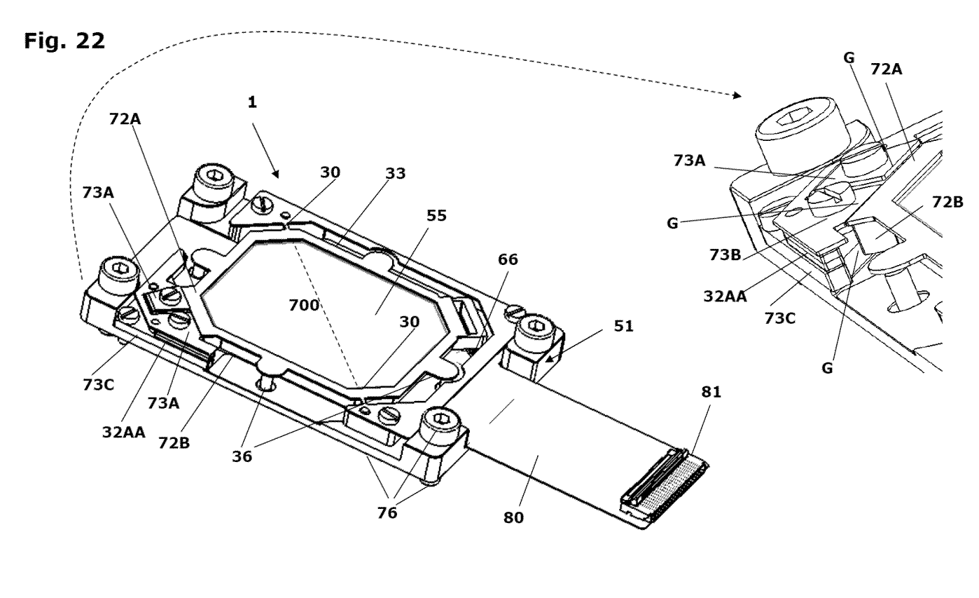

FIG. 22 shows an embodiment of the optical device according to the invention comprising a bistable or tristable carrier with at least two stable states, wherein the clamping means uses reluctance forces for providing clamping and defining of the rest positions of the carrier;

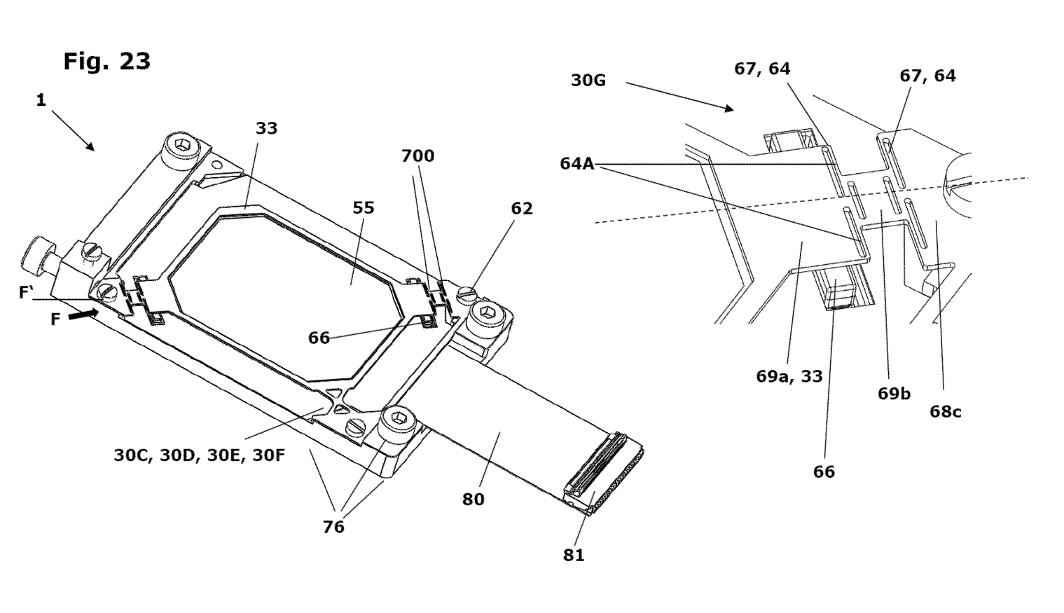

FIG. 23 shows an embodiment of the optical device according to the invention comprising a quadristable carrier (cf. FIG. 21A) with four stable states, wherein the joints via which the carrier is hinged to the support frame are integrally formed with springs;

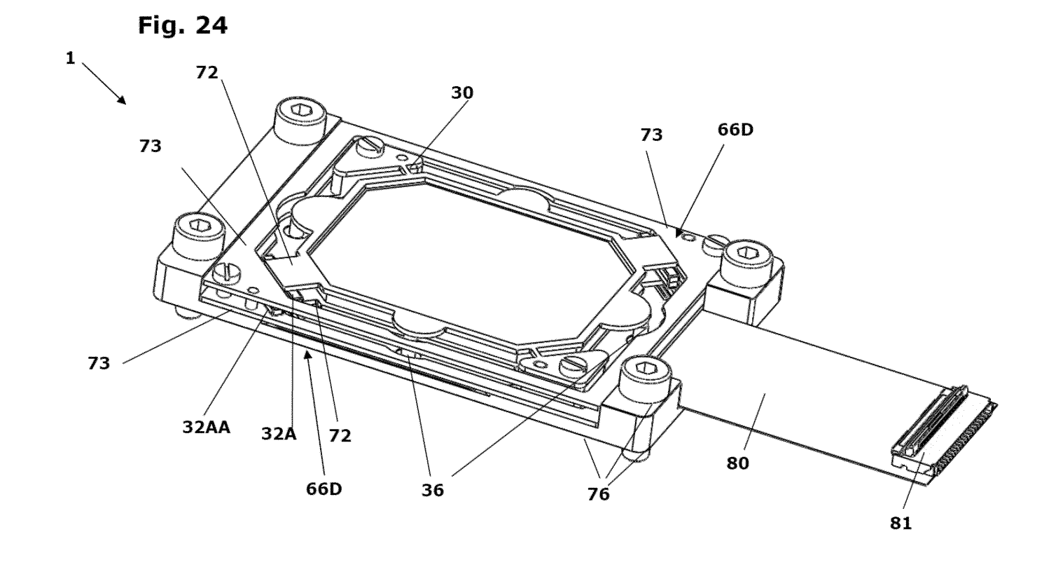

FIG. 24 shows a modification of the embodiment shown in FIG. 22;

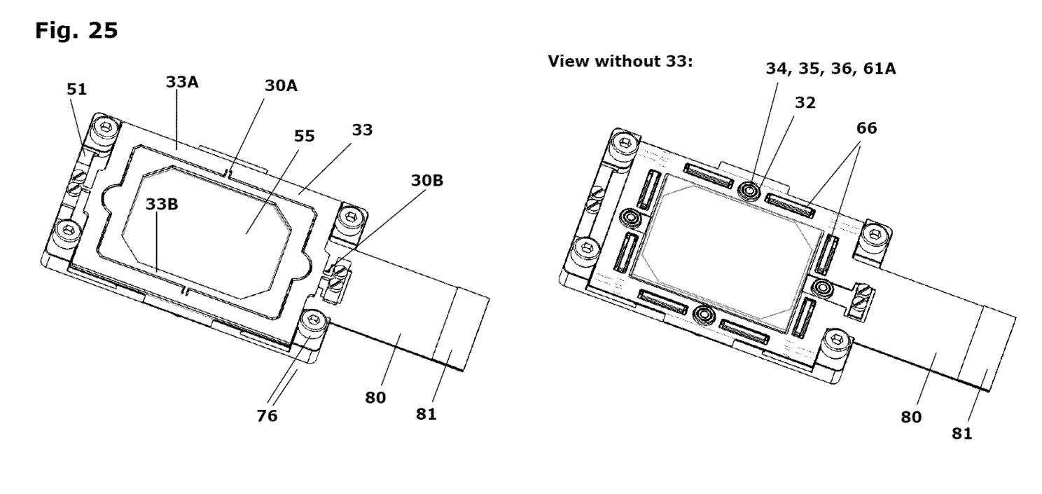

FIG. 25 shows two views of an embodiment of the optical device according to the invention (i.e. a modification of the embodiment shown in FIG. 2) comprising a carrier having a first part and a second part that can be independently tilted about an associated axis, respectively, wherein the tilt angle of the plate member is adjustable;

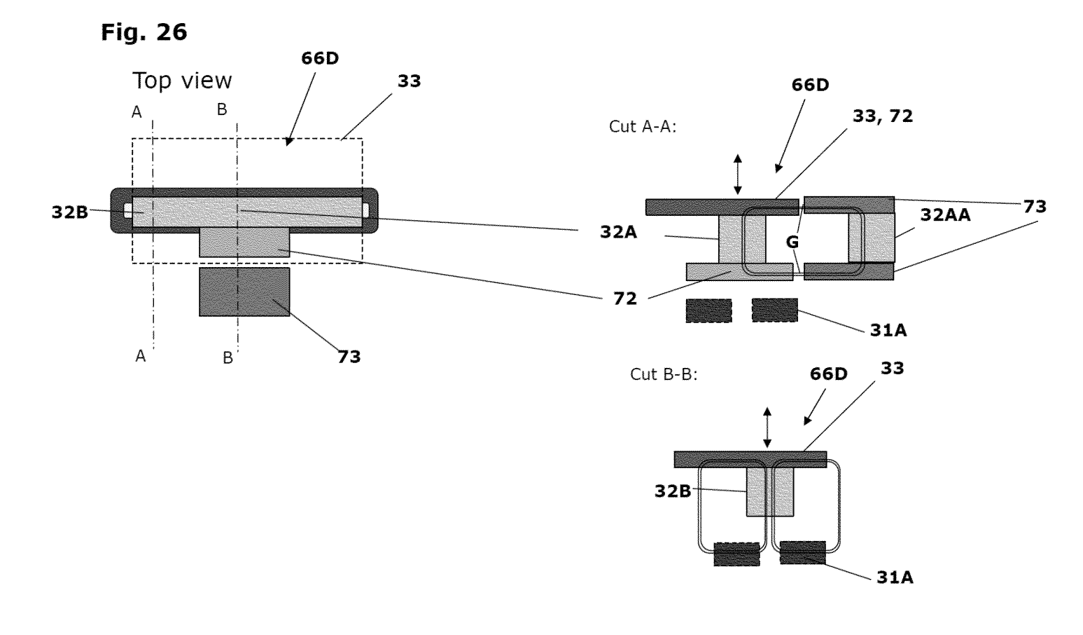

FIG. 26 shows different views an actuator means providing a disengaging means using a Lorentz force as well as a reluctance force for defining a rest position of the carrier;

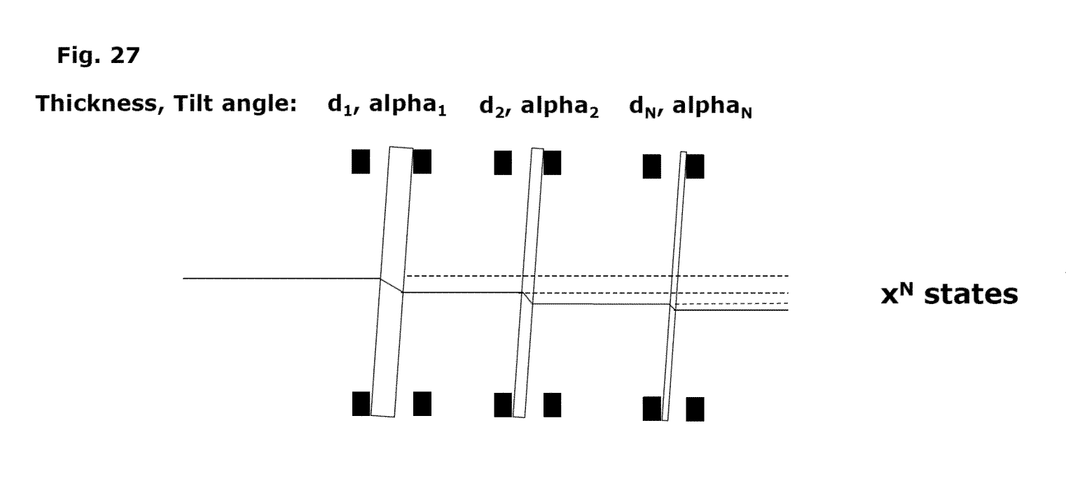

FIG. 27 shows the stacking of optical devices according to the invention in order to achieve shifting of the incident light beam (optical switching) corresponding to x″ different states, wherein x is the tilt angle of the carrier provided by the individual device and N is the number of stacked devices/carriers;

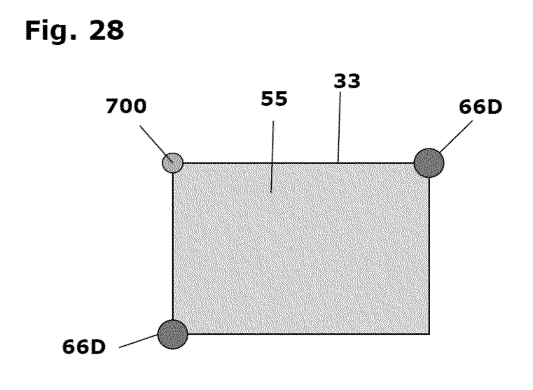

FIG. 28 shows a further possible arrangement of the actuators shown in FIG. 26 with respect to the carrier/plate member and its rotation axis;

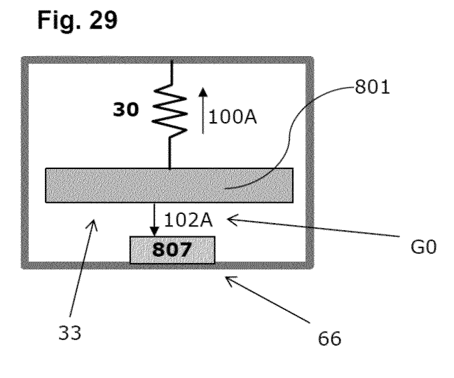

FIG. 29 shows a schematical illustration of a further embodiment of the present invention, having an actuator means that comprises at least one electropermanent magnet;

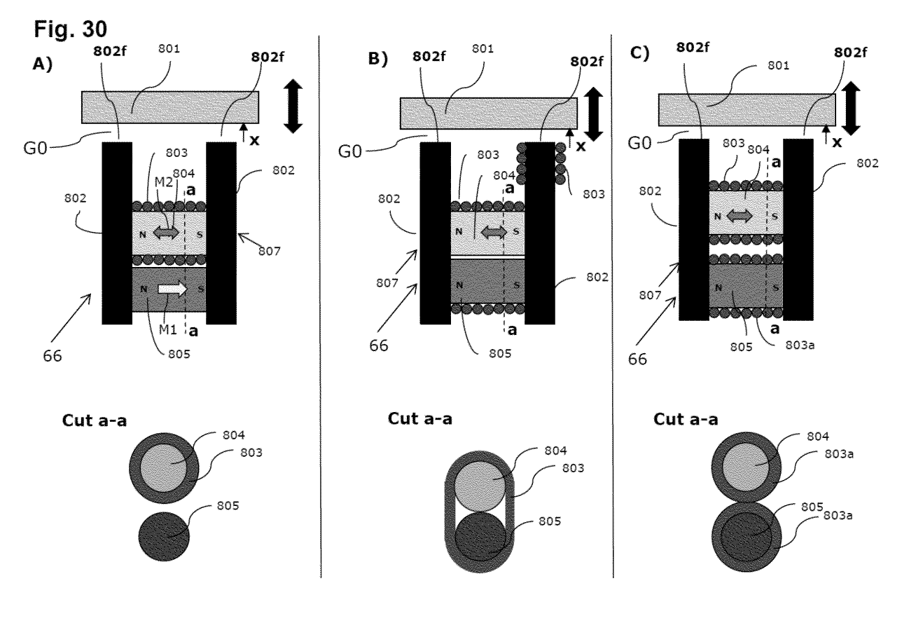

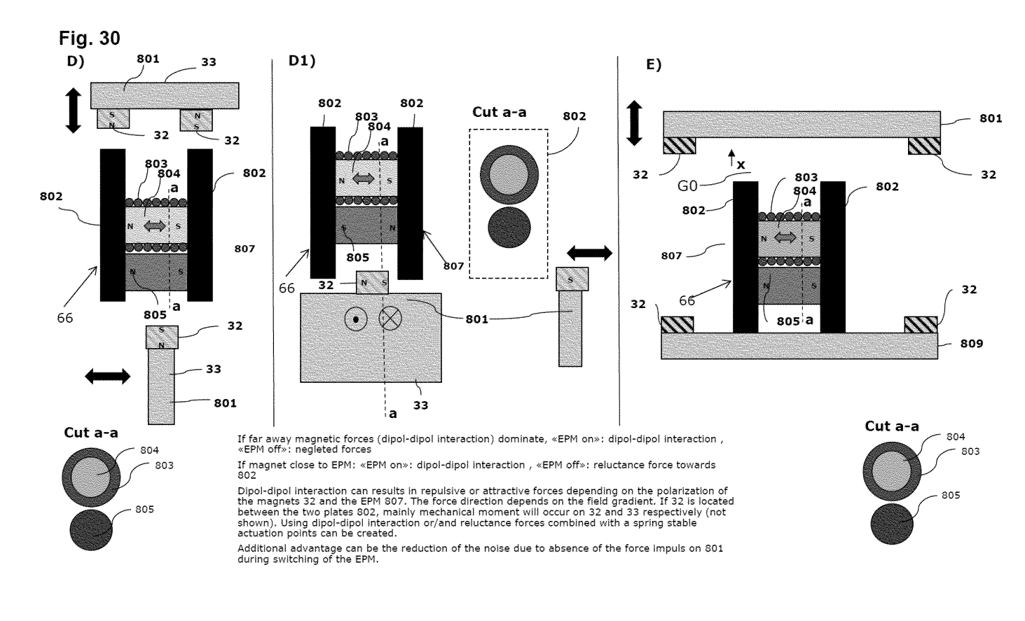

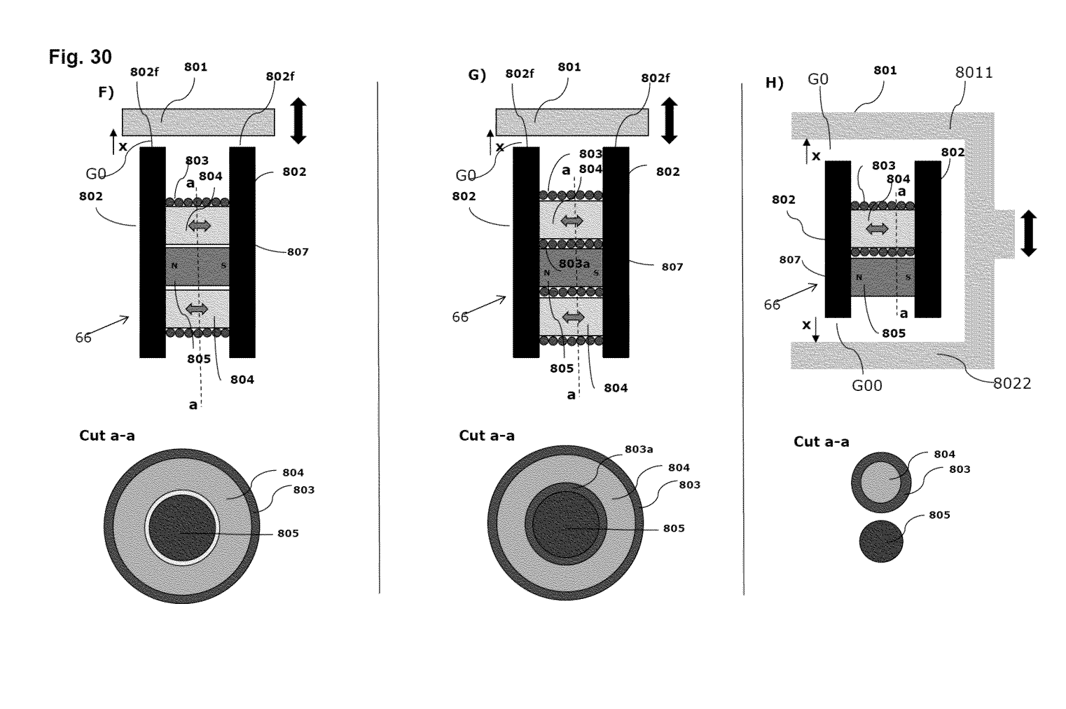

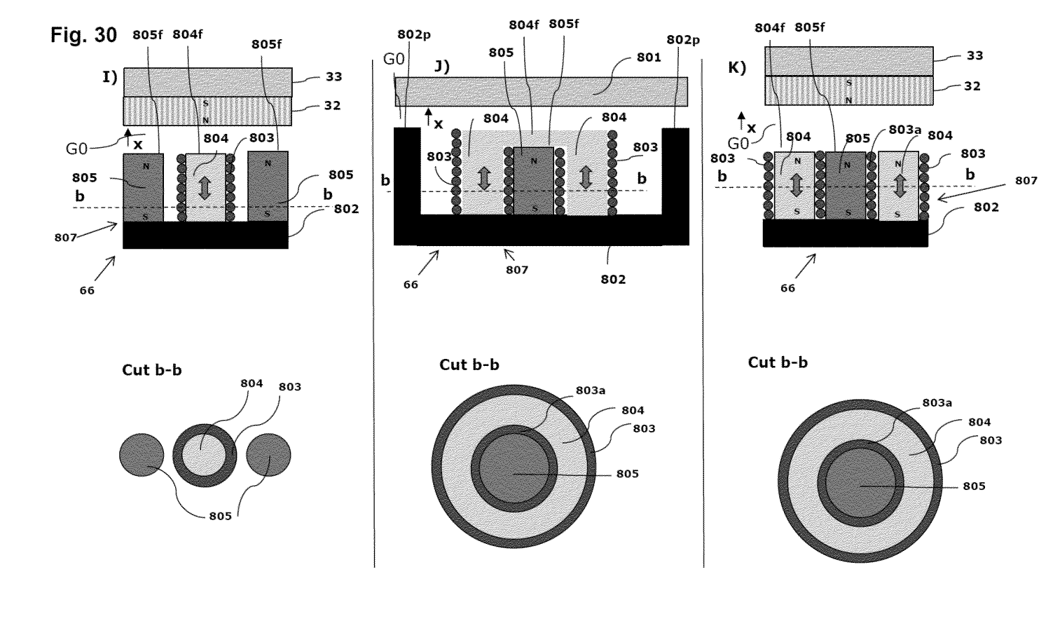

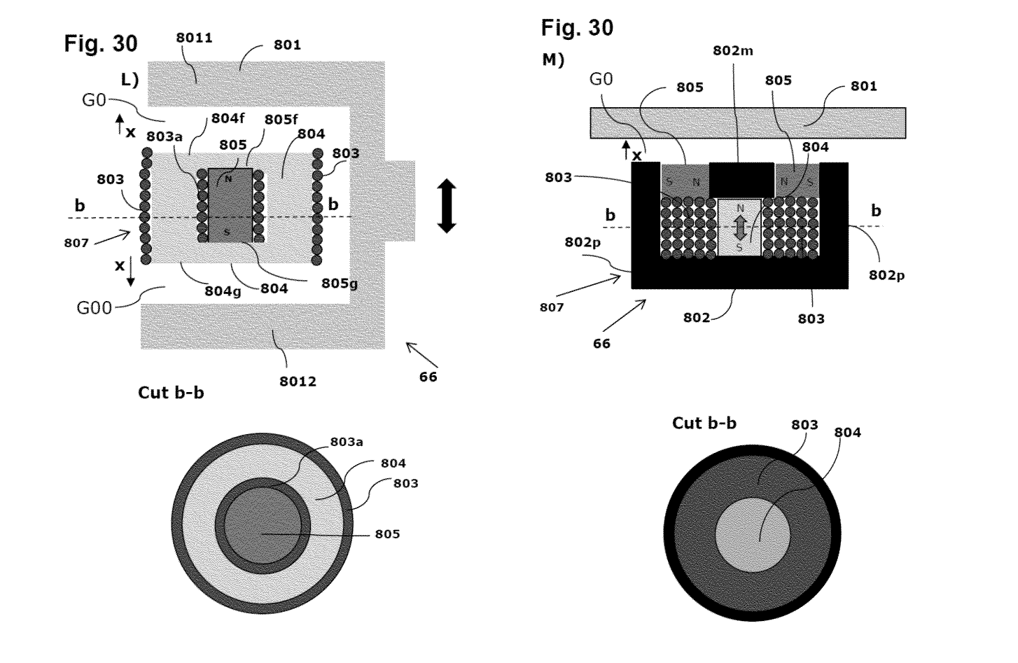

FIG. 30 shows different configurations (A) to M)) of electropermanent magnets that can be used in an optical device according to the invention;

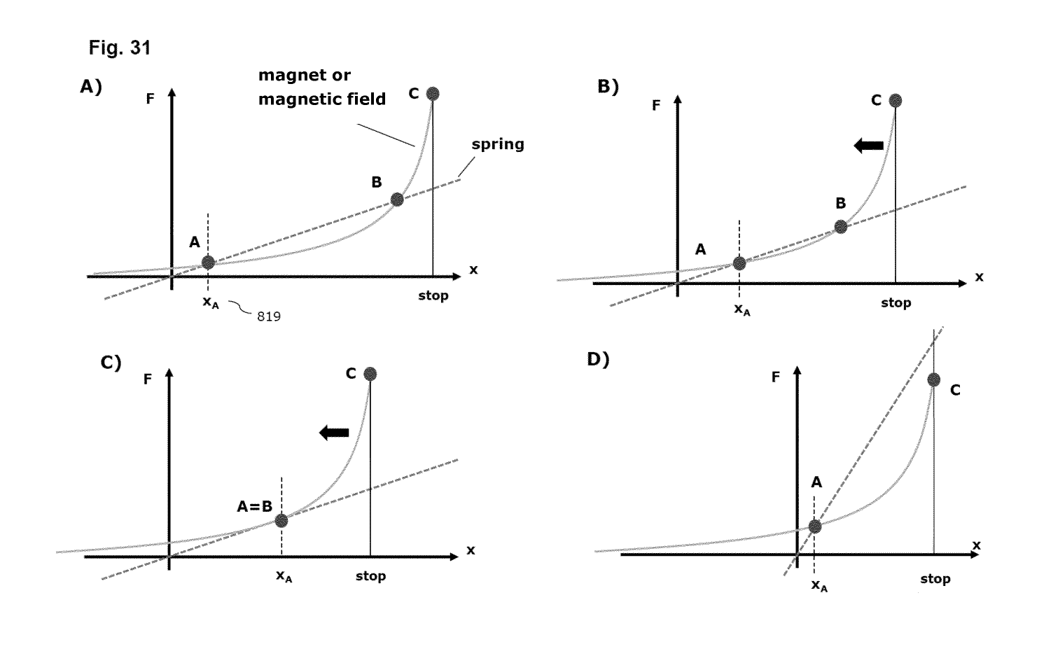

FIG. 31 illustrates stable states/points of a carrier of an optical device according to the invention;

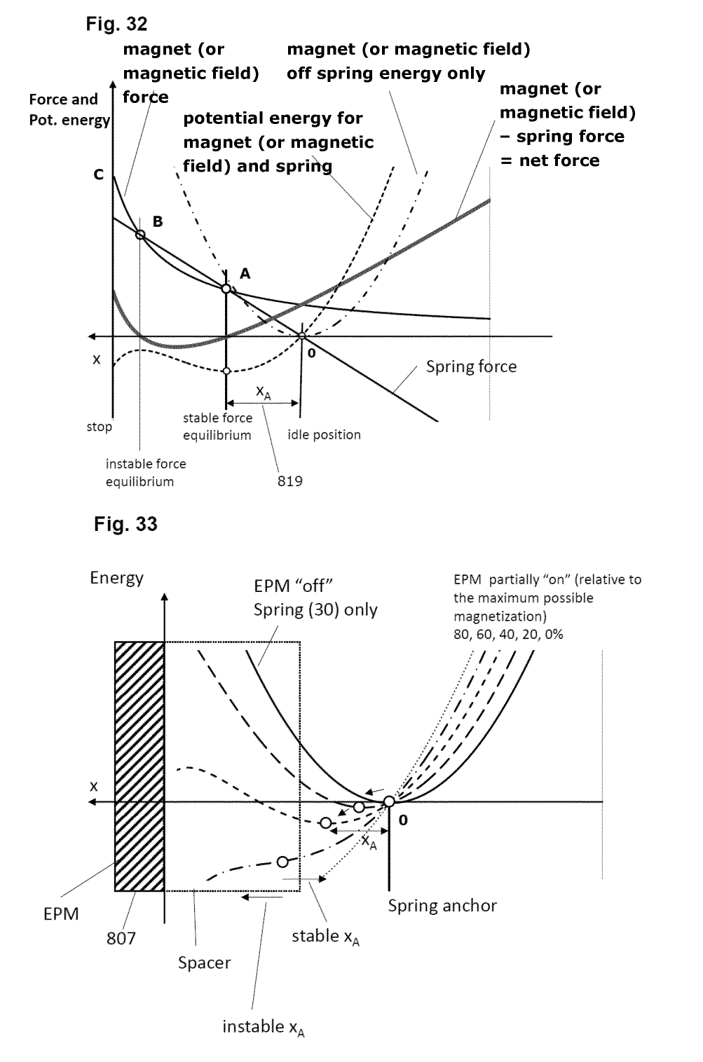

FIG. 32 shows different forces acting on the carrier and potential energy of the spring(s) via which the carrier is coupled to the support frame;

FIG. 33 shows the possibility of tuning the holding point of the carrier;

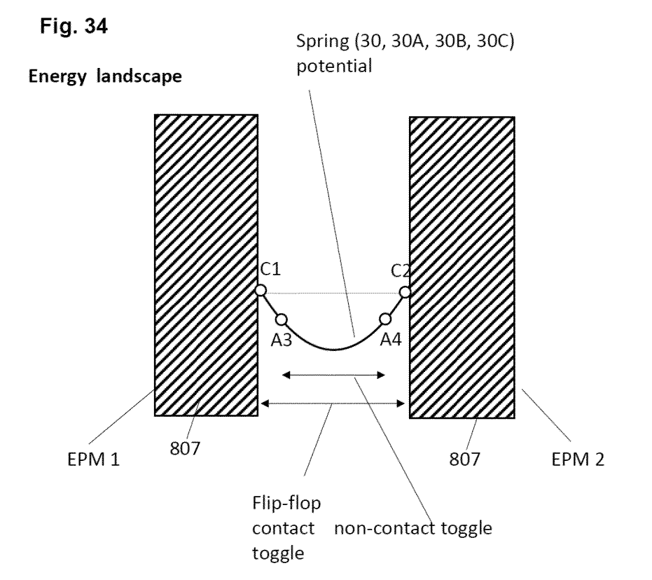

FIG. 34 shows a non-contact toggle versus a contact toogle of the carrier between two electropermanent magnets;

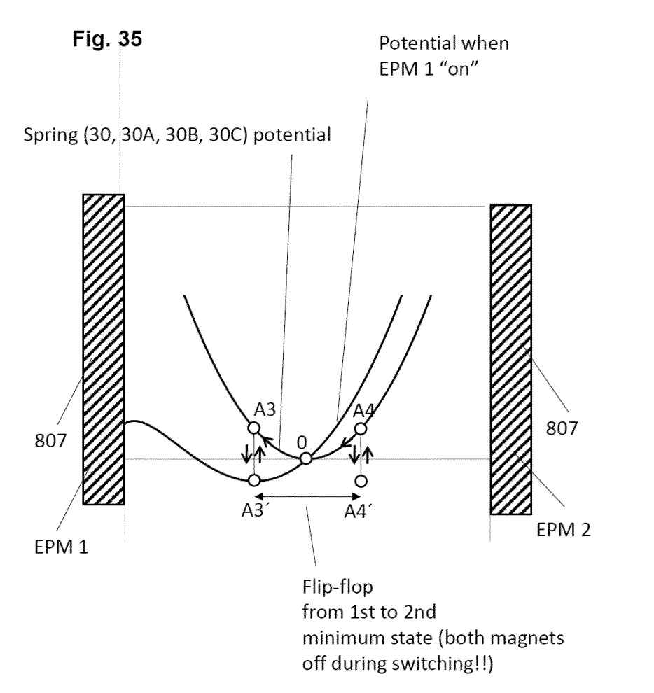

FIG. 35 Illustrates a transition between stable states in the non-contact toggle of the carrier;

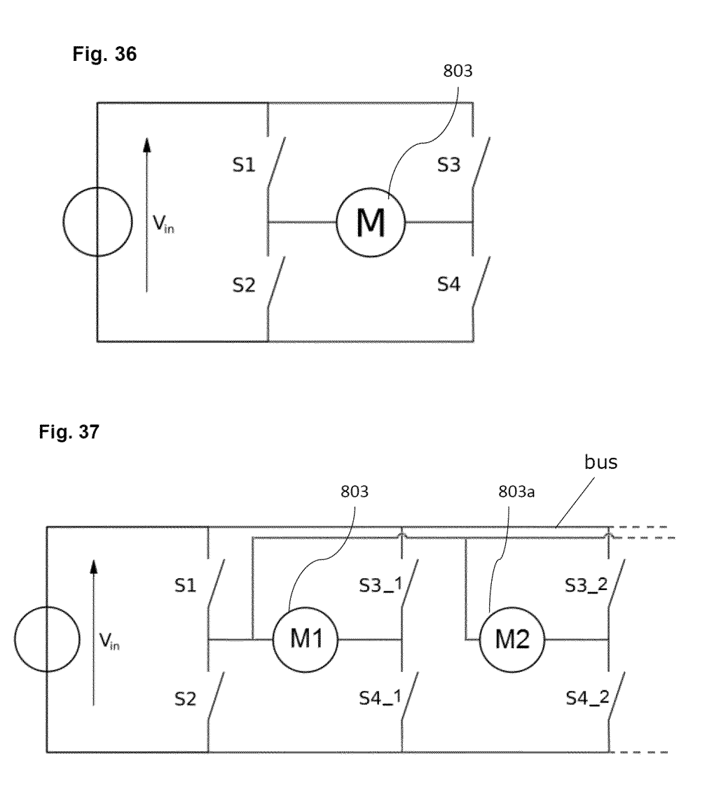

FIG. 36 shows a voltage source for driving a single coil of an electropermanent magnet;

FIG. 37 shows a voltage source or driving two coils of an electropermanent magnet;

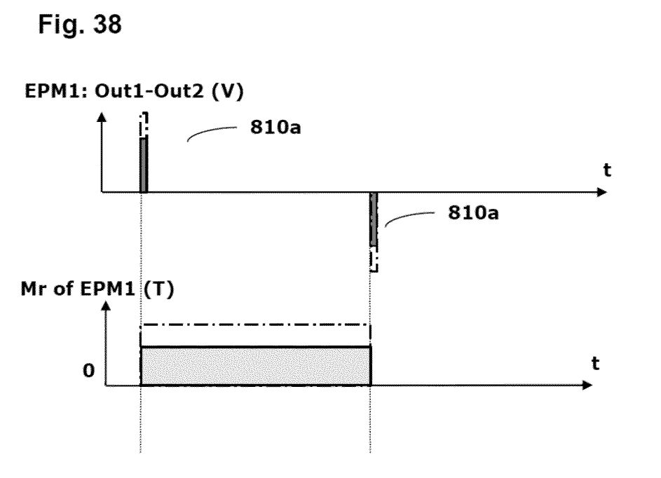

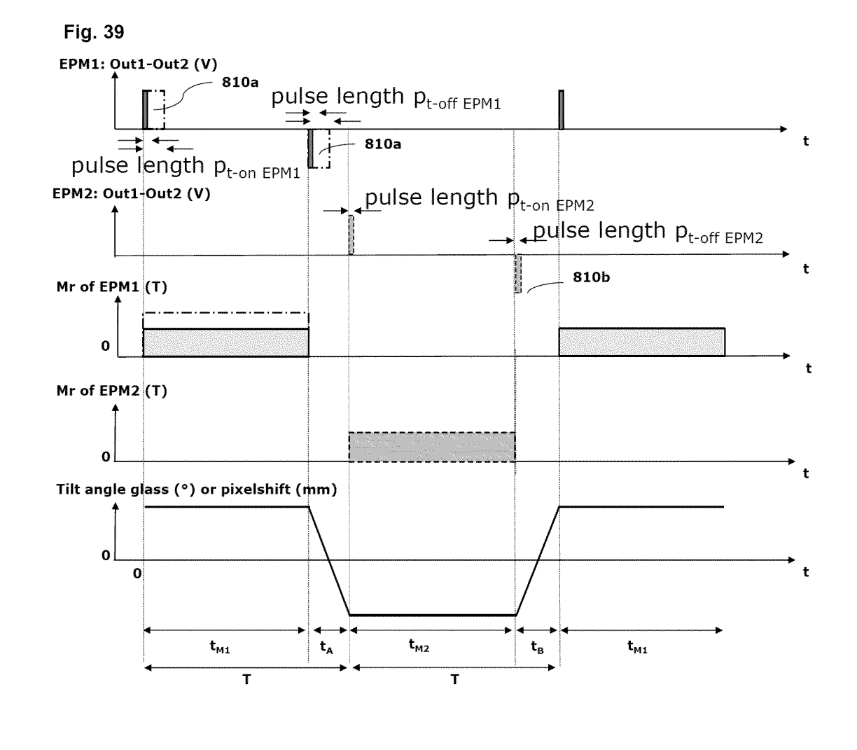

FIG. 38 shows a voltage pulse for generating a remnant magnetization of an electropermanent magnet as well as a voltage pulse for turning off said remnant magnetization FIG. 39 shows a switching sequence, wherein the carrier is tilted from a first stable state to a second stable state and back to the first stable state;

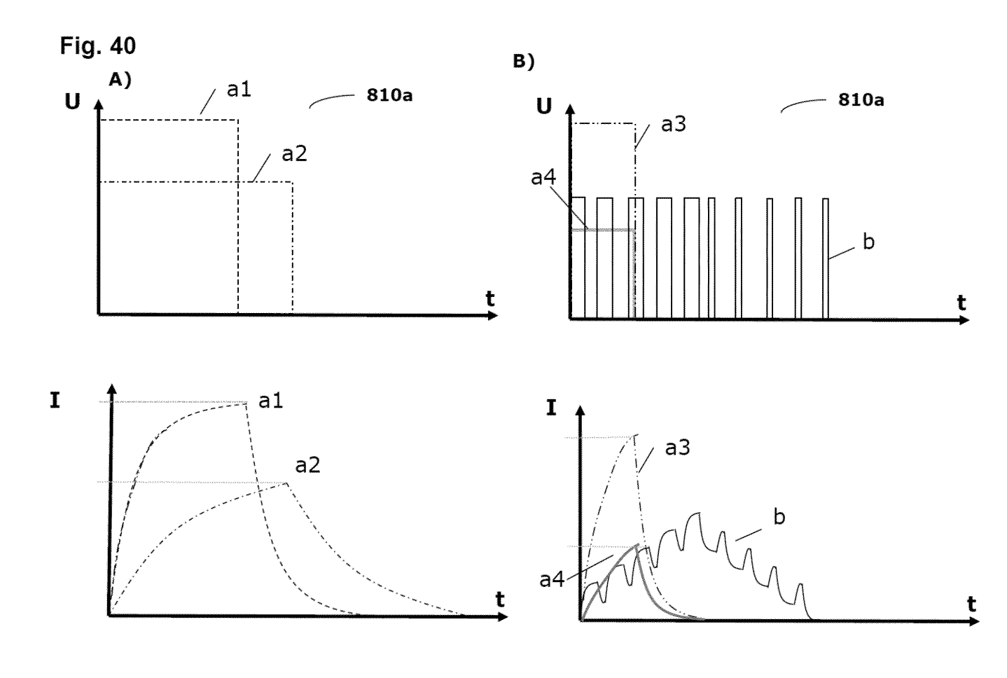

FIG. 40 shows different possibility of current shaping by means of voltage pulses applied to a coil of an electropermanent magnet;

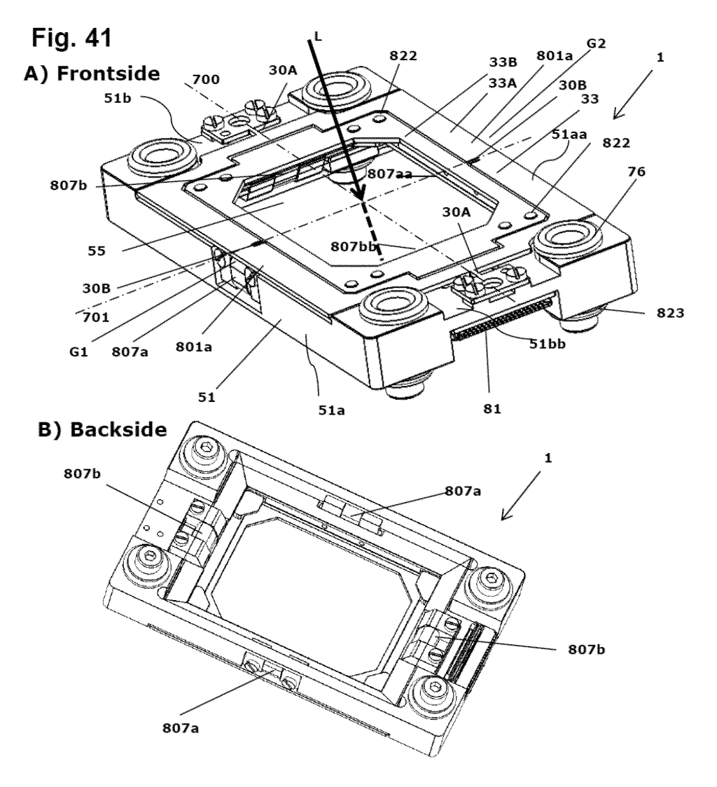

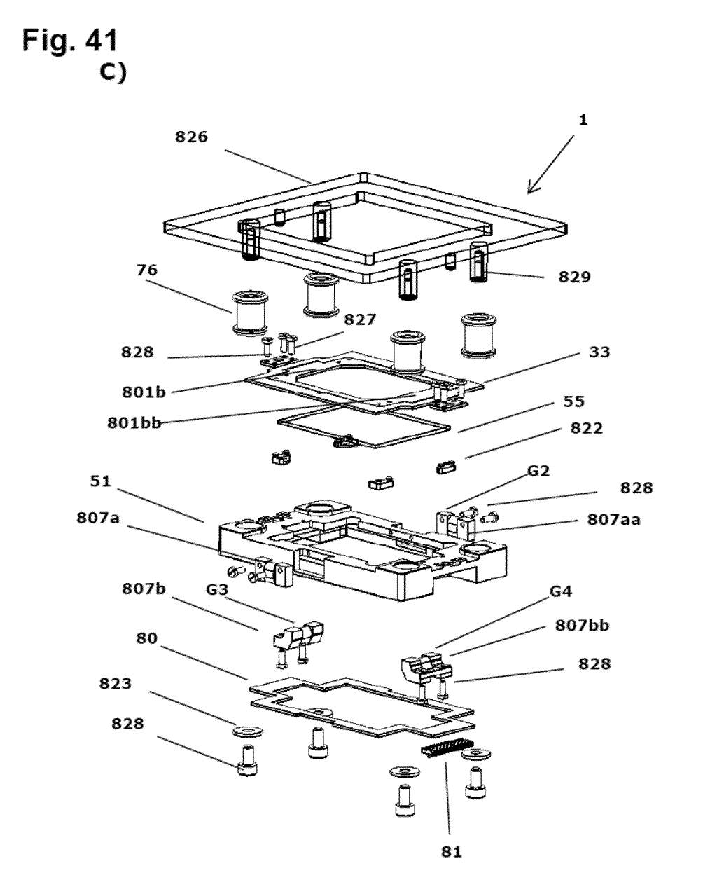

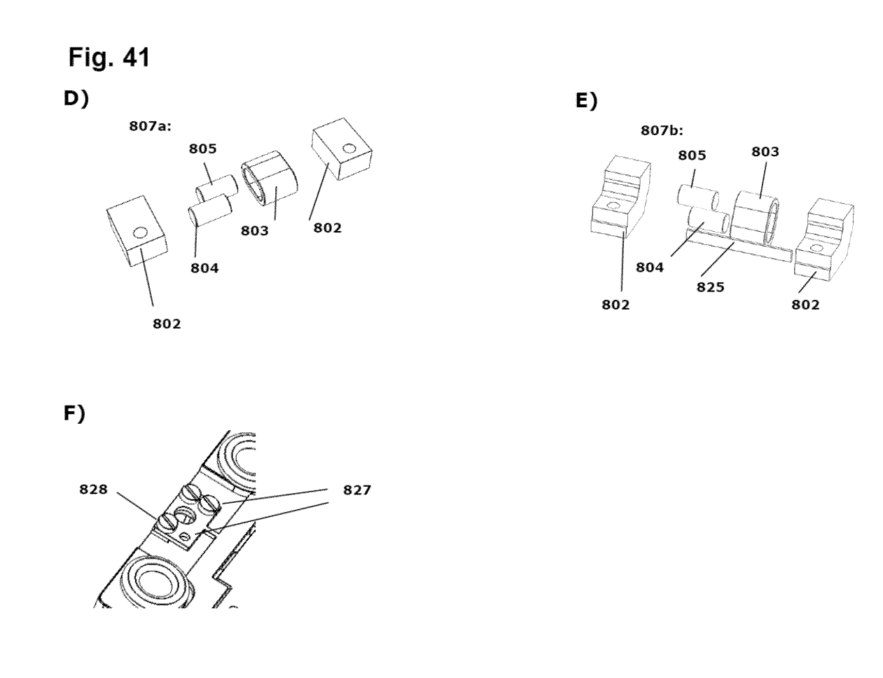

FIG. 41 shows different perspective views and exploded views of an embodiment of an optical device according to the invention comprising a carrier having two parts, wherein each part can be tilted between two stable states by means of two electropermanent magnets;

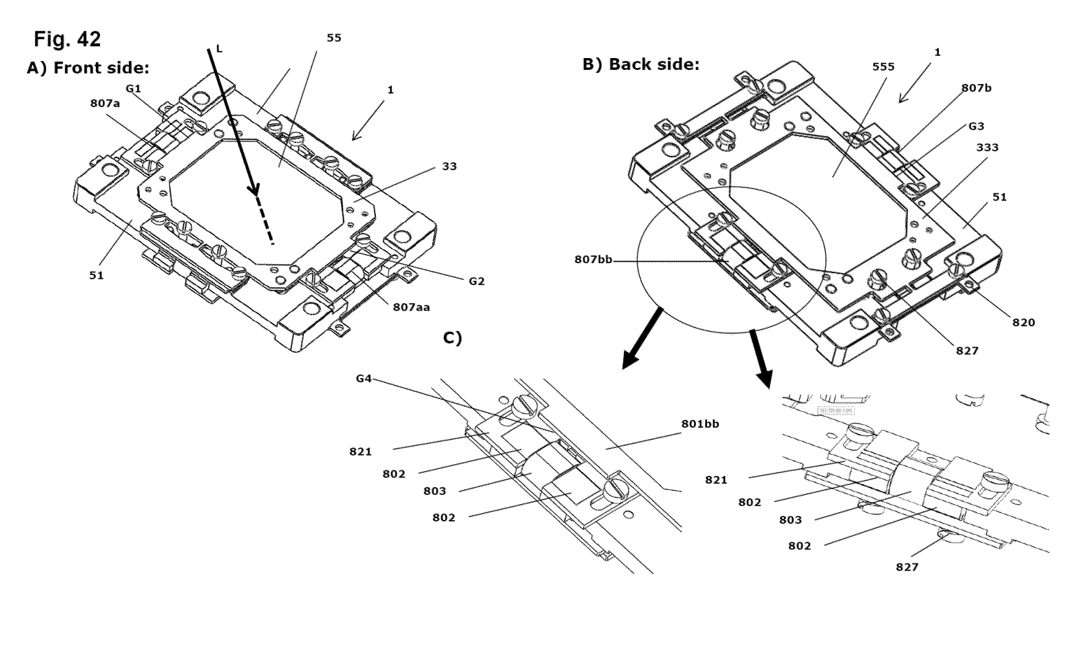

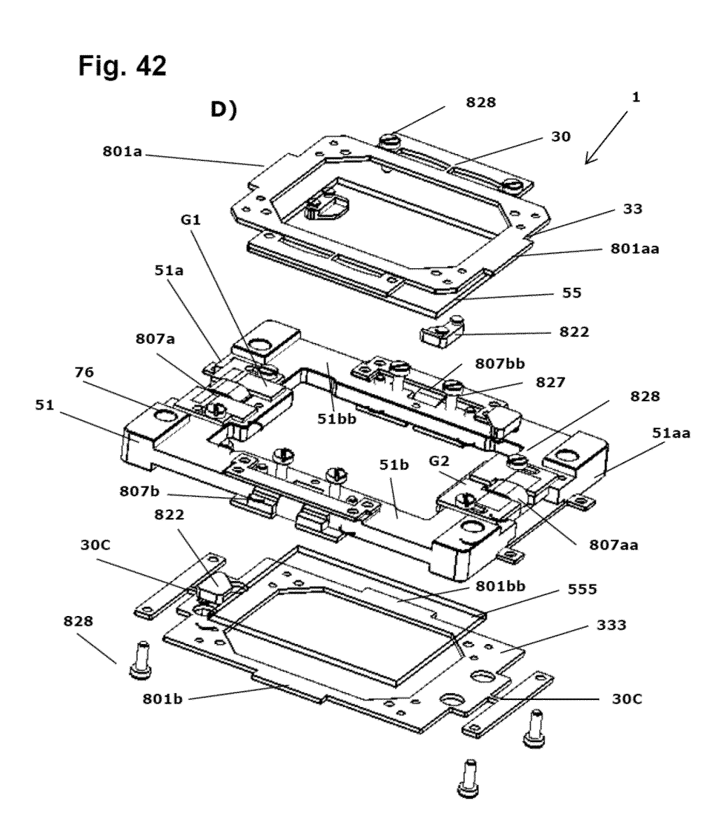

FIG. 42 shows different perspective views and an exploded view of an embodiment of an optical device according to the invention comprising two separate carriers each carrying a transparent plate member, wherein each carrier can be tilted between two stable states by means of two electropermanent magnets;

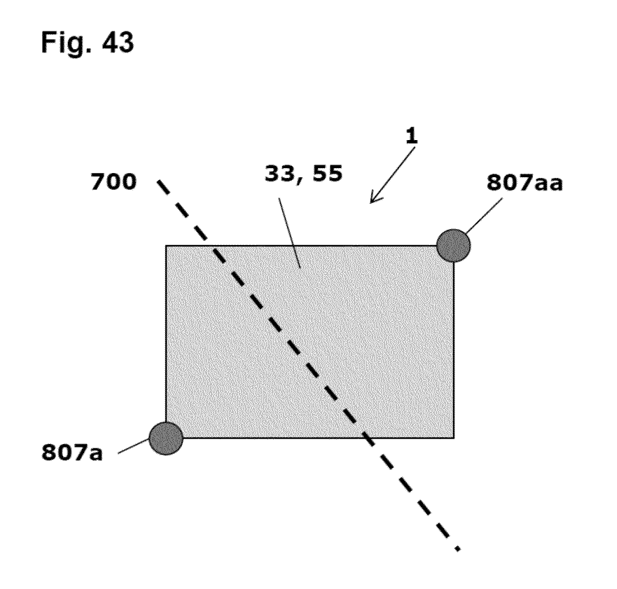

FIG. 43 shows a schematic illustration of an embodiment having a single carrier that can be tilted about a diagonal axis by means of two electropermanent magnets;

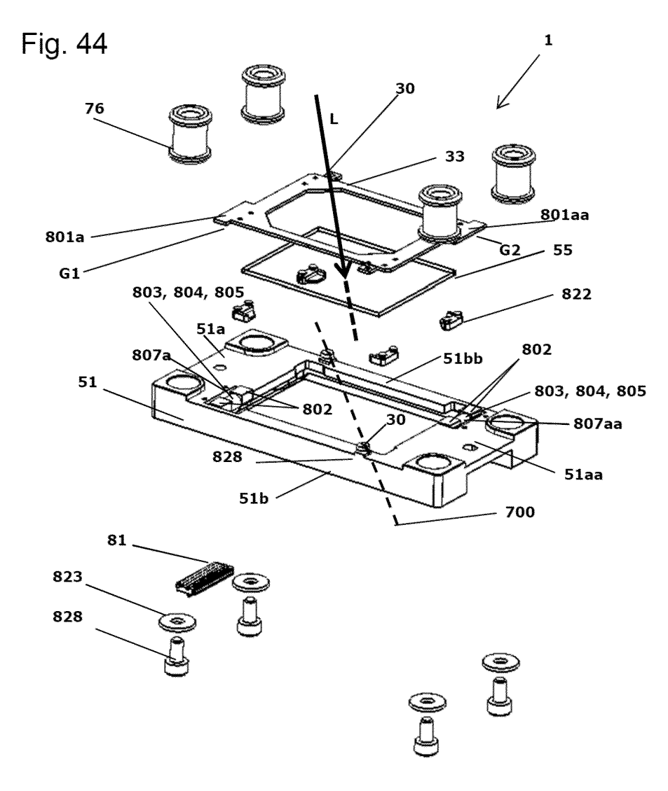

FIG. 44 shows an exploded view of a further embodiment of the optical device according to the invention, which comprises a carrier for the transparent plate member that can be tilted about a diagonal axis between two stable states;

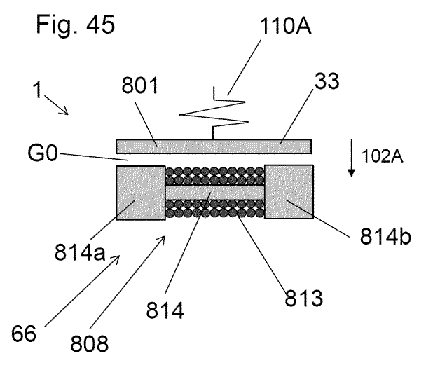

FIG. 45 shows a further actuator of an optical device according to the present invention comprising an electromagnet interacting with a magnetic flux guiding region of the carrier of the device;

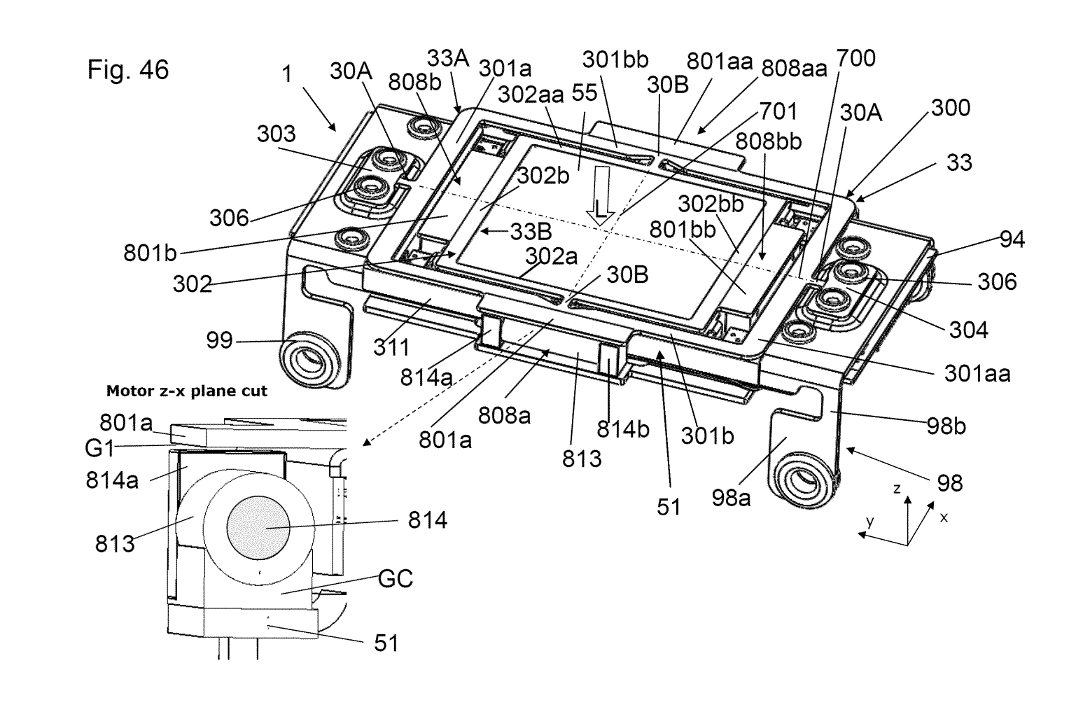

FIG. 46 shows a further embodiment of an optical device according to the present invention using an actuator of the kind shown in FIG. 45;

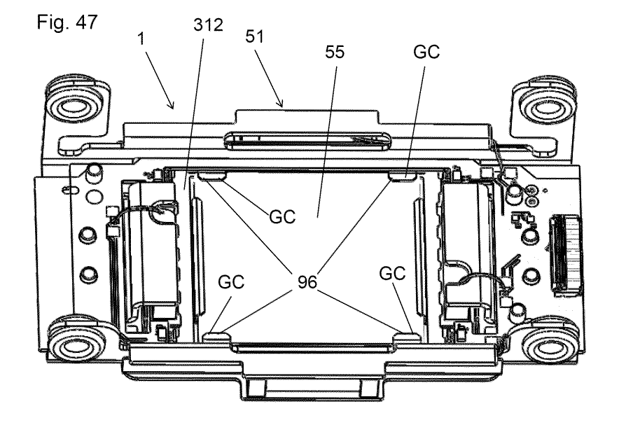

FIG. 47 shows a perspective view of a bottom side of the optical device shown in FIG. 46;

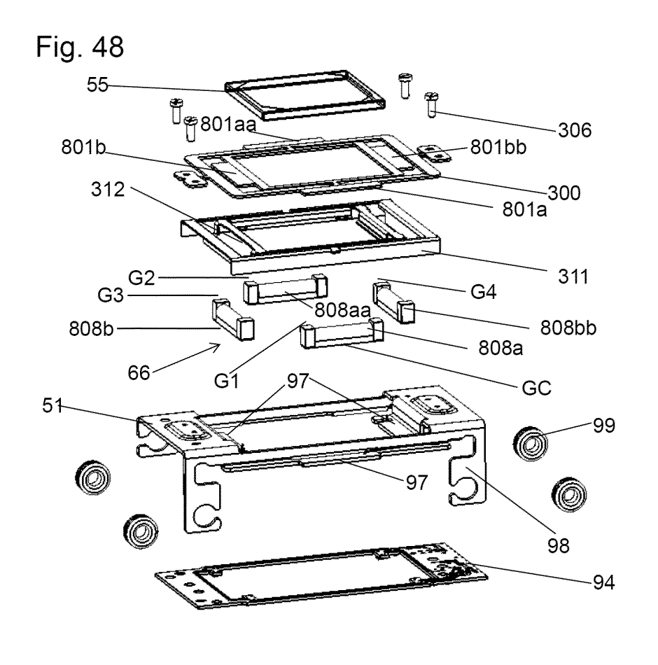

FIG. 48 shows an exploded view of the optical device shown in FIGS. 46 and 47;

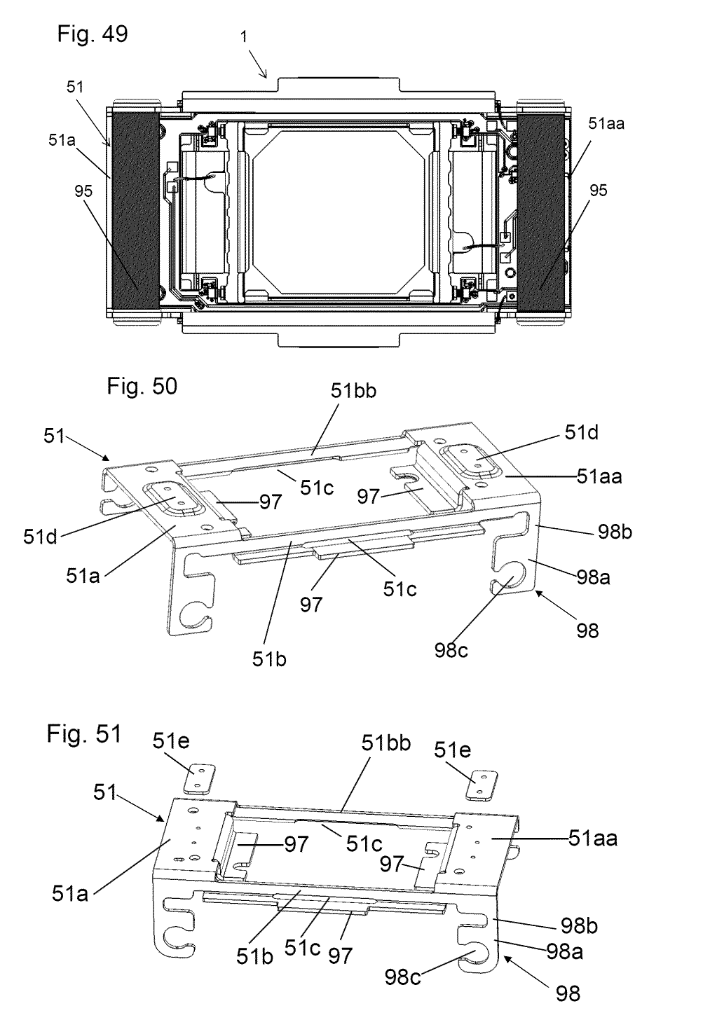

FIG. 49 shows a plan view onto an optical device of the kind shown in FIGS. 46 to 48 having additional mass bodies for increasing the mass and thus the moment of inertia of a support frame of the device to suppress a movement of the said support frame;

FIG. 50 shows a perspective view of an embodiment of a support frame of the optical device shown in FIGS. 46 to 49;

FIG. 51 shows a perspective view of an alternative embodiment of the support frame;

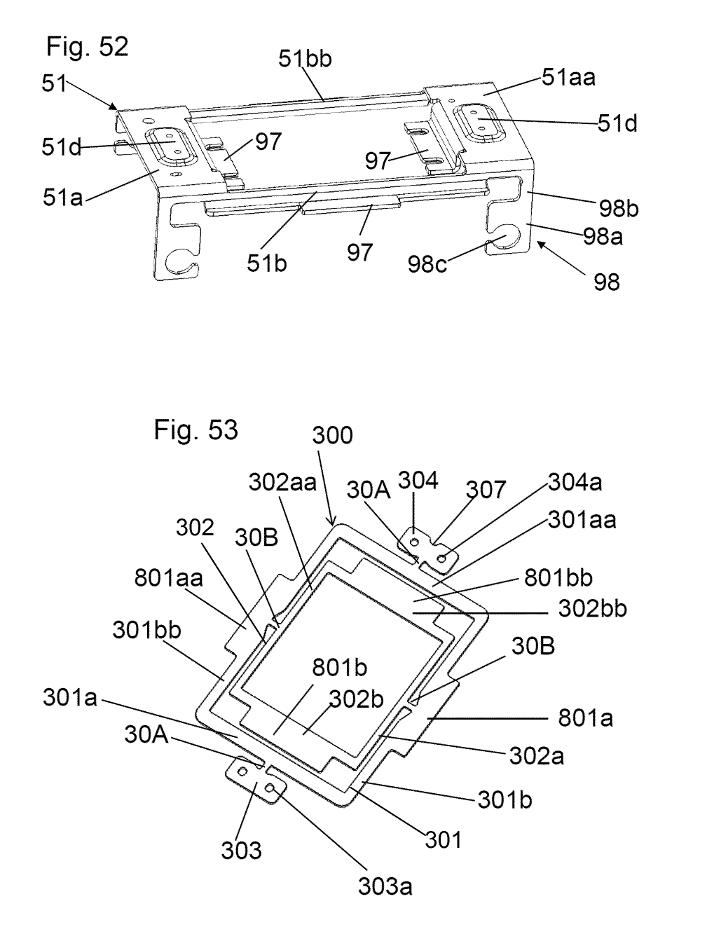

FIG. 52 shows a perspective view of a further alternative embodiment of the support frame;

FIG. 53 shows a plan view of a spring structure of the optical device shown in FIGS. 46 to 49;

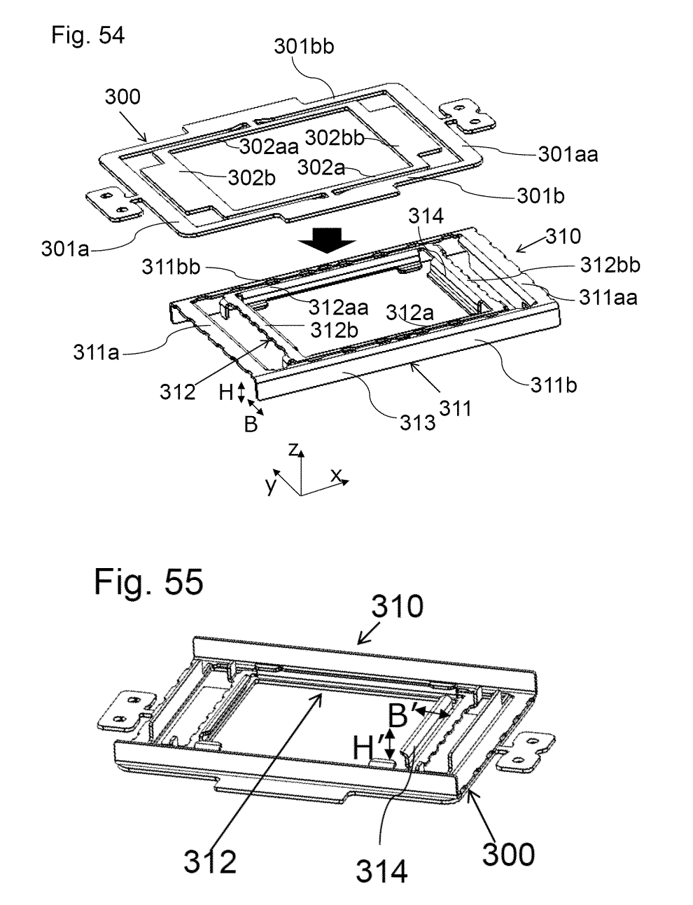

FIG. 54 shows an exploded view of the spring structure and a reinforcing structure of the carrier of the optical device shown in FIGS. 46 to 49;

FIG. 55 shows a perspective view of a bottom side of the assembly comprising the spring structure and the reinforcing structure as shown in FIG. 54;

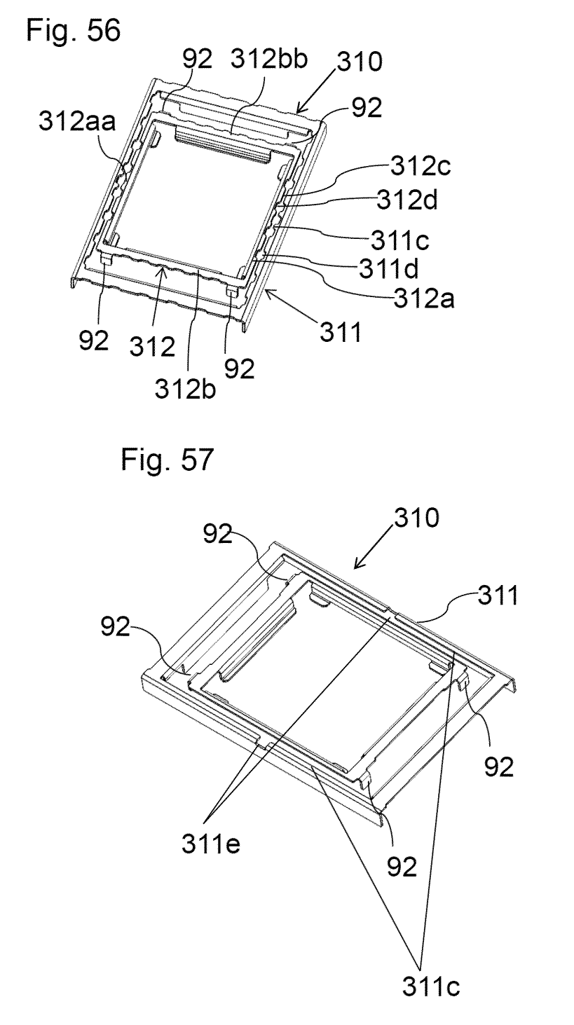

FIG. 56 shows the reinforcing structure comprising an inner reinforcing frame and an outer reinforcing frame;

FIG. 57 shows an alternative embodiment of the reinforcing structure;

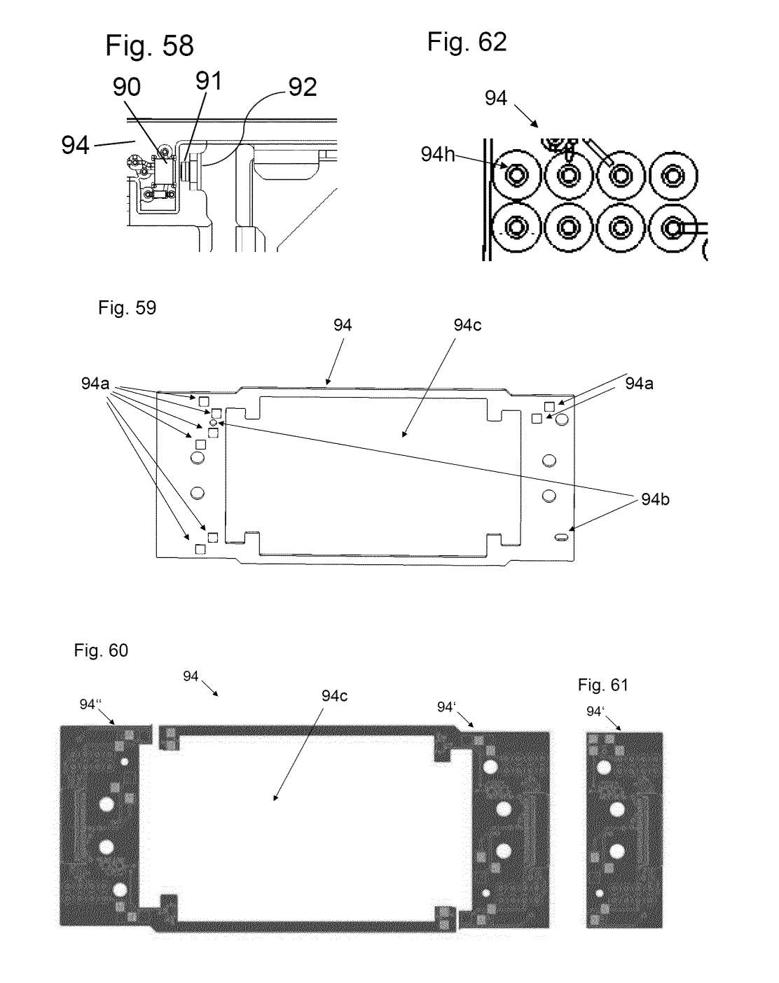

FIG. 58 shows a detail of the optical device shown in FIGS. 46 to 49 namely a Hall sensor connected to a printed circuit board of the optical device which senses a magnetic field generated by a permanent magnet arranged on the inner reinforcing frame for determining a spatial position of the plate member;

FIG. 59 shows a layout of a printed circuit board (PCB) of the optical device shown in FIGS. 46 to 49;

FIG. 60 shows a further variant of the printed circuit board that can be separated into several parts;

FIG. 61 shows an alternative printed circuit board shown in FIG. 60;

FIG. 62 shows a pattern of electrical connectors, in particular vias on a PCB to quickly connect the device with electrical test pins (such as pogo pins); this saves time to test the PCB in forehand and the device during calibration;

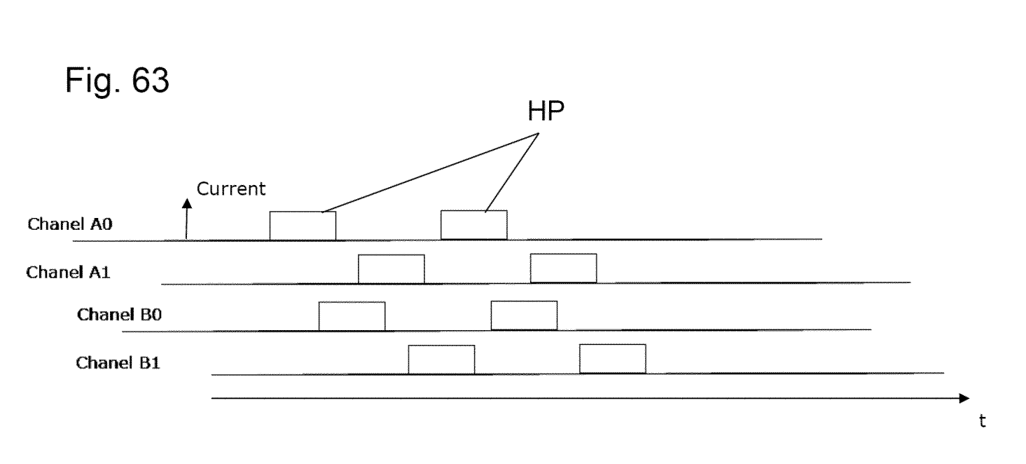

FIG. 63 shows holding current pulses applied to the coils of the electromagnets (actuators) of the optical device shown in FIGS. 46 to 49;

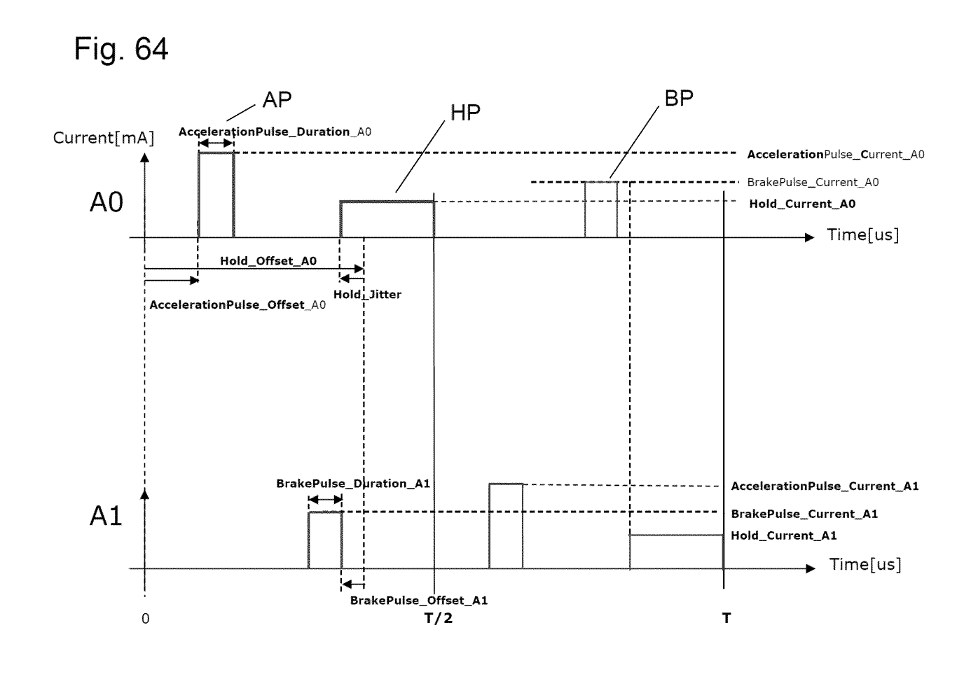

FIG. 64 shows holding, accelerating, and braking current pulses applied to coils of opposing actuators (electromagnets) of the optical device;

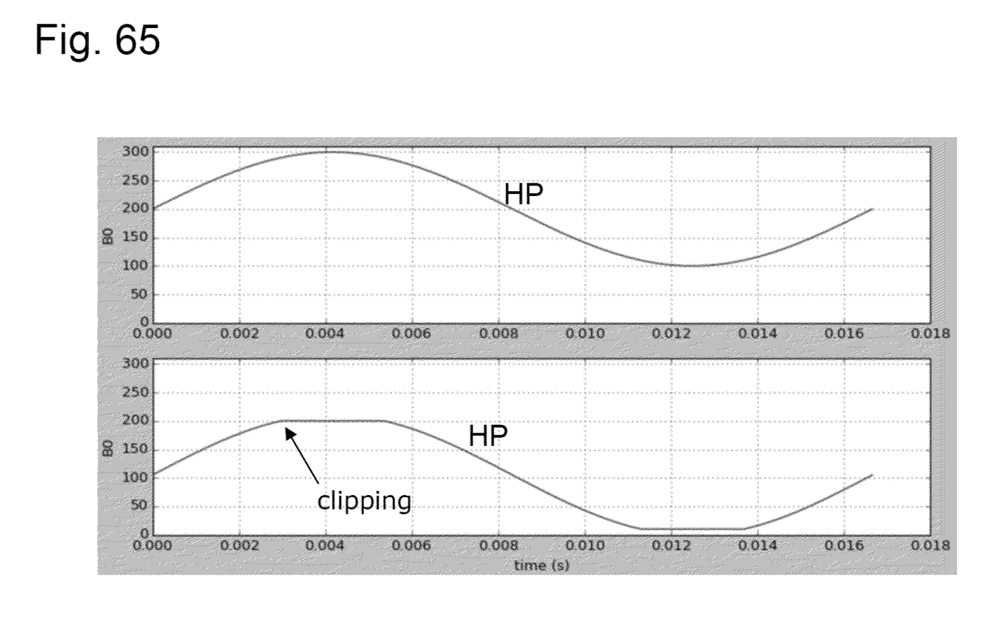

FIG. 65 shows holding pulses having a sinusoidal shape or alternatively a clipped sinusoidal shape;

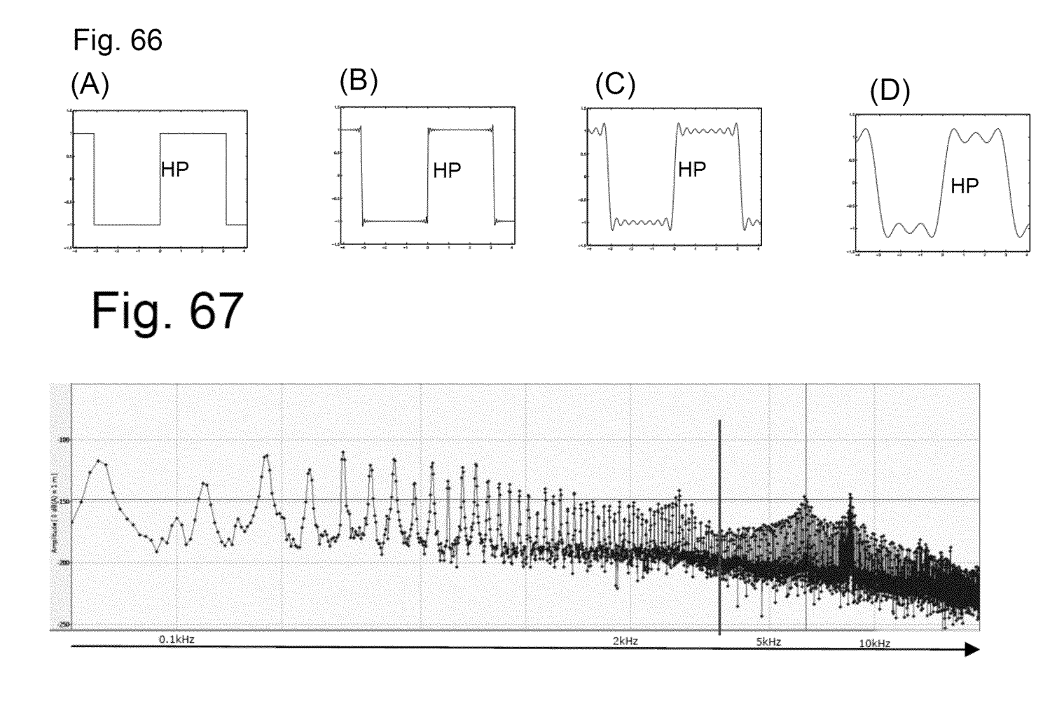

FIG. 66 show different holding pulses with certain higher frequencies removed (e.g. filtered out) for noise reduction;

FIG. 67 shows the individual mechanical frequencies of the tilt member; the line shows the possibility of cutting off the frequencies by implementing a filter onto the current pulses as thereby the larger frequencies will not be exited;

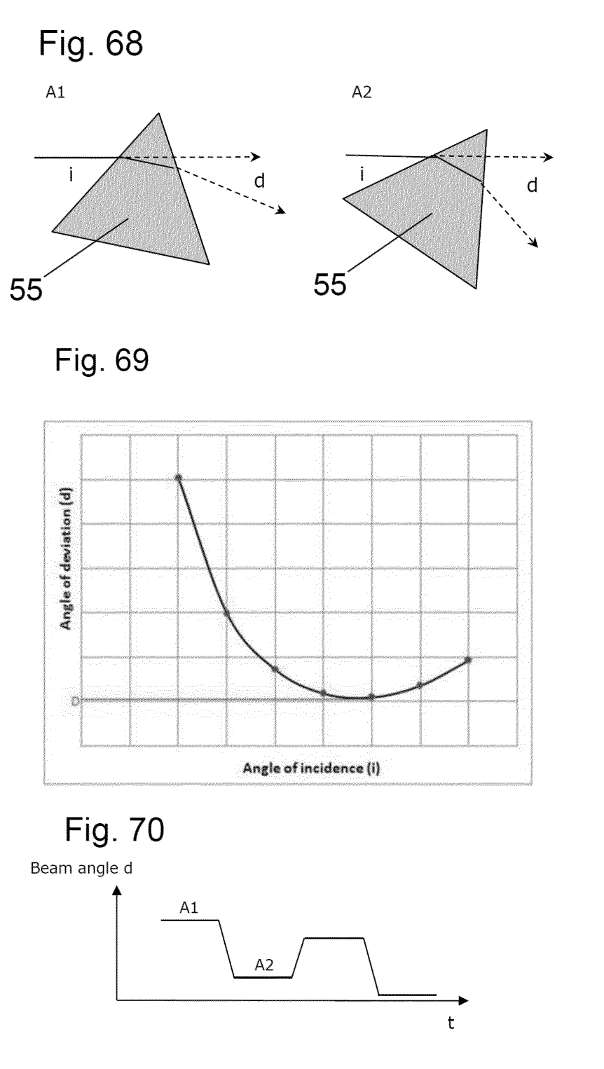

FIG. 68 shows an alternative embodiment of the plate member of the optical device, wherein here the plate member is formed as a prism;

FIG. 69 shows the angles of the light incident on the prism as well as the angles of the outgoing light beams (angle of deviation);

FIG. 70 shows different beam angles over time as shown in FIG. 68; and;

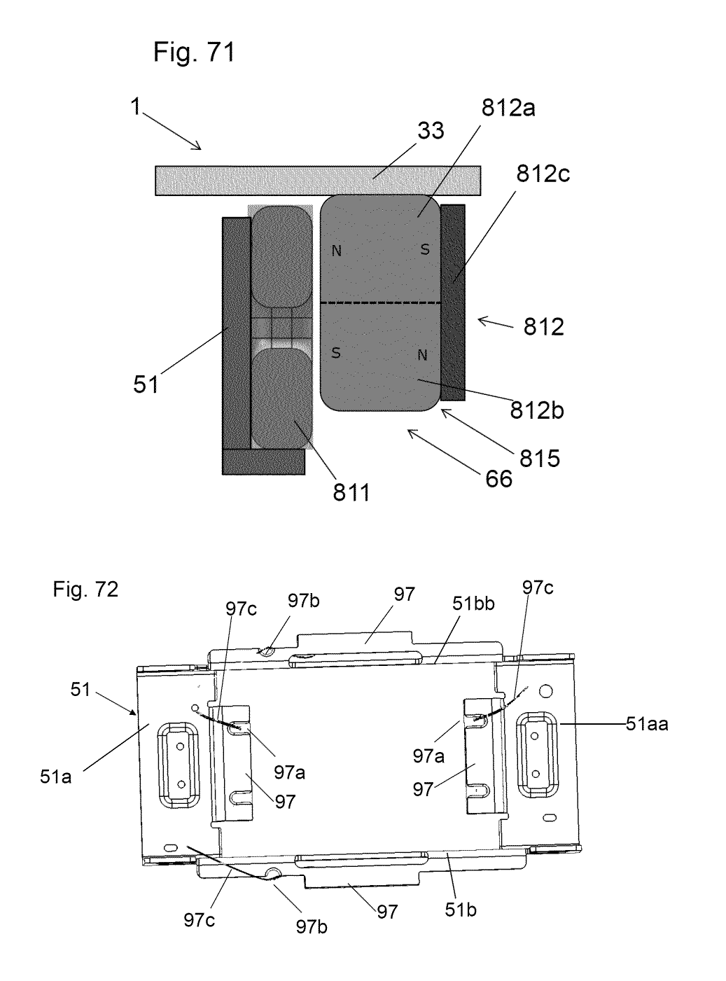

FIG. 71 shows a cross sectional view voice coil motor that can also be used an actuator in the embodiments of the present invention;

FIG. 72 shows a perspective view of the support frame having grooves for receiving electrical cables of the optical device; and

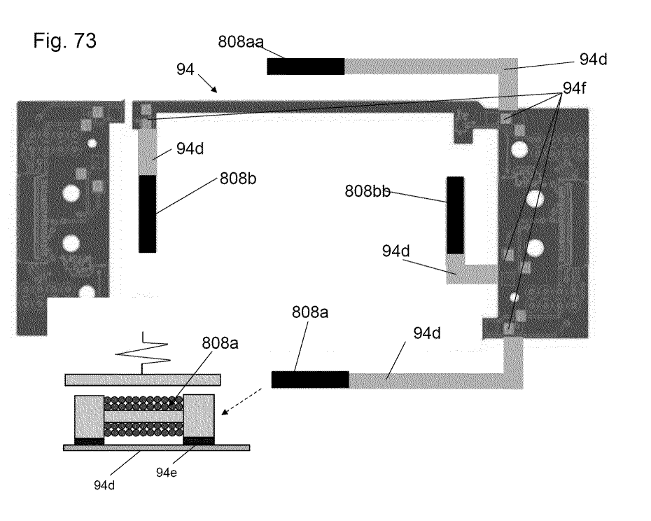

FIG. 73 shows a substrate (e.g. printed circuit board) of the optical device having flexible members for electrically connecting the printed circuit board to actuators, particularly electromagnets of the optical device.

FIG. 71 shows an alternative embodiment of an actuator in the form of a voice coil motor that can also be used with the embodiment shown in FIGS. 46 to 49. The present invention relates to optical devices that allow to shift an image IM projected by a light beam L by a fraction of a pixel (e.g. one-half pixel) ΔP in either 1D (e.g. horizontally) along a first direction x (e.g. corresponding to pixel rows of the image) or 2D (e.g. horizontally and vertically, or even diagonally) along a first direction x and a second direction y (e.g. corresponding to pixel columns of the image), wherein the shift in y-direction is denoted ΔP′.

FIG. 2 shows in conjunction with the schematic representation of FIG. 1 an embodiment of an optical device 1 according to the invention that allows to tilt a transparent member 55 in 2D between a first and a second position, respectively, such that a light beam passing through the plate member 55 is shifted by said fractions of a pixel ΔP, ΔP′ (see also FIG. 1). However the device 1 can also easily be modified to allow for the tilting in only one direction (e.g. by omitting the second part 33B and mounting the plate member 55 directly to the first part 33A so that is can be merely rotated about the first axis 70.

Particularly, as indicated in FIG. 1, the plate member 55 comprises two parallel, flat surfaces 55a, 55b that face away from each other and extend along the extension plane of the plate member 55. Thus, a light beam L passing the plate member 55 gets refracted at each surface 55a, 55b and finally the incident light beam L runs parallel to the transmitted light beam L. Particularly, the first and second position, e.g. the tilting angle or any other suitable coordinate, is selected such that the shifts ΔP, ΔP′ of the light beam L corresponds to a fraction (e.g. one-half) of a pixel of the image IM. Of course, in all embodiments of the present invention one may also use a plate member 55 that is not transparent, but forms a mirror. The device 1 then provides a defined angle of reflection in the respective stable state instead of a shift of the light beam.

In detail, the optical device 1 comprises, besides said transparent plate member 55 configured for refracting a light beam L passing through the plate member 55, wherein the light beam L projects an image IM comprised of rows and columns of pixels P, a carrier 33 to which said transparent plate member 55 is rigidly mounted, wherein the carrier 33 is configured to be moved between a first and a second state, whereby said projected image IM is shifted by said fraction ΔP of a pixel, particularly by a half of a pixel, along the first direction x.

In order to allow for a displacement of the image IM in two dimensions (2D) the carrier may comprise a first part 33A that may be formed as a first frame member 33A and that is connected via two springs 30A to a surrounding support frame 51 of the optical device 1, as well as a second part 33B that may be formed as a second frame member 33B that is connected via two springs 30B to the first frame member 33A. Here, the springs 30A connecting the first part 33A to the support frame 51 are aligned with each other and extend along said first axis 700, while the springs 30B that connect the second frame member 33B to the first frame member 33A are also aligned with each other and extend along the second axis 701, wherein said to axes 700, 701 may extend perpendicular to each other.

Thus, the carrier 33 can be tilted about the first axis 700 between said first and said second state with respect to said support frame 51. Here, the second part 33B to which the plate member 55 is mounted is tilted/moved together with the first part 33A. Furthermore, the second part 33B can be tilted/moved with respect to the first part 33A. This allows to tilt the plate member 55 independently about said two axes 700, 701 in 2D.

Further, the carrier 33, particularly the first part 33A together with the second part 33B, is configured to be bistable or tristable, wherein said first and said second state are stable states of the bistable or tristable carrier 33. Particularly, in the same manner, the second part 33B of the carrier 33 is configured to be bistable or tristable, too, wherein said first and said second state of the second part 33B are stable states of the bistable or tristable second part 33B,

In order to achieve a transition between said stable states 1A, 1B, the optical device 1 comprises an actuator means 66 that is configured to force a transition of the carrier 33, e.g. of the first part 33A and the second part 33B, from its first stable state 1A to its second stable state 1B and vice versa. Further, said actuator means 66 is configured to force a transition of the second part (second frame member) 33B of the carrier 33 from its first stable state to its second stable state and vice versa.

Alternatively, in case of a universal joint as described in conjunction e.g. with FIG. 13A, the carrier 33 may be tilted between four stable states.

Particularly, the actuator means 66 comprises a plurality of electrically conducting coils 31A and a corresponding plurality of magnets 32B, wherein the coils 31A are arranged on the support frame 51, and wherein the magnets 32B are arranged on the carrier 33. Particularly, four magnets 32B are arranged on the first part 33A, and four further magnets 32B are arranged on the second part 33B. Furthermore, each magnet 32B is associated to exactly one of the coils 31A and faces its associated coil 31A in a direction that runs parallel to the magnetization of the respective magnet 32B. Preferably, the respective magnet 32B is centered above its associated coil 31A in order to effectively generate a Lorentz force for initiating transitions between stable states 1A, 1B of the carrier 33 (with respect to the respective axis 700, 701), which here correspond to tilting movements of the carrier 33 (and plate member 55) about the respective axis 700, 701. The direction of the Lorentz force depends on the direction of the current in the respective coil 31A and points vertically up or down in the cross section of FIG. 2C.

Generally, in all embodiments described herein, the actuator means 66, 660 (e.g. coils 31A) maybe controlled by means of an electronic control unit which is not shown and which may control e.g. a defined tilting movement of the carrier 33/plate member 55 in order to achieve a resolution enhancement/shift of the light beam L (or change in angle of reflection) of the optical device 1 as described herein.

According to FIGS. 2A to 2D the actuator means 66 further comprises a clamping means 32A, which here comprises four magnets 32A, that are configured to clamp the first part 33A of the carrier 33 and the second part 33B in the respective stable states 1A, 1B by exerting a clamping force on the respective part 33A, 33B of the carrier 33 that over-compensates a spring force of the carrier 33 that is here provided by the carrier 33 itself, particularly by said elastic elements 700A, 700B.

In order to initiate or trigger a transition between the stable states 1A, 1B (i.e. in order to trigger a tilting movement of the carrier 33 the actuator means 66 further comprises a disengaging means that is here formed by said coils 31A and magnets 32B which are configured to cancel said clamping of the carrier 30/second part 30B in the respective first and/or second stable state 1A, 1B by applying a suitable electrical current in the corresponding coil 31A.

Furthermore, in order to damp the movement of the carrier 33, the optical device 1 further comprises a damping means 36 that dissipates kinetic energy of the carrier upon movement of the carrier into one of the stable states 1A, 1B so that the movement of the carrier 33 comes to rest in a defined manner.

Further, as indicated in FIG. 2D, the optical device may comprise a sheet that forms a non-linear spring 34, which sheet can additionally contain a damping means 36A (e.g. dissipates energy) and an end stop 35 (see also FIG. 9), wherein the coils 31A are arranged on the support frame 51.

In the above, the carrier 33 is tilted and a suitable coordinate to describe this movement may be a tilting angle. However, herein a coordinate of a movement between any two stable states 1A, 1B can in general be a spatial position, an angular position, or any other one, two, or three-dimensional parameterization of space.

Further, said local minimum (or local trap) states (also denoted as stable states herein) 1A and 1B are particularly thought to be interexchangeable in any context (particularly this also holds for 3A and 3B, see below).

In the following, most of the times, only a tilting about one axis 70 is considered in order to describe the invention, particularly the transition between the stable states 1A and 1B of the carrier 30 which here may correspond to the maximal tilting angles about the axis 70. However, the invention can be easily applied to 2D tilting as outlined above.

Further, temporal transitions between said stable states 1A and 1B (and vice versa) are herein also called a switching event, or simply a switch.

From an energetically point of view, as shown in FIG. 3, the invention describes a so-called bistable system (here a bistable carrier 33), meaning a system/optical device 1 with at least two energetically equally or at least energetically similarly favorable (stable) states of the carrier 33 having local minimum energy 1A and 1B.

Preferably, transitions between these states 1A and 1B cost minimal or no energy, since the stable states 1A and 1B have either the same or a similar potential energy, wherein spontaneous transitions between said stable states 1A, 1B are prevented by a potential energy maximum 3 separating the stable states 1A, 1B.

Further, forced transitions of the optical device 1 between the states 1A and 1B may be achieved by either temporarily lowering the energy barrier 2A to negative values, or by lowering the energy barrier 2A to a lesser energy and adding at least this amount of energy, or by adding that energy 2A right from the start.

Particularly, the stable states 1A and 1B may be connected with a path 7 of minimal or zero energy losses.

Furthermore, the stable states 1A and 1B are sharply defined by two steep potentials 8 and 9 as also indicated in FIG. 3.

Furthermore, the carrier 30 may also form a bistable system having at least one additional energetically favorable state 4 (see FIG. 4), i.e. a tristable system, where the first and second stable state 1A and 1B are connected through an intermediate local minimum state 4 that may form an (e.g. quadratic) potential well 7.

Particularly, in an embodiment the minimum 4 is not only a local but also a global minimum state, which could be, but not necessarily must be, the optical device's 1 idle-state (e.g. after power-off and/or shock impact and/or any other malfunction of the device).

Static switching of a bi-stable (see FIG. 5A) or tri-stable system (see FIG. 5B) is triggered by application of a static (e.g. electromagnetic) potential 15 (e.g. using the corresponding coil 31A and associated magnet 32B, see also FIGS. 2A-2D and FIGS. 7 and 8). By raising the potential (from 15A, to 15B, to 15C), the local minimum/stable state 1A is transformed into a unstable state 1A′, triggering a switching to the minimum/stable state 1B. After passing the local maximum 3A, the static potential 15 can be disengaged.

Further, dynamic switching of a bi-stable (see FIG. 6A) or tri-stable system (see FIG. 6B) is triggered by a surplus energy 2C, particularly by application of a short acceleration pulse (e.g. mediated by corresponding coils 31A and magnets 32B, see also FIGS. 2A-2D, and FIGS. 7 and 8). The energy 2C absorbed during the pulse initially appears in form of kinetic energy, then the energy 2A of energy 2C is transformed into potential energy to overpass the local maximum 3A (tri-stable) or 3 (bistable). The residual kinetic energy 2B is optionally used to maintain a minimum speed during overpassing of the local maximum 3A, 3.

Further, as shown in FIG. 6A dynamical switching of a bistable or tristable system may in detail involve a minimum rise 10 in potential energy by an amount 2A, a subsequent fall 11 in potential energy by said amount 2A, a dissipation 12 of a minimum energy 2B (preventing accidental out bouncing), a dissipation 13 of an energy amount 2A (for absorbing local oscillations around the stable state 1A), and a full stop 14.

Further, particularly, when dynamically switching a tristable system as shown in FIG. 6B, a fast transition from the stable state 1A to the stable state 1B may be driven by a phase 15A, 15B, where energy, e.g. elastic energy stored in a mechanical spring, is used to first accelerate and then decelerate the transition.

Optionally, an additional deceleration pulse is applied in phase 11 (at least half of the transition time delayed to the acceleration pulse) to remove residual kinetic energy 2B partially, or fully, prior to reaching stable state 1B, namely ideally shortly before reaching stable state 1B.

Further, when the carrier 33 forms a tristable system as shown in FIG. 5B the activation energy 2A is at least 2, 10, 100, or even 1000 times smaller than the depth 6 of the potential well 7. In other words, the transition time between state 1A and 1B is mainly determined by the potential energy 6 in the potential well 7, defining the so-called (e.g. harmonic) oscillator period T0 and oscillator frequency f0=1/T0.

Here, preferably, cycle transitions between the stable states 1A and 1B are initiated at a frequency f1 being at least 2, 10, 100, or even 1000 times lower than f0. In other words, the switching between states 1A, 1B is conducted at a frequency being much lower than the resonance frequency f0 of the oscillator.

When starting a tristable carrier 33 (see e.g. FIG. 6C), a single actuation pulse 16 with minimum energy 6 may be used to bring the carrier 33 from the steady state 4 to the stable state 1A (or 1B). Afterwards, transitions between the states 1A and 1B can be performed as described above.

Further, the carrier 33 may also be started (see e.g. FIG. 6D) using multiple such actuation pulses 17A-17D by means of which the minimum energy 6 is acquired which brings the carrier 33 from steady state 4 through resonant amplification of the system to the stable state 1A (or 1B).

Here, an e.g. harmonic excitation, a pulse train, or any other periodic excitation at the fundamental frequency, or close to the fundamental frequency f0, may be used to start the system from the steady state 4 by feeding incremental amounts of energy into the oscillator until the potential energy is high enough to pass the state 3A (or 3B) and to settle into one of the local minimum states 1A (or 1B). For example, a train of at least two (e.g. square) pulses or multiple of said pulses, spaced by regular intervals of approximately time T0 may be used to drive the system from state 4 to stable state 1A or 1B.

As already indicated, an optical device according to the invention preferably comprises a clamping means 32a, which can be formed by one or several magnets, particularly a permanent magnet, as shown in FIGS. 7A-7E (for simplicity FIGS. 7A-7E only show the clamping in one of the stable states 1A, 1B).

Here, the force 100A provided by the carrier 33 (indicated as a spring) is slightly over-compensated by said at least one permanent magnet 32A that attracts a soft magnet or magnetizable material part of the carrier 33 by reluctance forces 102A (off state in FIG. 8). In FIGS. 2A-2D two magnets 32A are provided on the support frame 51 to clamp opposing material parts of the first part 33A of the carrier 33, and two magnets 32A are further provided on the support frame 51 to clamp opposing material parts of the second part 33B of the carrier 33 to hold the carrier 33 in the respective stable state 1A, 1B.

In order to trigger a transition from one stable state 1A to the other stable state 1B or vice versa, the actuator means 66 comprises a disengaging means (i.e. provides a disengaging mechanism).

For this, as indicated in FIGS. 7A-7E it may comprise at least one additional (e.g. active) element such as a coil 31A (see also above) to tip the force balance (see FIG. 8) from an off state (Force 102A>Force 100A) to an on-state (or from one stable state to the other stable state 1A, 1B).

For instance, in FIG. 7A, the disengaging means is provided by at least one coil 31A (e.g. arranged on the support frame 51) and at least one corresponding magnet 32B arranged on the carrier 33 to generate a repulsive Lorentz force 101 (voice-coil solution, VCM).

According to FIG. 8A, this force 101 tips the force balance to yield

force102A<force100A+force101

so that the carrier 33 will leave its current stable state.

Further, as shown in FIG. 7B, a coil 31A could be used in combination with a magnetic return structure on the carrier 33 as disengaging means which generates an additional reluctance force 102B (counter to force 102A) that tips the force balance to yield

Force102A<force100A+force102B

so that the carrier 33 will leave its current stable state.

Furthermore, as shown in FIG. 7C, a coil 31A can be used to superimpose the magnetic field of the permanent magnet 32A, yielding little or no net reluctance force, at least

force102A+force102B<force100A

which allows the carrier 33 to leave its current stable state.

Here, the magnet 32B can also be mounted on the carrier 33 and said structure of the carrier 33 can be a magnetizable material.

Furthermore, as shown in FIG. 7D, a coil 31A could be used in combination with a electrically conducting structure of the carrier 33 as disengaging means to generate a repulsive Lorenz forced by using Eddy Currents induced in said structure of the carrier 33.

Furthermore, as shown in FIG. 7E, a high force, short stroke actuator 31C such as a piezoelectric or magnetostrictive actuator, a phase change material (e.g. Nitinol), an electro-active polymer, a bimetal could be used to apply the necessary force.

Preferably, the transition between the stable states 1A and 1B of the optical device is controlled by a highly elastic mechanical spring 30 which is e.g. formed by the carrier 33 or at least regions thereof. These regions can be formed or may comprise for instance said springs or elastic elements 30A, 30B described above in conjunction with FIGS. 2A-2D (or 30A-30F in FIGS. 14A-E). In general, such a spring 30 or such elastic elements can be a sheet spring, a torsion spring, a torsion beam, bending beam, a membrane). This spring/carrier 30 is therefore particularly configured to periodically provide, store, and absorb the energy required to accelerate and decelerate a moving mass (inertial forces), particularly the carrier 33 (or components thereof, e.g. first and/or second part 30A, 30B) and the plate member 55.

The spring/carrier 33 or said elastic elements is/are preferably made out of a spring alloy with high tensile strength (e.g. spring steel, Cu-alloys, Cu—Be alloys, Cu—Zn alloys), a high durability and a little energy dissipation under cycling conditions (highly elastic material).

Further, as indicated in FIG. 8B, two additional (e.g. elastic or viscoelastic) non-linear springs 34 can be used to shape the local potential traps 1A and 1B (e.g. linearize the reluctance forces from the permanent magnets).

Particularly, the purpose of the spring(s) 34 is to widen the spatial and temporal window in which the system can be decelerated and energy can be removed. As indicated in FIG. 8A said spring 34 adds to the potential 6 of the potential well.

FIG. 9 shows the components of the optical device 1 related to clamping, disengaging, rest position (e.g. stop) and damping in form of a schematic diagram for one stable state 1A or 1B in an exemplary fashion. Particularly for clamping the carrier 33 in the respective rest position (stable state), the actuator means of the device comprises a clamping means 661. Further, for triggering transition between stable states/rest positions, the actuator means comprises a disengaging means (trigger) 662. Further, for defining the respective rest position, the actuator means comprises a rest position defining means 663 which is configured to provide supporting points for the carrier 33.

Besides the spring(s) 34 a further (e.g. inelastic) springs 35 (e.g. mechanical hard stop generating force 100C) may be used to define, in combination with the magnet forces, the end-positions 1A or 1B.

As indicated on the right hand side, the damping means 36 may comprise at least one of: a mechanical damper 36A, 39 generating a force 103 on carrier 33, an eddy current damper 37 comprising magnet 32C for generating a Lorentz force 104 due to eddy currents in a structure facing the carrier 33/magnet 32C, a magnetic damper 38 (comprising magnets 32D, 32E) for generating force 105 and/or an active damper 41 (e.g. comprising coil 31B interacting with magnet 32E) for generating force 106.

In this regard, FIG. 10 illustrates where the above-discussed forces 100A, 102A, 102B, 101, 100C, 103, 104, 105, 106 act and contribute.

FIG. 11 shows a modification of the embodiment shown in FIG. 9, wherein here a mechanical stop for the carrier 33 is absent. Instead, the optical device 1 comprises a clamping means that also provides a rest position defining means 663 for defining a rest position of the carrier 33 in the stable state 1A or 1B that may use reluctance forces for defining said rest position.

Again, FIG. 12 illustrates where the above-discussed forces 100A, 101, 102B, 103, 104, 105, 106 act and contribute.

Furthermore, in contrast to FIG. 9, FIGS. 16A, 16B, and 16C show block diagrams of the optical device 1 for two desired positions of the carrier 33/spring 30. For this, according to FIG. 16A the magnets 32C and 32B, the coil 31A do not need to be duplicated, since the magnetic clamp provides clamping for both positions while the disengaging (release) mechanism provides a disengaging function 662 for both desired positions in which the carrier 33/spring 30 can be clamped. Further, a stop 35 can be omitted in FIG. 16A.

In the alternative diagram of FIG. 16B the coil 31A and magnet 32B do not need to be duplicated, but can be duplicated. Here, the end stops 35 and clamps 32A need to be duplicated.

Particularly, in the embodiment according to FIG. 16A, holding of the carrier in the two rest positions/stable states 1A, 1B is achieved by means of reluctance forces. For this, the optical device 1 comprises a magnetic flux return structure 73a, 73b, 74 that forms gaps with a magnetic flux guiding portion 72a,72b of the carrier 33 in both rest positions such that reluctance forces are generated that hold the carrier 33 in the respective rest position. Here, in the respective rest position damping can be achieved by eddy current dampers 37 but also by all other described damping possibilities 36. Further, for generating the magnetic flux, a magnet 32A can be arranged on said portion 72a, 72b. Alternatively or in addition a magnet 32AA can be positioned in the bottom of the magnetic flux return structure 73a, 73b, 74, via which bottom the magnet flux is guided in both rest positions of the carrier 33/portion 72b.

Furthermore, FIG. 16C shows a modification of the embodiment shown in FIG. 16B, wherein the spring 30 that is connected to the carrier 33 forms a part of the magnetic flux return structure 73a, 73b, 72b such that the magnetic flux is guided via the spring in both rest positions of the carrier 33/portion 72b.

Furthermore, FIGS. 13A to 13C show different embodiments concerning defined positions (supporting points 61A) of the carrier 30/plate member 55, wherein here the carrier 33 comprises four defined rest positions (e.g. tilting angles) corresponding to a stable state, respectively, wherein these rest positions are provided by suitable supporting points 61A which are generated by corresponding rest position defining means 663 (not indicated in FIGS. 13A to F) and particularly rotational joints or axes of the carrier 33.

According to FIG. 13A the optical device 1 provides one defined supporting point 61A (i.e. generated by a means for defining a rest position 663 such as a stop etc.) on each of the four sides/edge regions 331, 332, 333, 334 of the carrier 33. However, only three supporting points 61A are necessary for defining the respective plane corresponding to a rest position of the carrier 33/plate member 55. Thus, in case of a rotational joint provided by springs 30A, 3B as described herein (two rotation axes 700, 701), only two further defined supporting points 61A are needed.

According to FIG. 14B such a rotational joint can be accomplished by providing a carrier 33 with a first part 33A and a second part 33B holding the plate member 55 as described in conjunction with FIGS. 2A to 2D (see also FIG. 25).

Particularly in FIG. 13A, the actuator means comprises at least two disengaging means 662 (some possible positions are indicated with a dashed circle), particularly four disengaging means 662. Here, in case the optical device comprises two disengaging means 662 they are preferably configured as push-pull means which can pull the carrier 33 and push the carrier (e.g. along axis A) for triggering a transition between two stable states. Such disengaging means are preferably arranged between two supporting points 61A along an associated edge region (e.g. 331), but preferably not on diagonally opposing corner regions. In case the optical device comprises four disengaging means 662, many different positions are possible. Particularly, the respective disengaging means 662 may be arranged at the respective supporting point 61A. Further, each disengaging means 662 may be arranged at an associated corner region of the carrier 33 (e.g. in a region where edge region 331 and edge region 332 meet). Further, each disengaging means 662 may be arranged adjacent an associated supporting point 61A. Generally, according to an embodiment, said two or four disengaging means 662 are arranged such that they can trigger (as a whole) a transition between each two stable state of the four stable states.

Further, particularly, the optical device may here comprise at least four clamping means (only one indicated in FIG. 13A) for clamping the carrier 33 in the rest positions. For instance when triggering a transition between two stable states one of the clamping means 661 can maintain clamping the carrier 33 so as to provide a defined rotation axis together with the universal joint. Alternatively, the clamping means 661 can be arranged close to the corner regions (e.g. where edge regions meet) of the carrier 33. Here, one would simply release the clamping means 661 for the transition between stable states/rest positions.

Furthermore, according to FIG. 13B, the optical device 1 may use a rotational joint 30C/flexure 30C to connect the plate member 55/carrier 33 to the support frame 51 and provide two defined supporting points 61A for the carrier 33/plate member 55 on top of each other (e.g. on two diagonally opposing corner regions of the carrier 33). Again, three supporting points 61A suffice to define a rest position/stable state of the carrier 33. Here, one such supporting point is provided by a rotational joint (which can be one of the joints 30C, 30D, 30E, 30F of FIGS. 14A, 14C, 14D, 14E).

Further, particularly, the actuator means comprises at least two disengaging means 662 (dashed circles indicate some possible positions) which are arranged at or adjacent an associated supporting point 61A. Further, here, particularly, the optical device comprises at least two clamping means 661 for clamping the carrier in the rest positions, which clamping means 661 are arranged at or adjacent an associated supporting point (only one clamping means 661 indicated in FIG. 13B).

FIG. 13C shows a variant with two defined supporting points 61A on top of each other on all four sides of the plate member 55. In FIG. 13C, the carrier 33/plate member 33 does not have a defined support by means of springs that may provide a universal joint or rotation axes but can have guiding springs to support the rest positions.

Here, particularly, the actuator means comprises at least four disengaging means 662 (some possible positions of a disengaging means are indicated with dashed circles), wherein each disengaging means is arranged at an associated edge region 331, 332, 333, 334 of the carrier 33/plate member 55. Here, particularly, at or adjacent each supporting point 61A a clamping means 661 is arranged for clamping the carrier 33 in the respective rest position (only one clamping means 661 is indicated in FIG. 13C)

According to FIGS. 14A, 14C, 14D, 14E, as already indicated, the arrangement of FIG. 13B may be used in conjunction with a gimbal 30C, a single flexing beam 30E, 30F or two flexing beams 30D (cf. FIG. 14D). Particularly, as shown in FIG. 14E, the beam 30F may have cross configuration with four arms extending from a central region which allows a rotational support of the carrier 30. Other joints achieving the respective function may also be used.

Furthermore, FIGS. 13D, 13E, and 13F show possible supporting points 61A for a carrier 33 that can assume two different rest positions (corresponding e.g. to two stable states 1A, 1B).

According to FIG. 13D the three rest position supporting points per rest position of the carrier 33 are provided by a rotational axis 700 (e.g. generated by two aligned springs 30 as described herein) and a single supporting point 61A that may be generated with help of a rest position defining means as described herein. Here the rotational axis 700 may extend diagonally along the carrier 33/plate member 55.

Here, particularly, the actuator means comprises at least one disengaging means 662 arranged on an edge region of the carrier 33 (e.g. at edge region 331 or where edge regions 331, 332 meet). Here, the optical device particularly comprises two clamping means 661 for clamping the carrier 33 in the respective rest position (only one clamping means is indicated), wherein each clamping means 661 is arranged at or adjacent an associated supporting point 61A. Alternatively, two clamping means 661 may be arranged at one of the supporting points 61A on top of each other for providing clamping for each of the two rest positions.

Further, FIG. 13E shows a modification of the embodiment of FIG. 13D, wherein here two supporting points 61A are arranged on top of one another.

Further, FIG. 13F shows a modification of the embodiment of FIG. 13E, wherein here the rotational axis 700 extends along a corner region of the plate member 55/carrier 33.

Particularly in FIGS. 13E, F, the disengaging means 662 can be arranged on a corner region of the carrier 33/plate member 55. Further, particularly, the optical device may here comprise two clamping means 661 for clamping the carrier 33 in the respective rest position (only one clamping means 661 is shown), wherein each clamping means 661 is arranged at or adjacent an associated supporting point 61A.

FIG. 13G shows a variant with two defined supporting points 61A on top of each other on two opposing corner regions of the plate member 55. In FIG. 13G, the carrier 33/plate member 55 does not have a defined support by means of springs that may provide a rotation axis, but can have guiding springs to support the rest positions.

Further, FIGS. 15A to 15D show different embodiments of the optical device 1 relating to the damping means 36 of the optical device 1. In contrast to FIGS. 2A-2D and 24 all damping means and stops are arranged adjacent the respective coil of the disengaging means of the actuator means 66. According to FIG. 15B the respective magnet 32B is arranged on the carrier 30 (e.g. either on the first part 30A or on the second part 30B), see also FIG. 15A, wherein the magnet 32B is arranged above an associated electrical coil 31A wherein the magnetization of magnet 32b and the winding axis of coil 32A are parallel.

Particularly, a magnetic flux guiding member 40B is attached to a face side 400B of the respective magnet 32B, which face side faces the associated coil 31A. Said magnetic flux guiding member 40B forms a magnetic flux return structure with a region 40C of the carrier 33 for the magnetic field of the respective magnet 32B, wherein particularly the respective magnetic flux guiding member 40B is arranged in a central opening of the associated coil 31A. Due to the return structure, the magnetic field extends parallel to the member 40B/face side 400B inside the central opening of the coil 31A.

The coil 31A and magnet 32B are configured to provide a Lorentz force that pushes magnet 32B away from coil 31A so that a transition between stable states 1A, 1B of the carrier 30 (e.g. a tilting of the whole carrier about first axis 70 and/or a tilting of the second part 30B about the second axis 71 with respect to the first part 30A) can be triggered.

In order to damp such a movement upon reaching the respective stable state 1A, 1B, the optical device 1 comprises damping means 36 (here, e.g. four such damping means 36 for each stable state 1A, 1B). As indicated in FIG. 15B the damping means comprises a damping element 36A comprising a damping material such as a rubber (see also below) that may be arranged on the support frame 51, namely here below the respective magnet 32B, particularly adjacent clamping magnet 32A, particularly around magnet 32A.

Particularly, said rubber may be PDMS, silicone, polyurethane, any elastomer, polyether-based polyurethane, fluoroelastomer, Viton, a material with enhanced visco-elastic properties (like Viton), a non-Newtonian material, etc., and may be provided as a rubber-to-metal over-mold, a rubber coating, a rubber glue, a rubber gap filler etc.

Furthermore the damping element 36A (e.g. rubber like damper) may comprise air pockets, e.g. may be formed out of a silicon foam or an aerogel, an EPDM foam, or any other foam. The damping element 36A can also be any shock absorbing (e.g. rubber like, or porous) coating.

The respective damping means 36 further comprises an eddy current brake 37 (see also FIG. 9) formed by a material portion of the support frame 51 in which currents are induced once the respective magnet 32B comes close enough to said material portion 37 which may then be laterally arranged with respect to the magnet 32B, wherein said material portion 37 is surrounded by the respective coil 31A.

Further, FIG. 15B shows a damping element 36B (that may also serve as a spring, see also spring 34 FIGS. 9 and 8B) for contacting the magnet 32B or a soft magnetic part 40B attached to the face side of magnet 32B upon arrival of the magnet 32B towards magnet 32A. Here, said soft magnetic part 40B may form a return structure with a region 40C of the carrier 30 for the magnetic field of the magnet 32B. The damping element/spring 36B may be formed out of a rubber or said damping material and may be attached (e.g. integrally) to the damping element 36A.

Furthermore, the magnets 32B and 32A (or any other pair of magnets) may form a magnet-to-magnet repulsive pair 38 for damping means (see also FIG. 9 showing magnets 32D and 32E).

Furthermore, also an active counter acting coil-magnet arrangement may be used to dissipate energy, which can be achieved with the magnet 32B and the coil 31A, for example, by sensing the position of the magnet 32B with a hall sensor, or by measuring the induced voltage in the coil 31A or an induced current in the coil 31A, or by means of a capacitive measurement (e.g. capacitance between the carrier 33 and the support frame 51) and a corresponding control of the current applied to coil 31A.

Further, the damping means 36 may comprise an aerodynamic (air) damping element 39. Here, e.g. in the form of a pinhole in sealed chamber, or closed chamber with leakage).

Further, the damping means 36 may also comprise a fluid dynamic damping means (oil,-gel, water, damping grease with high resistance to shear stress).

FIG. 15C shows a variant of FIG. 15B, wherein in contrast to FIG. 15B, where the magnet 32A is surrounded by the damping material of the damping element 36A and embedded in the damping material, so that the magnet 32A can vibrate, the magnet 32A of the embodiment of FIG. 15C is embedded into the support 51 (without surrounding damping material) and thus comprises an exact position with respect to the support 51.

The damping element 36B is arranged on the support 51 and may be formed out of a rubber (or said damping material) and thus also provides a spring effect. The damping of the damping element 36B is preferably non-linear (e.g. initially comparatively soft and then gets harder). The damping element 36B may surround a cavity filled with a gas, particularly air.

Further, in FIG. 15D a variant is shown where in contrast to FIG. 15B the eddy current brake 37 is realized using a material portion below coil 31A which portion does not protrude (but can protrude) into the central opening of the coil 31A as in FIG. 15B and is arranged on a face side of the magnet 32A that faces the coil 31A/magnet 32B. Further, the member 40B is absent which changes the shape of the magnetic field of the magnet 32B, which magnetic field is now oriented parallel to a winding axis W of the associated coil 31A (an electrical conductor of the coil 31A is wound about the winding axis to form the coil 31A) at the face side 400B of the respective magnet 32B.

Further, FIG. 17A shows a further variant of the damping means 36 being essentially configured as shown in FIG. 15B which also uses an air dampening. Here, a magnetic reluctance based brake can be used in addition, comprising at least one magnet 32B and a soft magnetic part 40B attached to the face side of the magnet 32B, which magnet 32B may be a magnet of the actuator means 66 that is used for disengaging (i.e. triggering transition between stable states) together with an associated coil 31A, but can also be a separate magnet, and a return structure 40C for the magnetic field of magnet 32B which structure 40C also forms an enclosure and has a region for forming a gap with the soft magnetic part 40B of the magnet 32B when the latter approaches its end position related to a stable state (e.g. 1A or 1B). Due to the gap, reluctance forces are generated that brake the magnet 32B and thus the carrier 33 to which the magnet 32B is attached. The coil and and the return structure can be separated.

Furthermore, the coil 31A and the return structure 40C does not necessary have to be arranged on top of one another as shown in the cuts AAA and AA of FIG. 17A. Here, cut AA shows the disengaging means using magnet 32B and associate coil 31A for triggering transitions of the carrier 33 between stable states, while cut AAA shows the reluctance brake using structure 40C and the magnet 32B with magnetic soft part 40B.

Further, the enclosure 40C is connected to ambient atmosphere by an air channel 39 for providing air dampening in addition.

Furthermore, FIG. 17B shows an embodiment of a damping element 36A that combines a rubber material and a damping grease 36N.

The damping element 36A here comprises a rubber element 36B above a damping grease element 36N which are embedded into the support frame 51 (or are arranged on an element of the support frame 51 such as an adjustment screw that allows to adjust the position of the damping element), wherein this combination 36B, 36E functions as spring 34 as well as full-stop 35 as indicated in FIG. 17B.

FIGS. 17C to 17L shows further embodiments of damping means 36 wherein here e.g. a portion 50 of the carrier 30 interacts with the respective damping element 36

According to FIG. 17C, the damping means 36 may comprise a bottom-mounted damping element 36A (e.g. a glue, or gap filler, or molded part), particularly adjacent the magnet 32A and embedded into support frame 51, as well as a top-mounted damping element 36C with a gap between the latter and said portion 50 (e.g. molded part, sheet spring like part, dispensed silicone droplet, foam, rigid foam, aerogel, with or without pores).

Further, according to FIGS. 17C, 17D, the damping means 36 may comprise a damper 36D (e.g. a magnet coating, magnet over-molding, co-molding, gap filler, or molded part) that particularly encloses the magnet 32A, particularly adjacent magnet 32A and may embedded at least partially into support frame 51, as well as a top-mounted rubber-like non-linear damping element 36C (FIG. 17C), particularly a damping element 36E without a gap between the latter and portion 50 (less noisy, prolonged braking phase), see FIG. 17D.

Further, according to FIG. 17E, the damping means 36 may comprise a top-mounted elastic or viscous-elastic non-linear damping element 36F without a gap between the latter and portion 50 (e.g. a sheet metal or plastic spring with non-linear force-travel characteristics).

Further according to FIG. 17F, the damping means 36 may comprise a side-mounted damping element 36G (e.g. molded part, over-molded magnet)

In all embodiments shown in FIGS. 17C to 17F the top mounted damping elements 36C, 36E, 36F may also be attached to the housing/support frame 51 instead of the magnet's 32A top surface 36D. This is shown in FIGS. 17G-17I.

Furthermore, as shown in FIGS. 17J-17L, the damping and clamping domains may also be separated. Here, the top-mounted damping elements 36L and 36M sit next to or around or inside the respective magnet 32A (which can also be a ring magnet).

The damping device position relative to the clamping device position D can be fixed or tuned during assembly of the optical device 1.

It is to be noted that in general the local potential traps (i.e. the stable states 1A and 1B) can be shaped using a combination of various elements, such as
a magnet-to-magnet repulsive pair
a magnet-to-magnet attractive pair
a magnet-to-(ferromagnetic metal) pair
a non-linear mechanical spring
a mechanical hinge/joint mechanism
a haptic mechanism
an electro-magnetic element
an electro-dynamic (eddy current) element.

Further, FIGS. 18A and 18B show further embodiments of the device according to the invention with respect to the clamping means.

For example, as shown in FIG. 18A this means may comprise magnets 32A with at least one alternating magnetization direction that shapes a force-distance characteristics differently compared to a single magnet. This can be designed with or without a magnetic flux closure 40B and 40C. Thus, magnet 32B can be moved up or down with respect to the housing/support frame 51 by powering the coil 31A with positive or negative voltage.

In particular, compromising a magnetic flux closure 40B that is saturated by the permanent magnet 32B caused field B_{32B}, but not by the magnetic field B_{32A} caused by the magnets 32A, the combined magnets 32A clamp to magnet 32B when brought into close proximity, and remain clamped after on.

Furthermore, as an alternative, FIG. 18B shows as clamping means an arrangement of two counter magnetized magnets 40A and 40D, where 40D is bigger than 40A, and a coil 31A, such that the magnetic flux closure 40B is not, or only partially saturated when the coil is inactive, and indeed is saturated or oversaturated when the coil is active.

Thus the magnetic flux closure 40B turns the repelling force between 40A and 40D into an attractive force, at least when the coil 31A is inactive. When active, the coil 31A field B₃₁ saturates or partially saturates the closure 40B, thus no attractive force can be mediated anymore, thus magnets 40A and 40D repel each other in the same ways as they would in absence of 40B.

The magnetization/saturation in the 40B can also be out-of-plan.

Furthermore, the individual stable state positions can also be defined in a mechanical manner using buckling as shown in FIGS. 19A and 19B. Particularly, as shown in FIG. 19B such a configuration may also be spring-loaded. Also here, the above-discussed release and damping mechanisms apply as well.

Particularly, the actuator means 66 according to FIG. 19A is a mechanical bistable actuator means 66 that comprises a middle plate 89A that is connected, particularly integrally connected, via at least two angle plates 89B to a support 88 of the optical device 1 such that the middle plate 89A is bistable and comprises two stable states corresponding to two different positions of the middle plate 89A with respect to the support 88. It is to be noted here that also four angle plates 89B may be used to connect the middle plate 89A to the support 88 in order to inhibit a rotation of the middle plate 89A. Further, the middle plate 89A is connected to the carrier 33 which holds the transparent optical plate member 55. Furthermore, an actuator 660 is provided that is configured to force a transition of the middle plate 89A from one stable state to the other stable state of the middle plate 89A which yields a corresponding transition of the carrier 33 between its two stable states (the two positions correspond to the two different angle positions of the angle plates, wherein one position is shown in FIG. 19A while the other position is indicated with lines in FIG. 19A). The actuator 660 can be an electro-magnetic actuator, an electro-active polymer (EAP), a piezo actuator, a magnetorestrictive actuator, a phase change material, a shape memory alloy.

Further, as shown in FIG. 19B, on one side of the support 88, the latter may comprise a spring 87 for elastically pretension the angle plates 89b and middle plate 89A, wherein this side of the support 88 may be guided by guiding means 86.

Further, according to FIGS. 21A and 21B, in an embodiment, the carrier 33 (here denoted as carrier 69a) may be connected, particularly integrally connected, to a support 68a, 68c (e.g. a support frame as described herein) of the optical device 1 such that it is bistable (cf. FIG. 21B) and comprises two positions with respect to the support corresponding to a first and a second stable state (e.g. states 1A, 1B) or that it is quadristable (cf. FIG. 21A) and comprises four stable positions 66, 61, 62, 63 with respect to the support 68a, 68c corresponding to four stable states.

Particularly, as shown in FIG. 21A, the carrier 69a is connected on a side of the carrier via a joint 64 to an angle plate 69b which in turn is connected via a further joint 64 to the support 68a, and wherein the carrier 69a is connected on an opposing side via a joint 64 to an angle plate 69b which in turn is connected via a further joint 64 to the support 68c, wherein particularly a spring 67 may connect the further joint 64 to the support 68c or may be integrally formed with the support 68b, 68c, or may be formed integrally with the joint 64 and/or the further joint 64 on said opposing side of the carrier 69a (cf. also FIG. 23).

The specific arrangements of two angle plates 69b and four joints allows the carrier 69a to assume four stable states/rest positions which are indicated in FIG. 21A with the number 60 to 63.

Further, FIG. 21B shows a modification of FIG. 21A using only three joints 64 and one angle plate 69b allowing for two stable states of the carrier 69a indicated as stable state 60 and 61. Particularly, here, the carrier 69a is connected on a side of the carrier via a joint 64 to an angle plate 69b which in turn is connected via a further joint 64 to the support 68a, and wherein the carrier 69a (or 33) is connected on an opposing side via a single joint 64 and a spring 67 to the support 68c, wherein particularly said spring 67 may be integrally formed with said single joint 64.

Transitions between the stable states of FIGS. 21A and 21B may be triggered by means of an actuator means 66 as described herein.

Further, FIG. 22 shows an embodiment of an optical device 1 according to the invention, which particularly comprises a configuration of supporting points 61A as described in conjunction with FIG. 14B.

Particularly, the carrier 33 holding plate member 55 is connected via two springs 33 (e.g. torsion beams) two a support frame 51, wherein the two springs 33 are aligned such that a rotation axis 700 is formed that runs diagonally along the carrier 33/plate member 55. The carrier 33 can be tilted by using an actuator means 66 as schematically shown in FIG. 16B.

For providing a clamping means of the actuator means 66 of the device 1, the carrier 33 comprises in a corner region two magnetic flux guiding portions 72a, 72b, namely a top magnetic flux guiding portion 72a and a bottom magnetic flux guiding portion 72b, which are arranged on top of each other, and may either be connected via a magnet 32A (which is however omitted in FIG. 22) or directly.

In the rest positions small air gaps G are formed with a magnetic flux return structure connected to the support frame 51. The air gaps G are minimal in both rest positions so that a corresponding reluctance force clamps the carrier 33 in these positions.

In detail, said return structure comprises a first top magnetic flux guiding portion 73a, a second top magnetic flux guiding portion 73b, and a bottom magnetic flux guiding portion 73c, as well as a magnet 32aa that connects the bottom magnetic flux guiding portion 73c to the first and second top magnetic flux guiding portions 73a, 73b.

As can be seen in FIG. 22, the top portions 73a, 73b have a different height so the top portion 72a can form two minimal gaps G with the top portions 73a, 73b corresponding to the two possible rest positions (stable states). In each rest position the bottom portion 72b forms a small air gap with the bottom portion 73c of the return structure.

The disengaging means/function of the actuator means 66 is spaced apart from the clamping means and arranged diagonally opposite said return structure (i.e. on the other side of the rotational axis 700). Particularly a coil and a magnet may be used to force transitions between the two stable states, wherein the coil may be arranged on the support frame 51 while a corresponding magnet can be arranged on the carrier 33. Alternatively, reluctance forces may be used instead of Lorenz forces to trigger transitions between the two stable states of the carrier 33. Any other suitable force/actuator described herein may also be used.

The same actuator can further be used to realize a system having four stable states, e.g. by using the left corner actuator additionally in the diagonal corner and using a spring structure 30 which avoids air gap closing (cf. also FIG. 14E or FIG. 28).

Further, FIG. 24 shows, particularly in conjunction with FIG. 26, a modification of the embodiment of FIG. 22, wherein here, two actuator means 66D are used which are arranged in opposite corner regions of the carrier 33/frame support 51, wherein here the clamping and disengaging function of the respective actuator means 66D are arranged nearby.

As shown in FIG. 26, the respective actuator means 66D comprises a magnet 32A that is arranged between the carrier 33 (forming a top magnetic flux guiding portion 72) and a bottom magnetic flux guiding portion 72 (the lower one in FIG. 24). The magnet 32A is arranged on top of an elongated coil 31A such that is comprises a cross sectional area as shown in cut A-A that can be used to generate a Lorentz force using coil 31A and portion 32B of magnet 32A (e.g. such that coil 31A and magnet portion 32B repel each other) for triggering a transition from one stable state to the other stable state of the carrier 33.

Further, for realizing a clamping means a return structure is provided such that the arrangement of magnet 32A and coil 31A comprises a cross sectional area (cut B-B) that comprises a magnetic flux return structure 73 according to FIG. 26.

In detail according to FIG. 24, said return structure comprises a top magnetic flux guiding portion 73 (upper one in FIG. 24) and a bottom magnetic flux guiding portion 73 arranged on the support frame 51, respectively, as well as a magnet 32AA arranged on the bottom magnetic flux guiding portion 74, which magnet 32AA connects the bottom portion 73 with the top portion 73.

Further, in the rest positions of the carrier 33 small air gaps G are formed between the top magnetic flux guiding portions 72 and 73 and between the bottom magnetic flux guiding portions 72 and 73 for generating a reluctance force that clamps the carrier 33 in the respective rest position. Since the carrier 33, namely the two portions 72 being arranged on top of one another are arranged a bit higher or lower as the associated surrounding portions 73 the air gaps G are minimal in the left corner region of the carrier 33 when the carrier 33 is tilted downwards/upwards there (corresponding to the rest position/stable state), or are minimal in the right corner region when the carrier 33 is tilted downwards in said right corner region (and thus tilted upwards in the left corner region of the carrier 33).

Furthermore, the device 1 may comprise a noise-vibration reduction mounting 76 (which may comprise at least one of: a damping plate, a rubber, a ring, a material like fluoroelastomer, polyurethane, silicone).

For making electrical contact to components of the device 1, particularly to the coils 31A and/or a corresponding control unit as well as sensors, the device 1 may comprise a flexible flat cable 80 which may be integrally formed with a printed circuit board for supporting the coils and particularly also other components, wherein a connector 81 may be provided at the end of the flexible flat cable 80

Furthermore, FIG. 23 shows an application of the design of carrier 69a shown in FIG. 21A, wherein the schematical cross section shown in FIG. 21A essentially corresponds to a cut along the dashed line in the detail of FIG. 23.

Here, the two joints 64 that connect the respective angle plate 69b to the middle plate/carrier 69a or 33 are integrally formed with springs 67. For this, the joints 64 are formed by torsion beams that extend along the respective rotation axis 700 of the joint 64, which beams undergo a torsional deformation when the middle plate 33 is tiled (cf. also FIG. 21A) wherein the respective spring 67 is realized by a bending movement of the respective torsion beam 64a in a direction perpendicular to the respective rotation axis 700. Here, a transition between the four possible stable states 60 to 63 can be triggered by an actuator means 66 that acts on the carrier 33/69a adjacent the respective inner joint 64. The actuator means 66 may comprise a coil and a magnet below the respective region of the carrier 33/69a for this task.

However, all other actuator means described herein may also be used (particularly without a mechanical hard stop) as well as all damping means described herein.

Particularly, a prestraining of the structure can be achieved by force F and than fixing the so-bended structure by means of screw F′

As described before, the device 1 may comprise a noise-vibration reduction mounting 76 (e.g. damping plate, rubber, ring, material like fluoroelastomer, polyurethane, silicone), as well as a flexible flat cable 80 with connector 81 (see also above).

Furthermore, FIG. 25 shows a further embodiment of the optical device according to the invention, wherein the carrier is supported via springs 30A, 30B as described above and thus four stable positions (see FIG. 13A as well as FIG. 2A-2D). The actuator means 66 can be designed as shown in FIG. 15B or 15D, i.e., the magnets 32b may protrude with their soft magnetic portions (magnetic flux guiding portions) 40B into the central opening of the associated coil 31A (FIG. 15B), but may also not comprise such a guiding structure 40B as explained in conjunction with FIG. 15D.

According to an embodiment, the springs 34, end stops 35, damping means 36 (all damping means described herein, particularly according to FIGS. 17 and/or 9, may be used) or otherwise provided supporting points 61A (which components 34, 35, 36, 61A are here arranged spaced apart from the disengaging means 31A, 32B of actuator means 66) are preferably designed to be adjustable in height (i.e. in a direction essentially normal to the plate member 55) so that the tilt of the plate member (e.g. glass) 55 can be adjusted to specific needs. Further, the coils may comprise eddy current brakes as described in conjunction with FIG. 15B.

As described before, the device 1 may comprise a noise-vibration reduction mounting 76 (e.g. damping plate, rubber, ring, material like fluoroelastomer, polyurethane, silicone), as well as a flexible flat cable 80 with connector 81 (see also above)

Further FIG. 27 discloses a further aspect of the present invention, namely a system that comprises a plurality of stacked optical device according to the invention. By means of such a stack of plate members 55 that can be individually tilted a shifting of the incident light beam (optical switching) corresponding to x″ different states can be achieved, wherein x is the tilt angle of the carrier provided by the individual device and N is the number of stacked plate members 55/devices 1. Different angles x may be provided by height-adjustable means as described in conjunction with FIG. 25.

Further, particularly, in embodiments of the present invention, mechanical leverage (e.g. 10×, 100× or 0.1×, 0.01×) may be used for amplifying short travel actuators (such as piezo or magnetostrictive actuators) or for reducing long travel actuators (such as EM actuators) in favor of accuracy of defined position and amplified accelerating force.

Finally, as shown in FIGS. 20A to 20D starting the actuators described herein with regard to the embodiments of FIGS. 13C and 13G with the correct delay will significantly reduce the settling time.

In detail, the two opposing disengaging means 66 of the actuator means in FIGS. 13C and 13D are switched from an up/down to a down/up configuration. If the waveform going to the second disengaging means 66 is delayed by a optimal time

t_{delay}1/(2*f_{ch})

where f_{ch} is the characteristic oscillation of the carrier 33 versus the waveform going to the other (first) disengaging means 66, the ringing shows only in the optically non relevant coordinate along the optical axis and not in the tilt angle of the plate member 55.

Further, in general, the activation energy 2A is preferably designed as little as possible.

Further, preferably, the duty cycle of the system is small, e.g. the duty cycle of the coil actuation pulse (current on coil) for an optical switch (e.g. a transition between two stable points) is smaller than 90%, particularly smaller than 50%, particularly smaller than 10%, particularly smaller than 5%, particularly smaller than 1% of the total time during which the device 1 is turned on (e.g. in an “on”-state), wherein the total time is the sum of the switch time used for transition between stable states and the holding time used for holding the carrier in the respective stable state.

Preferably, short acceleration pulses are used in general to bring the system over the potential barrier, from then on, no further energy supply is actually needed (before the subsequent switch is triggered).

Energy absorbed during deceleration or damping phases could be temporarily stored and reused in the next cycle (e.g. electrical storage in capacitor or supercapacitor, mechanical storage in a spring system (elastic energy), storage in an coupled secondary oscillating system (kinetic and potential energy that oscillates).

Finally, anything described above in conjunction with the individual embodiments can readily be applied to two distinct coordinate axis 700, 701 as explained in conjunction with FIGS. 2A to 2D.

FIG. 29 shows a schematic illustration of yet another embodiment of an optical device 1 according to the invention.

Also here, the optical device 1 may serve for shifting a light beam or a projected image, particularly for enhancing the resolution of the image, and comprises a transparent plate member (not shown) configured for refracting said light beam passing through the plate member, a carrier 33 to which said transparent plate member is rigidly mounted, wherein the carrier 33 is configured to be moved between a first and a second state, whereby said light beam is shifted. Particularly, the carrier 33 is configured to be multistable, here e.g. bistable, wherein said first and said second state are stable states of the multistable carrier 33. Further, for tilting the carrier 33, the carrier is coupled via a spring 30 or several springs 30 to a support (e.g. a support frame), wherein the optical device 1 comprises an actuator means 66 that is configured to force a transition of the carrier 33 from the first stable state to the second stable state and vice versa. Here, particularly said actuator means comprises at least one electropermanent magnet 807. Here, the electropermanent magnet 807 is configured to hold the carrier 33 in a stable state by means of a reluctance force 102A against the action of a counterforce 100A provided by said spring(s) 30. Once the electropermanent magnet 807 releases the carrier 33 (e.g. by turning of the reluctance force 102A), the counterforce 100A moves the carrier 33 out of the present stable state and into another stable state (here a further electropermanent magnet may be present to again hold the carrier in said other stable state).

FIGS. 30 A) to M) show different configurations of such an electropermanent magnet 807.

Generally, the respective electropermanent magnet 807 comprises at least a first magnet 805 having a magnetization M1 and a first coercivity and a second magnet 804 having a second coercivity that is smaller than the first coercivity, and wherein an electrically conducting conductor 803 is wound around the second magnet to form a coil 803. Further, the respective electropermanent magnet 807 comprises a voltage source (Vin) (cf. FIGS. 36 and 37) configured to apply a voltage pulse to the coil 803 so as to switch the magnetization (M2) of the second magnet 804. Particularly, the coil 803 can be wound or partially around both magnets 804, 805 and can even be wound around the element 802 of the magnetic flux guiding structure, particularly around the path of the magnetic flux which runs through the magnetic flux guiding region 801, cf FIG. 30B). Further,

According to FIG. 30A) the electropermanent magnet 807 comprises a magnetic flux guiding structure 802 connected to the magnets 804, 805 which magnetic flux guiding structure 802 forms the respective gap G0 with a magnetic flux guiding region 801 of the carrier 33. Here, particularly, the magnetic flux guiding structure comprises two magnetic flux guiding elements 802 spaced apart from one another between which said first magnet 805 and said second magnet 804 are arranged, such that each magnet 805, 804 contacts both elements 802, wherein each element 802 comprises a face side 802f facing the magnetic flux guiding region 801, which face sides 802f form the gap G0 with the magnetic flux guiding region 801.

The working principle of the electropermanent magnet 807 shown in FIGS. 30A) to L) can be easily explained using FIG. 30A). In case the first magnetization M1 of the first magnet 805 points to the left, switching the magnetization M2 of the second magnet 804 also to the left, as shown in FIG. 30A) produces a magnetic flux that is guided via element 802 on the left hand side and magnetic flux guiding structure 801 back to the other element 802 (on the right hand side) of the magnetic flux guiding structure. This generates a reluctance force that tries to minimize gap G0 against a counterforce acting on the carrier 801 (e.g. spring force(s)).

Switching the magnetization M2 of the second magnet 804 such that the magnetizations M1, M2 are antiparallel closes the magnetic flux inside the structure 802 so that the reluctance force vanishes and the magnetic flux guiding region 801 of the carrier 33 is pushed away from the electropermanent magnet 807 by the spring force(s) so that the carrier 33 moves to the other (e.g. second) stable state.

The switching of the second magnetization M2 can be achieved by applying a current pulse to the coil 803 surrounding the second magnet 804. Advantageously, energy is only required for changing the direction of the magnetization M2 of the second magnet 804 but not for maintaining it in the switched direction. Thus, the actuator 807 can be driven by means by a series of current pulses which saves a considerably amount of energy.

Particularly, both magnets 804, 805 are arranged such that their magnetization M1, M2 is either parallel or antiparallel and extends essentially along the extension plane of the carrier 33 or transparent plate member 55. Alternatively, cf. FIG. 30D) lower part, the carrier 33/magnetic flux guiding region 801 may also extend perpendicular to said magnetizations for generating a tilting movement in the directions indicated by the double arrow.

As shown in FIG. 30B), the coil 803 may also surround the first magnet 805. Furthermore, FIG. 30B) also shows the embodiment according to which a part of coil 308 or a separate coil 308 is wound around a portion of a magnetic flux guiding element 802.

Further, the first magnet 305 may be enclosed by a separate further coil 803a (cf. FIG. 30C).

Further, as shown in FIG. 30D at least one additional permanent magnet 32 may be attached to the carrier 33 (or to the magnetic flux guiding region 801 of the carrier 33. If the carrier 33 with the magnets 32 is not very close, magnetic forces (dipol-dipol interaction) dominate, <<EPM on>>: dipol-dipol interaction, <<EPM off>>: neglected forces, e.g. reluctance forces are very low.

If the magnet 32 is very close (e.g. smaller than 1 mm) to the EPM 807, turning the EPM 807 on generates a dipol-dipol interaction, in case the EPM 807 is off, a reluctance force towards element 802 is generated.

The dipol-dipol interaction/force can be repulsive or attractive depending on the polarization of the magnets 32 and the EPM 807. The force direction depends on the field gradient.

In case the at least one magnet 32 is located between the two elements/plates 802, mainly a mechanical moment will act on magnet(s) 32 and carrier 33 respectively (not shown). Using dipol-dipol interaction or/and reluctance forces combined with a mechanical spring, stable stopping points of the carrier 33 can be created.

An additional advantage can be the reduction of the noise due to absence of the force impuls on the region 801 of the carrier during switching of the EPM.

In addition, as shown in FIG. 30E) such permanent magnets 32 may also be attached to a non-magnetic support 809 of the electropermanent magnet 807 so as to interact repulsively with permanent magnets 32 arranged on said region 801.

Said one or several permanent magnets 32 may also be used to enforce a moment of the carrier 33/801.

According to FIGS. 30F) and 30G) the second magnet 804 may also extend circumferentially around the first magnet, wherein a single coil 803 may surround both magnets (FIG. 30F), or wherein an additional coil 803a may enclose the inner first magnet 805 such that the outer coil 803 also encloses the further coil 803a (cf. FIG. 30G).

Further, according to FIG. 30H) the electropermanent magnet 807 can be arranged between a first and a second member 8011, 8012 of the magnetic flux guiding region 801 of the carrier 33 so that the electropermanent magnet 807 forms two gaps G0 and GOO, namely with member 8011 and 8012. Thus, the plate 801 can be attracted to the electropermanent magnet from both sides depending on which member 8011. 8012 is closer to the electropermanent magnet 807 when the latter is turned on. Thus, two touching or two stable points can be reached.

Further, as shown in FIG. 30I) the electropermanent magnet 807 may comprises a further first magnet 805, wherein the second magnet 804 is arranged between the two first magnets 805, and wherein the second and the two first magnets 804, 805 are arranged with a bottom side on a single magnetic flux guiding structure/plate 802. Here, the second and the two first magnets 804, 805 each comprise an opposing top side 804f, 805f, which top sides form the gap G0 with a permanent magnet 32 that is attached to the region 801 of the carrier 33, which can be a magnetic flux guiding region 801 of the carrier 33 but may also be non-magnetic

Here, particularly, the hard first magnets (large coercivity) 805 are magnetized in the opposite direction compared to permanent magnet 32 (cf. FIG. 30I)).

Further, as shown in FIG. 30J), the second magnet 804 surrounds the first magnet 805, wherein the second and the first magnet 804, 805 are arranged with a bottom side on a magnetic flux guiding structure 802 that comprises lateral portions 802p between which said first and second magnet 805, 804 are arranged, wherein the second and the first magnet 804, 805 each comprise an opposing top side 804f, 805f, wherein the top side 804f of the second magnet 804 covers the top side 805f of the first magnet 805. Particularly, said lateral portions 802p form the gap G0 with the magnetic flux guiding region 801 of the carrier 33.

Further, in FIG. 30K), the second magnet 804 does not cover the top side 305f of the first magnet. However, alternatively, top side 804f may cover first magnet 805. Here, the two magnets are merely arranged on a single magnetic flux guiding structure/plate 802 with their bottom sides while the tops sides 804f, 805f of the second 804 and the first magnet 805 form the gap G0 with a permanent magnet 32 attached to the region 801 of the carrier 33 (which can be a magnetic flux guiding region 801 but may also be non-magnetic). Particularly, the permanent magnet 32 and first magnet 805 are mounted such that they generate a repulsive force.

Finally, FIG. 30L) shows a configuration without a separate magnetic flux guiding structure 802. Here, the second magnet 804 again surrounds the first magnet 805, wherein the second and the first magnet 804, 805 each comprise a top side 804f, 805f and an opposing bottom side 804g, 805g, wherein the top side 804f of the second magnet 804 covers the top side 805f of the first magnet 805 and wherein the bottom side 804g of the second magnet 804 covers the bottom side 805g of the first magnet 805 such that the first magnet 805 is completely enclosed by the second magnet 804, wherein the top side 804f of the second magnet 804 forms a gap G0 with a first member 8011 of the magnetic flux guiding region 801 of the carrier while the bottom side 804g of the second magnet 804 forms a further gap GOO with a second member 8012 of the magnetic flux guiding region 801 of the carrier 33. Also here, the plate 801 can be attracted to the electropermanent magnet 807 from both sides depending on which member 8011. 8012 is closer to the electropermanent magnet 807 when the latter is turned on. Thus, again, two touching or two stable points can be reached.

Particularly, in FIGS. 30A) to 30L) the magnetization of the first magnets 805 points upwards or downwards. The magnetization M2 of the second magnet 804 can be switched by means of the voltage source and coil 803 and particularly further coil 803a to be either parallel or antiparallel to the fixed magnetization M1 of the first magnet(s) 805.

Additionally, coil 803a can be used to create a second electromagnetic field to fine tune the total resulting field. Furthermore this coil can be used for sensing purposes, and it can help to reduce the noise by keeping the magnetic flux during the switching in the EPM (no high force pulse on 801).

Further, particularly the magnetic flux guiding region 801 of the carrier 33 (e.g. movable plate), as well as all other magnetic flux guiding regions 801a, 801aa, 801b, 801bb can be formed out of a soft magnet/magnetic flux guiding material such as steel, spring steel, cobalt-iron soft magnetic alloys, e.g. permendur, hyperco.

Further, according to FIG. 30M) the first magnet 805 can be a ring magnet 805, wherein here the second magnet 804 is enclosed by the coil 803 and is arranged on a bottom of a magnetic field guiding structure 802 that comprises a circumferential wall 802p that encloses said coil 803. Further, a central opening of the ring magnet 805 is filled with a magnetic flux guiding element 802m below which the second magnet is arranged. The coil 803 is arranged below the ring magnet 805.

In the above embodiments, the carrier 33/magnetic flux guiding region 801 may form an integral part of a spring structure. In other words, springs that connect the carrier 33/region 801 to a (e.g. non-magnetic support, particularly support frame 51, see below) can be integrally formed with the carrier 33 or parts thereto.

Further, FIG. 31 illustrates stable states/points of a carrier 33 of an optical device according to the invention. Particularly, the invention offers the advantage that the carrier can be moved without making contact at stable points with the electropermanent magnets 807 that are used to hold the carrier 33 in the respective stable point. This is beneficial since it reduces noise wear to a great extent that would otherwise be generated upon hard stops of the carrier against the support frame (or structure) 51/electropermanent magnets 807.

As illustrated in FIG. 31A) to D) an electropermanent magnet 807 can be used to attract or release said carrier 33 or plate member (e.g. glass) 55 which contains or is connected to a spring structure 30, 30A, 30B that supports the carrier 33 or parts thereof on a support (e.g. support frame 51).

Particularly, a stable contact point (point C) occurs when the spring loaded carrier (e.g. iron plate) 33 is in the vicinity or in contact with the electropermanent magnet 807 as the magnetic (reluctance) force exceeds the repelling spring force (the magnetic force is 1/distance while the negative spring force is proportional to the distance).

A stable point without a contact between the repelling spring force and the attracting magnetic force occurs when the forces cancel each other (point A at distance x_{A}), cf. FIG. 31A,B,C.

Point A is a stable working point. Point B is instable due to an instable force equilibrium. After point B a snapping occurs towards point C at the stop.

Point A can be shifted to increase x_{A}. The maximal x_{A} is reached when A is equal to B, thereafter the system gets instable.

Point A can be shifted to increase x_{A} by:
by changing the gap of the electropermanent magnet 807 to the metal structure, e.g. to the said magnetic flux guiding region 801 of the carrier (cf. FIG. 31A,B,C),
decrease spring constant of the spring(s) 30, 30A, 30B (not shown in FIG. 31)
increasing the remnant magnetization Mr of the electropermanent magnet 807 or magnetic field of a magnet (see next FIG. 32)

Because the magnetization Mr of the electropermanent magnet 807 can be changed by a current pulse it can be used for a fine tuning after production.

Further FIG. 31D) shows a stable working point without a snap-in, when the spring constant of the spring(s) 30, 30A, 30B is high enough or the full stop close enough (x_stop<x_B) (such a full stop can also be damped to avoid noise). Particularly, said stop can be the surface of the magnet/EPM 807 or a mechanical stop.

FIG. 32 shows the different forces for a stable working point A, namely the force of the electropermanent magnet (EPM) 807 (or alternatively of an electromagnet) on the carrier 33 termed “Magnet force”, the force of the spring structure 30, 30A, 30B, denoted as “Spring force” as well as the spring energy, the energy of the spring and the EPM 807, as well as the net force, i.e. the difference between the magnet force and the spring force.

FIG. 33 shows a continuous tuning (by variable magnetization of the switchable second magnet 804 shown for the values 80%, 60%, 40%, 20%, 0% of a maximal value).

Here, lowering the remanent [or magnetic field strength of the tunable (e.g. semihard) second magnet 804 of the EPM 807 (e.g. by appropriate pulse shaping) will move the potential minimum (i.e. the working point) from the spring anchor towards the EPM's 807 surface.

Particularly, a spacer of appropriate thickness can provide a full stop to avoid movement beyond the maximum allowed working travel.

The confinement strength (i.e. the local curvature of the potential around the minimum point) decreases with increasing deflection. Close to the maximum travel, the minimum vanishes and snap-in occurs.

Particularly, it is to be noted concerning FIG. 33 that instead of an EPM also an electromagnet can be used as an actuator as described herein.

FIG. 34 illustrates a flip-flop/toggle operation of the carrier 33.

An Ideal operation is a non-contact toggle operation between state A3 and A4 (without energy losses, cycling along the spring potential energy). A contact toggle takes place between C1 and C2, where the carrier 33 hits the respective EPM 807, here denoted as EPM1 and EPM2.

Further, FIG. 35 illustrates a flip-flop/toggle operation cycle:
(1) both EPM1 and EPM2 807 off, spring(s) mechanically deflected to A3
(2) free oscillation from A3 to A4 (only damped by spring energy loss during the oscillations)
(3) switch EPM1 807 on when A3 is reached
(4) free oscillation around new minimum state A3′, (oscillation around A3′ occurs until all kinetic excess energy is dissipated). Depending on position accuracy the oscillations around A3′ can be suppressed by switching on the magnet (EPM1) when the spring system has no kinetic energy and the magnetic force is chosen such that a stable energy point occurs in A3; a further deacceleration to supress the kinetic energy can be supressed by inserting a short counter pulse when turning on EPM2 for a short while
(5) switch off EPM1 807, free oscillation from A3 to A4
(6) switch on EPM2 807 when A4 is reached
(7) free oscillation around new minimum state A4′ (oscillation around A4′ occurs until all kinetic excess energy is dissipated), see point (4).
(8) Switch off EPM 1, back to state A3,
(9) Repeat sequence

In order to apply voltage pulses to the coils of the electropermanent magnets 807, the latter comprise a voltage source Vin. Particularly, each electropermanent magnet comprises its own voltage source. However, also a common voltage source may be used.

According to FIG. 36, the voltage source Vin can be configured as a full H bridge driver. Here a positive current is generated in the coil 803, when the switches S1 and S4 are closed and S3 and S2 are open. Further, a negative current is generated in coil 803 when switches S1 and S4 are open, and switches S3, S2 are closed. An off-state can be realized by having switches S2 and S4 closed and by having switches S1 and S3 open.

Particularly, for each coil 803, 803a one H bridge is used.

Applying one or several capacitors in parallel to the voltage source Vin, the supply voltage can be buffered. This way, a limited voltage drop during a pulse can be guaranteed even with voltage sources that are only capable to deliver a fraction of the required pulse current. For example a DRV8872 Brushed DC Motor Driver implementing a Full H bridge driver can be used with the present invention.

FIG. 37 shows the switching of two coils 803, 803a. Since only one coil needs to be pulsed at one time, one half bridge can be used to drive a “bus”, and one half bridge for each coil, i.e., six switches S1, S2, S3_1, S4_1, S3_2, S4_2 suffice properly to drive the coils 803, 803a.

For example: A positive current in coil 803 is generated when switches S1, S4_1, 53_2 are closed, and switches S3_1, S4_2, S2 are open.

Further a positive current is generated in 803a when switches S1, S4_2, S3_1 are closed, and switches S3_2, S4_1, S2 are open.

An off state can be realized when switches S2, S4_1, S4_2 are closed, and switches S1, S3_1, S3_2 are open.

Particularly, as already described herein, the control signals for the switches Sₓ of the half or full bridge circuits can be generated by a control unit (e.g. microcontroller, DSP, PLD, FPGA, ASIC) which can generate the switching signal (pulse signal) using e.g. two timer output compare drivers (or PWM generator) per EPM, or one timer output compare driver per switch.

To reduce the number of output pins required on the control unit, a serial to parallel converter can be used

As shown in FIG. 38 using the voltage source Vin/control unit, the remnant magnetization of the respective EPM 807 (or 807a, 807aa, 807b, 807bb, see below) can be controlled by altering the length of the voltage pulses applied to the coil(s) 803 (803a), or alternatively by altering the voltage of these pulses while keeping the pulse length constant.

In this regard, FIG. 38 shows the generation of a remnant magnetization Mr of an electropermanent magnet 807 (EPM1) by means of voltage pulse 810a and the cancellation of the magnetization Mr by means of a further (inverted) voltage pulse 810a.

Since only one coil 803 at a time is not in the off-state, one controllable voltage source Vin would suffice. Such a programmable voltage source Vin could be implemented using a D/A converter, and a buffer op amp or a PWM voltage source.

Particularly, FIG. 39 shows the switching of two EPMs 807 denoted EPM1 and EPM2, wherein the upper two graphs show the respective voltage pulses 810a for generating the respective remnant magnetization Mr of the respective EPM which is shown in the third and fourth graph (from top to bottom). The lower graph “Tilt angle glass)(° or pixelshift (mm)” shows the resultant tilt of the carrier 33. It is to be noted that the switching between two stable states occurs when all remanent magnetizations are zero.

By tuning the respective pulse length p_{t-onEPM1}, p_{t-offEMP1}, p_{t-onEPM2}, p_{t-offEMP2} (e.g. smaller or equal to 10 microseconds, smaller or equal to 50 microseconds, smaller or equal to 150 microseconds or the current value smaller or equal to 0.5A, smaller or equal to 3A, smaller or equal to 10A, the magnetization Mr of the respective EPM (e.g. EPM1 or EPM2) can be tuned.

The pulse timing is used to clamp the carrier 33 at the holding position (stable state) when its velocity is zero and its kinetic energy is zero or close to the minima (at the turning points). See FIGS. 34 and 35.

Particularly, the frequency f of the device is smaller or equal to 45 Hz, smaller or equal to 50 Hz, smaller or equal to 60 Hz, or smaller or equal to 65 Hz whereas the period is given by T=1/f.

Further, in FIG. 39, tₘ₁ is the time<<on>> for EPM1, and tₘ₂ is the time<<on>> for EPM2. Further, t_{A} and t_{B} are the switching times of the carrier 33 (e.g. plate/gimbal) from one stable state to the other stable state.

During the switching time t_{A} or t_{B} additional short pulses can further accelerate or deaccelerate the spring system.

In FIG. 39, only two EPMs are shown. In case four EPMs are used, the two other ones are phase shifted by 90°.

Particularly, all times, e.g. t_{M1}, t_{M2}, T_{A}, t_{B}, p_{t-onEPM1}, p_{t-offEPM1}, p_{t-onEPM2}, p_{t-offEPM2} can be individually adjustable to tune the actuator means (e.g. the EPMs and interacting spring(s) 30, 30A, 30B.

Further, as indicated in FIG. 40, the individual current applied to a coil 803 (803a) can be shaped by altering the voltage correspondingly.

Particularly, different current levels in the coil 803 of an EPM result in different magnetic field values H to partially switch the EPM. The EPM can therefore be programmed (e.g. by setting a corresponding magnetization Mr in the <<on>> state) based on the magnetic field H_{c} of the coil 803 of the EPM.

Further, shaping the current of the switching pulses 810a applied to the coils 803 allows one to considerably reduce noise during operation of the device 1.

Particularly, noise reduction can be achieved by changing the voltage (cf. voltages a1, a2 of pulse 810a in FIG. 40A) to a lower value so as to have a slower current I increase, and/or by increasing the pulse length of the individual pulse 810a (cf. FIG. 40A)).

Further, as shown in FIG. 40B), using a PWM (pulse-width modulation) signal b to shape the current pulse also helps to reduce noise due to the resulting shape of the current I

Furthermore, using a counter pulse in the secondary coils 803a helps to avoid attraction during the actuation pulse that would normally lead to noise at the magnetic materials in the device 1. The pulse may be as long as the pulse length of pt-on (of EPM1, EPM2).

Furthermore, a current with an amplitude modulation that exhibits frequencies which are 180 degrees phase shifted to auditable noise on coil 803 and in particularly 803a to cancel out noise may also be applied. Particularly, the EPMs may be driven such that the excited device oscillations are damped out.

Apart from current shaping additional damping material (e.g. having visco-elastic behaviour, e.g. polyurethan, silicone, etc.) may be placed on ringing parts (e.g. damping tape, overmolded damping material, sprayed damping material, application of damping material by plunging, glueing etc.)

Furthermore, polymer material (particularly reinforced by glass, carbon fibre, or particles) with damping properties may be used for the base/support frame 51.

Further damping grommets can be used at mounting screws.

In order to control the switching of the EPMs position sensing may be conducted in order to determine the position of the carrier, particularly the tilting angle of the latter.

For this, the coil 803 or 803a or an additional coil can be used to measure an induced voltage or a current in the respective coil due to the moving carrier 33. Alternatively, a magnetic hall sensor may be used for position sensing.

Furthermore, also a microphone can be used for position sensing (such a microphone can also be used to sense if the device is still working and/or if the device is tuned) Particularly, If the device is not tuned it can hit the magnet or hard stop (instable), if the device is tuned nicely (correct timing of all pulses) the noise pattern will be lower and different. Due to the noise pattern the device could be tuned.

Further LED(s) (light emitting diodes) can be used to decide when to switch on the EPMs as well as for noise reduction. Furthermore, using LED(s) the amount of a pixel shift from one tilting position of the carrier to the other one can be controlled. This is advantageous since said pixel shift can vary with temperature, life cycle, material wear etc.

Furthermore, using a light source such as an LED, the gap distance (position) can be measured by measuring the amount of light (intensity) traveling through the respective gap G0, GOO, G1, G2, G3, G4.

Furthermore, in order to compensate temperature drifts, particularly of the holding/working points of the carrier 33, a temperature sensor may be placed on the device 1. Such a sensor can further be used to have a temperature dependent operation of the device.

A tuning of the tilting angle of the carrier at the position where the respective EPM holds the fix position (delta x)/working point can be done by:
readjusting the timing t_{A} and t_{B} (time of spring acceleration and deacceleration)
readjusting the magnetization Mr of the respective EPM (by changing the respective pulse length p_{t-onEPM1}, p_{t-onEPM2} or pulse voltage/current (see FIG. 39)
using an additional voice coil or coil (e.g. 803, 803a) for a fine tuning of the magnetic force (pulsed or continuous current) see FIG. 40 (current shaping), particularly
such an electronical tuning can avoid mechanical fine adjustment after assembly
alternatively, mechanical fine tuning in order to individually adjust the respective gap between the respective EPM and the carrier 33 can be done by screws

Further, regarding calibration the device may be adapted to a certain temperature and frequency. Particularly, the device 1 can have different working environments, namely different temperature states, different operation frequencies, different glass tilting angles (working points) for different optics and optical devices. The optical device 1 according to the invention can therefore comprise an EPROM/data storage device with stored correction values, which have been calibrated after production of the individual device.

Furthermore, FIG. 41 shows an embodiment of the optical device 1 according to the present invention comprising a first, a second, a third and a fourth electropermanent magnet 807a, 807aa, 807b, 807bb.

As before, the optical device 1 comprises a transparent plate member 55 configured for refracting a light beam L passing through the plate member 55 (see also above), a carrier 33 that is connected via two springs 30A to a support frame 51 comprising four arms 51a, 51aa, 51b, 51bb so that the carrier 33 can be tilted about a first axis 700 that is aligned with said springs 30A between said first and said second state with respect to said support frame 51. This causes the light beam L (or an image IM) to be shifted in a first direction, particularly by a fraction ΔP of a pixel, particularly by a half of a pixel. Particularly, the two springs 30A connect the carrier to opposing arms 51b, 51bb which are connected by parallel arms 51a, 51aa of the support frame 51. Each of said parallel arms, namely first arm 51a, and second arm 51aa has an electropermanent magnet 807a, 807aa mounted to it, which are denoted as first electropermanent magnet 807a and second electropermanent magnet 807aa.

Particularly, both electropermanent magnets 807a, 807aa comprise a magnetic flux guiding structure consisting of two elements 802 between which a first and a second magnet 805, 804 extend that are enclosed by a coil 803. These electropermanent magnets 807a, 807aa function as explicitly described above, see particularly FIGS. 30A) and 30B).

The two elements 802 of the respective electropermanent magnet 807a, 807aa face an associated magnetic flux guiding region 801a, 801aa of the first part 33A of the carrier 33, wherein the region 801a is arranged on top of the first arm 51a, while the other one (801aa) is arranged on the second arm 51aa. Thus two gaps G1 and G2 are formed between the elements 802 and the respective region 801a, 801aa, wherein the two electropermanent magnets 807a, 807aa can be controlled such that each gap G1; G2 can be minimized upon tilting the carrier 33 towards the respective electropermanent magnet 807a, 807aa against the action of the springs 30A, wherein the carrier 33 is held in each stable state (where the force of the respective electromagnetic magnet equals the counterforce provided by the springs 30A) by the respective electropermanent magnet 807a, 807aa such that the carrier does not contact the respective electropermanent magnet 807a, 807aa. Thus, the gaps G1, G2 never vanish completely.

Further as can be seen from FIG. 41, the carrier 33 comprises a first part 33A that is connected via said springs 30A to said support frame 51 (namely to the third and fourth arm 51b, 51bb) and a second part 33B that is connected via springs 30B to the first part 33A, so that the second part 33B can be tilted about a second axis 701 that runs perpendicular to the first axis 700 with respect to the first part 33A between a first and a second state of the second part 33B whereby particularly said light beam L (or a projected image IM) is shifted, particularly by a fraction ΔP′ of a pixel, particularly by a half of a pixel, along a second direction.

As can be inferred from FIG. 41, the transparent plate member 55 is rigidly mounted to the second part 33B of the carrier 33, wherein said second part 33B is configured to be bistable or tristable, too. Also for the second part 33B, the device 1 comprises two further electropermanent magnets 807b, 807bb, one of which is mounted to the third arm 50b while the other one is mounted to the opposing fourth arm 51bb.

Also here, the third electropermanent magnet 807b and the fourth electropermanent magnet 807bb each comprise a magnetic flux guiding structure consisting of two elements 802 between which a first and a second magnet 805, 804 extend that are enclosed by a coil 803. Here, particularly the two elements 802 comprise a curved shape so that a face side of the respective element 802 faces an associated magnetic flux guiding region 801b, 801bb of the second part 33B of the carrier 33 and forms a gap G3, G4 with the respective region 801b, 801bb when the elements 802 are mounted to the associated third and fourth arm 51b, 51bb from below. The two elements 802 can be connected by a bar 825 to mechanically strengthen this assembly.

Also these electropermanent magnets 807b, 807bb function as explicitly described above, see particularly FIGS. 30A) and 30B).

Thus the device 1 according to FIG. 41 is capable of tilting a single transparent plate member 55 (e.g. glass) in two dimensions using the springs 30A, 30B via which the first and the second part 33A, 33B of the carrier 33 are elastically supported on the frame member 51 and four electropermanent magnets 807a, 807aa, 807b, 807bb

Furthermore the distance 819 (cf. FIG. 31A)) between the respective electropermanent magnet 807a, 807aa, 807b, 807bb and the associated magnetic flux guiding region 801a, 801aa, 801b, 801bb can be adjusted by a mechanical system (e.g. by means of adjustment screws). Further, this gap can be adjusted by using spacers or screws 827 at the base 51 of the carrier 33, which allow the tilting of the base of the carrier 33.

Further, the tilting angle can be adjusted via the screws 827.

Furthermore, the carrier 33 comprises a clamp 822 for the plate member (e.g. glass 55) that is configured to support all four edges of the plate member 55 (in addition glue can be applied).

Furthermore, washers 823 can be used to have a constant force on the grommets 76 so that the damping material is not compressed too much.

Further, the grommets 76 can be used for damping and are received in recesses in the support frame 51.

To help in the assembly process the mounting part 826 can be used that comprises stents 829 to assist in mounting the individual components. Particularly, the stents 829 and washers 823 serve for having a constant force acting via the grommets onto the housing/support frame 51. The grommets 76 are thus clamped on either side of the respective recess with equal forces.

FIG. 42 shows a further embodiment of an optical device 1 according to the invention. Here, the device 1 comprises two carriers 33 and 333 stacked on top of one another, wherein each carrier 33, 333 carries a transparent plate member 55.

Particularly, the upper carrier 33 is connected to an upper side of a support frame 51 by two opposing springs 30 which are aligned with a first rotation axis 700 about which the carrier 33 can be tilted with respect to the support frame 51. Particularly, the two springs 30 connect the carrier 33 to opposing arms 51b, 51bb which are connected by parallel arms 51a, 51aa of the support frame 51. Each of said parallel arms, namely first arm 51a, and second arm 51aa has an electropermanent magnet 807a, 807aa mounted to it, which are denoted as first electropermanent magnet 807a and second electropermanent magnet 807aa.

Particularly, both electropermanent magnets 807a, 807aa comprise a magnetic flux guiding structure consisting of two elements 802 between which a first and a second magnet 805, 804 extend that are enclosed by a coil 803. These electropermanent magnets 807a, 807aa function as explicitly described above, see particularly FIGS. 30A) and 30B).

The two elements 802 of the respective electropermanent magnet 807a, 807aa face an associated magnetic flux guiding region 801a, 801aa, one of which is provided on the first arm 51a, the other one on the second arm 51aa. Thus two gaps G1 and G2 are formed, wherein the two electropermanent magnets 807a, 807aa can be controlled such that each gap can be minimized upon tilting the carrier 33 towards the respective electropermanent magnet 807a, 807aa against the action of the springs 30A, wherein the carrier 33 is held in each stable state (where the force of the respective electromagnetic magnet equals the counterforce provided by the springs 30A) by the respective electropermanent magnet 807a, 807aa such that the carrier 33 does not contact the respective electropermanent magnet 807a, 807aa. Thus, the gaps G1, G2 never vanish completely.

By means of the upper carrier, the light beam L can be shifted in a first direction. In order to also accomplish a shift in a different second direction, the further carrier 333 is connected via springs 30 to the bottom side of the support frame 51 so that the further carrier can be tilted about a second rotation axis 701 that extends orthogonal to the first axis 700, wherein also here the two springs 30 are aligned with the second rotation axis 701.

Here, particularly the two springs 30 are connected to the bottom side of the first and the second arm 51a, 51aa of the support frame 51

Also for the further carrier 333, the device 1 comprises two further electropermanent magnets 807b, 807bb, one of which is mounted to the third arm 51b while the other one is mounted to the opposing fourth arm 51bb.

Also here, the third electropermanent magnet 807b and the fourth electropermanent magnet 807bb each comprise a magnetic flux guiding structure consisting of two elements 802 between which a first and a second magnet 805, 804 extend that are enclosed by a coil 803. In turn, the two elements 802 form a gap G3, G4 with the respective magnetic flux guiding region 801b, 801bb of the further carrier 333.

Also these electropermanent magnets 807b, 807bb function as explicitly described above, see particularly FIGS. 30A) and 30B).

Thus the device 1 according to FIG. 42 is capable of tilting a two stacked transparent plate members 55, 555 (e.g. glasses) in one dimension about different axis 700, 701 using the springs 30 via which the carriers 33, 333 are elastically supported on the frame member 51 and four electropermanent magnets 807a, 807aa, 807b, 807bb

Also here, said distance 819 (see above), i.e. the height of the gaps G1, G2, G3, G4 in the respective stable position can be adjusted by a mechanical system (e.g. screws). The spacer 820 is particularly used to adjust the height of the carrier 33 and correct tilt errors.

Further the elements 802 of the magnetic flux guiding structure can be held by a holding structure 821 that can have soft magnetic properties and can thus also be used as an extension of elements 802.

Finally, according to FIG. 43 also a more simple two-way device 1 can be configured using two diagonally arranged electropermanent magnets 801a, 801aa which are arranged at opposing corner regions of the carrier 33/transparent plate member 55

Here the rotation/titling axis extends diagonally along the carrier 33 between the two electropermanent magnets 807a, 807aa. Also here the carrier can be supported on springs which load the carrier against the action of the holding forces of the respective electropermanent magnet 807a, 807aa.

Finally, FIG. 44 shows an embodiment that particularly corresponds to the configuration shown in FIG. 43.

Also here, the optical device 1 comprises a transparent plate member 55 configured for refracting a light beam L passing through the plate member 55 (see also above), a carrier 33 that is connected via two springs 30 to a support frame 51 comprising four arms 51a, 51aa, 51b, 51bb so that the carrier 33 can be tilted about a first axis 700 that runs diagonally with respect to the support frame 51. Particularly, the first arm 51a is arranged opposite a second arm 51aa of the support frame 51, wherein these two arms are connected by two parallel arms 51b, 51bb, namely a third arm 51b and a fourth arm 51bb.

Again, due to the tiling of the carrier 33—which as before in FIGS. 41 to 42 forms itself a frame that holds the plate member 55—the light beam L (or an image IM) impinging on the plate member 55 is shifted in a first direction, particularly by a fraction ΔP of a pixel, particularly by a half of a pixel.

Particularly, the integral springs 30 of the carrier 33 connect the carrier 33 to a corner region of the support frame 51, respectively, namely to a first corner region at which the first arm 51a and the fourth arm 51b meet, as well as to a second corner region at which the third arm 51b and the second arm 51aa meet. Correspondingly, the rotation axis 700 about which the carrier 33 and thus the plate member 55 can be tilted between two stable states extends from said first corner region to the second corner region of the support frame 51.

Furthermore, the support frame comprises a third corner region, namely where the first arm 51a and the third arm 51b meet, and a fourth corner region at which the second arm 51aa and the fourth arm 51bb meet. Now, for holding the carrier in the respective stable state in which the carrier 33 is tilted about axis by a pre-defined amount a first electropermanent magnet 807a is arranged at said third corner region while a second electropermanent magnet 807aa is arranged at the fourth corner region, i.e. diametrically with respect to the first electropermanent magnet 807a. The second electropermanent magnet 807aa allows to hold the carrier 33 in the other stable state.

Particularly, both electropermanent magnets 807a, 807aa comprise a magnetic flux guiding structure consisting of two elements 802 between which a first and a second magnet 805, 804 extend that are enclosed by a coil 803. These electropermanent magnets 807a, 807aa function as explicitly described above, see particularly FIGS. 30A) and 30B).

The two elements 802 of the respective electropermanent magnet 807a, 807aa face an associated magnetic flux guiding region 801a, 801aa, which are corner regions of the carrier 33, too (cf. FIG. 44).

Thus two gaps G1 and G2 are formed between said elements 802 and the associated region 801a, 801aa of the carrier 33, wherein the two electropermanent magnets 807a, 807aa can be controlled such that each gap G1; G2 can be minimized upon tilting the carrier 33 towards the respective electropermanent magnet 807a, 807aa against the action of the integral springs 30 of the carrier 33, wherein the carrier 33 is held in each stable state (where the force of the respective electromagnetic magnet equals the counterforce provided by the springs) by the respective electropermanent magnet 807a, 807aa such that the carrier 33 does not contact the respective electropermanent magnet 807a, 807aa. Thus, the gaps G1, G2 never vanish completely.

Further, as before, electrical connection to the device 1 can be made via the connector 81 shown in FIGS. 41, 42, and 44, particularly via a flexible cable.

Further, various mounting screws are denoted as 828 in FIGS. 41, 42, and 44.

Particularly, in the embodiments described in conjunction with FIGS. 41 to 44 the additional coil 803a described above can be used to create a second electromagnetic field to fine tune the total resulting field. Furthermore this coil 803a can be used for sensing purposes.

According to yet another embodiment of the present invention, the optical device 1 may comprises an actuator means 66 as shown in FIG. 45 that comprises at least one electromagnet 808 that forms a gap G0 with a magnetic flux guiding region 801 of the carrier 33 for holding the carrier 33 in one of the stable states by exerting a reluctance force 102A on said magnetic flux guiding region 801 of the carrier 33, wherein particularly in said stable state said reluctance force 102A balances a counterforce 110A acting on the carrier 33, particularly, such that the electromagnet 808 does not contact said magnetic flux guiding region 801, and particularly such that when the reluctance force is turned off the carrier 33 is moved to the other stable state by means of said counterforce 100A. Here, the counterforce may be provided by a spring structure 300 comprised by the carrier 30, which spring structure 300 will be described further below.

Particularly, the electromagnet 808 forms a clamping means and also defines—together with the counterforce—a supporting point 61A. The supporting points 61A or actuators 808 (e.g, 808a, 808aa, 808b, 808bb) can be positioned as described in conjunction with FIG. 13A to 13G, i.e. at the points 61A. Particularly, in case of a reluctance actuator, the latter merely generates attractive forces and thus forms a clamping means (e.g. at positions 661 in FIGS. 13A to 13G). By turning a corresponding (holding current) off, the respective reluctance actuator releases the carrier and can thus also be considered to form a disengaging means.

In all embodiments described further below, the electromagnet/actuator 808 (together with the magnetic flux guiding region 801) can also be replaced by a voice coil motor 815 as shown in FIG. 71. Here, the voice coil motor comprises a coil 811 and an associated magnetic structure 812 comprising two permanent magnets 812a, 812b arranged on top of one another or two (e.g. integrally connected) sections 812a, 812b arranged on top of one another (here the magnetic structure is a single permanent magnet 812). The magnets/sections 812a, 812b each comprise a magnetization (e.g. N S or S N, cf. FIG. 71), wherein the two magnetizations are anti-parallel. Further, particularly, the magnetic structure 812 is connected to the carrier 33, and wherein the coil 811 is connected to a support frame 51. Particularly, the coil 811 comprises an electrical conductor wound about a coil axis to form said coil 811, wherein the coil axis extends parallel to the magnetizations of the sections 812a, 812b or magnets 812a, 812b. Furthermore, particularly, a magnetic flux return structure 812c is arranged on a side of the magnetic structure 812 that faces away from the coil 811, wherein the magnetic flux return structure 812c connects the two magnets/sections 812a, 812b to one another for guiding magnetic flux from one magnet/section 812a to the other magnet/section 812b. Particularly, the magnetic flux return structure is formed out of a soft magnetic material, particularly a ferromagnetic material.

Thus, applying a suitable electrical current to the coil 811, a Lorentz force is generated that tilts the carrier 33 downwards in FIG. 71. Particularly, the voice coil motor 815 is configured to hold the carrier 33 in the respective stable state by means of said Lorentz force, which particularly balances a counterforce acting on the carrier 33 such that the carrier preferably does not contact a mechanical stop. Further, in case the Lorentz force is turned off, the carrier is moved to the other stable state by means of said counterforce.

Particularly, the voice coil actuator 815 forms a clamping means (661) and a disengaging (662) means and also defines—together with the counterforce—a supporting point 61A. The actuators 815 can be positioned as described in conjunction with FIG. 13A to 13G at 661 or 662 or supporting points 61A (when the actuator forms a stop together with the counterforce).

Further, FIGS. 46 to 49 and show a further embodiment of an optical device 1 according to the present invention that may employ actuators 808 or 815 as described above.

Here, the optical device 1 also comprises a carrier 33 that is connected via springs 30A (e.g. in the form of two first torsion bars 30A) to a support frame 51 so that the carrier 33 can be tilted about a first axis 700 between a first and said second state with respect to said support frame 51. A light beam L incident on the plate member 55 as shown in FIG. 46 can therefore be shifted (e.g. on an image sensor arranged below the optical device in FIG. 46) as described herein.

Furthermore, the carrier 33 comprises a first part 33A that is connected via said springs 30A to said support frame 51 and a second part 33B that is connected via springs 30B (e.g. in the form of two second torsion bars) to the first part 33A, so that the second part 33B can be tilted about a second axis 701 with respect to the first part 33A between a first and a second state of the second part 33B whereby particularly said light beam L is shifted. Particularly, the transparent plate member 55 is rigidly mounted to the second part 33B of the carrier 33, wherein said second part 33B is configured to be bistable or tristable, too, and wherein said first and said second state of the second part 33B are stable states of the bistable or tristable second part 33.

Furthermore, for providing said counterforce, the carrier 33 particularly comprises an (e.g. one-piece) spring structure 300, that comprises an outer (e.g. rectangular) frame 301, wherein said springs 30A that connect the carrier 33 to the support frame 51 are integrally connected to the outer frame 301 of the spring structure 300.

Further, said springs 30A are preferably formed by two first torsion bars 30A, wherein one first torsion bar 30A protrudes from a first arm 301a of the outer frame 301 of the spring structure 300 while the other first torsion bar 30A protrudes from a second arm 301aa of the outer frame 301 of the spring structure 300. Particularly, the second arm 301aa opposes the first arm 301a of the outer frame 301 of the spring structure 300. Furthermore, said first torsion bars 30A are aligned with each other and define said first axis 700. More specifically, said first and said second arm 301a, 301aa of the outer frame 301 extend parallel to one another and particularly perpendicular to the first axis 700. Particularly, said first and said second arm 301a, 301aa are integrally connected by a third arm 301b and a fourth arm 301bb of the outer frame 301 of the spring structure 300. Particularly, also the third and the fourth arm extend parallel to one another.

As shown in FIG. 53 in more detail the spring structure 300 can further comprise an inner frame 302, wherein the outer frame 301 surrounds the inner frame 302, and wherein said springs 30B that connect the second part 33B of the carrier 33 to the first part 33A of the carrier 33 integrally connect the inner frame 302 of the spring structure 300 to the outer frame 301 of the spring structure 300.

Preferably, said springs 30B are formed by two second torsion bars 30B, wherein one second torsion bar 30B extends from a first arm 302a of the inner frame 302 of the spring structure 300 to the third arm 301b of the outer frame 301 of the spring structure 300, while the other second torsion bar 30B extends from a second arm 302aa of the inner frame 302 of the spring structure 300 to the fourth arm 301bb of the outer frame 301 of the spring structure 300. Particularly, also the second torsion bars 30B are aligned with each other and define said second axis 701. Furthermore, particularly, the first and the second arm 302a, 302aa of the inner frame 302 of the spring structure 300 are integrally connected by a third arm 302b and by a fourth arm 302bb of the inner frame 302 of the spring structure 300, wherein the third arm 302b of the inner frame 302 of the spring structure 300 opposes the fourth arm 302bb of the inner frame 302 of the spring structure 300.

Particularly, also here, said first and said second arm 302a, 302aa of the inner frame 302 of the spring structure 300 extend parallel and particularly perpendicular to the second axis 701. Particularly, also the third and the fourth arm 302b, 302bb of the inner frame 302 of the spring structure 300 extend parallel to one another.

Furthermore, particularly, the first arm 301a of the outer frame 301 of the spring structure extends along the third arm 302b of the inner frame 302 of the spring structure 300, the second arm 301aa of the outer frame 301 of the spring structure 300 extends along the fourth arm 302bb of the inner frame 302 of the spring structure 300, the third arm 301b of the outer frame 301 of the spring structure 300 extends along the first arm 302a of the inner frame 302 of the spring structure 300, and the fourth arm 301bb of the outer frame 301 of the spring structure 300 extends along the second arm 302aa of the inner frame 302 of the spring structure.

Particularly, the entire spring structure 300 as comprising inner and outer frame 302, 302 as well as the first and second torsion bars 30A, 30B as shown in FIG. 53 is formed as a flat plate member that is formed in one piece.

Furthermore, for fastening the spring structure 300 to the support frame 51, each first torsion bar 30A is integrally connected to a fastening region 303, 304, wherein the carrier 33 is connected via said fastening regions 303, 304 to the support frame 51.

Particularly, one of said fastening regions 303 comprises elongated holes 303a for mounting this fastening region 303 to the support frame (51). Further, the other fastening region 304 may comprises a marker 307, e.g. in form of a recess at an edge of the fastening region for identifying the orientation of the spring structure 300 when mounting the latter to the support frame 51.

Particularly, the other fastening region 304 comprising the marker 307 may comprise circular holes 304a for mounting this fastening region 304 to the support frame 51.

Particularly, the fastening regions 303, 304 are fastened to the support frame 51 using screws 306 (cf. FIG. 48) that extend through said holes 303a, 304a. Due to the elongated holes 303a stress can be minimized when mounting the fastening regions 303, 304 to the support frame 51.

Furthermore, as shown in FIGS. 48, 54 to 57 the carrier 33 comprises a reinforcing structure 310 to stabilize the spring structure 300. For this, the reinforcing structure 310 is connected to the spring structure 300, particularly so as to increase rigidity and stiffness of the outer and inner frame 301, 302 of the spring structure 300 and particularly also to reduce noise generated by the optical device during operation/tilting of the carrier 33.

In detail, the reinforcing structure 310 comprises an outer reinforcing frame 311 and an inner reinforcing frame 312, wherein the inner reinforcing frame 312 is connected to the inner frame 302 of the spring structure 300, and wherein the outer reinforcing frame 311 is connected to the outer frame 301 of the spring structure 300.

Particularly, the plate member 55 is preferably mounted to the second part 33B of the carrier by providing a glue connection GC between the plate member 55 and wings 96 that protrude from the inner reinforcing frame 312 as shown in FIG. 47.

Particularly, as shown in FIG. 54, the outer reinforcing frame 311 comprises a first arm 311a and an opposing second arm 311aa, wherein the first and the second arm 311a, 311aa of the outer reinforcing frame 311 are connected by a third and a fourth arm 311b, 311bb of the outer reinforcing frame 311.

Likewise, the inner reinforcing frame 312 comprises a first arm 312a and an opposing second arm 312aa, wherein the first and the second arm 312a, 312aa of the inner reinforcing frame 312 are connected by a third and a fourth arm 312b, 312bb of the inner reinforcing frame 312.

Furthermore, the reinforcing structure, e.g. the inner and outer reinforcing frame 312, 311, preferably comprises bendings 313, 314 (e.g. at the arms 311a, 311aa, 311b, 311bb of the outer reinforcing frame 311 and at the arms 312a, 312aa, 312b, 312bb of the inner reinforcing frame 312) in order to increase stiffness of the reinforcing structure.

Particularly, such a bending is formed by an angled section 313, 314 of the outer or inner reinforcing frame 311, 312 (cf. FIGS. 54 and 55). The individual angled section 313, 314 comprises a height H, H′ which is significantly larger than the thickness B, B′ of the respective angled section 313, 314 (the thickness B, B′ may correspond to the thickness of the respective metal sheet out of which the respective frame 311, 312 can be formed).

Due to these bendings 313, 314, the reinforcing structure can be formed out of a thin metal sheet having a small mass. Particularly, as indicated for the second arm 311b of the outer reinforcing frame 311 in FIG. 54 a high stiffness is achieved in y-direction due to a high 2nd moment of inertia Iy=(B*H³)/12, wherein B indicated the metal sheet thickness/thickness of the angled section 313, and wherein H denotes the height of the angled section.

Regarding a connection between the reinforcing structure 310 and the spring structure (cf. FIG. 54), which can be accomplished by glueing or welding or any other suitable connecting technique, a top side of the first arm 311a of the outer reinforcing frame 311 is preferably connected to a bottom side of the first arm 301a of the outer frame 301 of the spring structure 300, and wherein a top side of the second arm 311aa of the outer reinforcing frame 311 is preferably connected to a bottom side the second arm 301aa of the outer frame 301 of the spring structure 300, and wherein a top side of the third arm 311b of the outer reinforcing frame 311 is preferably connected to a bottom side of the third arm 301b of the outer frame 301 of the spring structure 300, and wherein a top side of the fourth arm 311bb of the outer reinforcing frame 311 is preferably connected to a bottom side of the fourth arm 301bb of the outer frame 301 of the spring structure 300.

In the same manner, a top side of the first arm 312a of the inner reinforcing frame 312 is preferably connected to a bottom side of the first arm 302a of the inner frame 302 of the spring structure 300, and wherein a top side of the second arm 312aa of the inner reinforcing frame 312 is preferably connected to a bottom side of the second arm 302aa of the inner frame 302 of the spring structure 300, and wherein a top side of the third arm 312b of the inner reinforcing frame 312 is preferably connected to a bottom side of the third arm 302b of the inner frame 302 of the spring structure 300, and wherein a top side of the fourth arm 312bb of the inner reinforcing frame 312 is preferably connected to a bottom side of the fourth arm 302bb of the inner frame 302 of the spring structure 300.

Furthermore, according to an embodiment shown in FIG. 56, an inner edge 311c of the outer reinforcing frame 311 can comprise recesses 311d for welding the outer reinforcing frame 311 to the outer frame 301 of the spring structure 300.

Likewise, an outer edge 312c of the inner reinforcing frame 312 can comprise recesses 312d for welding the inner reinforcing frame 312 to the inner frame 302 of the spring structure 300.

Alternatively, as shown in FIG. 57, said inner and outer edges 311c, 312c can also be straight and a distance of the outer edge 312c of inner reinforcing frame 312 to the inner edge 311c of the outer reinforcing frame 311 is chosen such that a welding seam fits into a gap between said inner and outer edge 311c, 312c.

Furthermore, as indicated in FIG. 57, an inner edge 311c of the outer reinforcing frame 311 may comprise two opposing recesses 311e for avoiding a contact between the first torsion bars 30A and the outer reinforcing frame 311. Here, the torsion bars 30A are arranged in the vicinity of said recesses 311e which provide a play between the first torsion bars 30A and the outer reinforcing frame 311.

Furthermore, as indicated in FIGS. 56 and 58, for determining the spatial position of the plate member 55, the optical device 1 comprises at least one Hall sensor 90 connected to the support frame 51, which Hall sensor 90 is configured to sense a magnetic field generated by a permanent magnet 91 of the optical device 1, wherein the at least one Hall sensor 90 faces said magnet 91.

Particularly the Hall sensor 90 can be arranged on a printed circuit board 94 that is connected to the support frame 51. Possible embodiments of the printed circuit board 94 are shown in FIGS. 59 to 61. According to FIG. 59 the PCB 94 comprises a central opening 94c which is aligned with the plate member 55 so that light can pass through the printed circuit board 94 (via said central opening 94c). The PCB 94 can comprise solder pads 94a that can be aligned diagonally or parallel to each other to optimize the solderability. Furthermore, all solder pads 94a can have the same relative distance to each other to optimize the process for automation.

The PCB 94 may further comprise alignment features 94b (e.g. for pins). Corresponding alignment features can be provided on the support frame 51 in order to have a defined position between the support frame 51 and the PCB 94. At least one of the alignment features 94b can be formed as an elongated hole to account for tolerances in the parts.

Furthermore, as shown in FIGS. 60 and 61, the PCB 94 can have different shapes and sizes to minimize the machining costs and size. Particularly, the PCB 94 can be made out of FR4, rigid flex, flex with stiffener, flex.

Particularly, as shown in FIGS. 60 and 61 out of the same PCB 94 (comprising parts 94′, 94″) two PCBs for two devices can be fabricated by changing the PCB shape (e.g. by using only the right hand part 94′ as indicated in FIG. 61.

Furthermore, FIG. 62 shows a pattern of electrical connectors/pads 94h that may be arranged on the printed circuit board 94, in particular vias on the PCB 94, to quickly connect the device 1 with electrical test pins (such as pogo pins); this saves time to test the PCB 94 in beforehand and the device 1 during calibration.

Preferably, the above-described Hall sensor(s) 90 is/are integrated onto the PCB 94 that is connected to the support frame 51. Thus, when the plate member 55 is tilted the magnet 91 moves with respect to the Hall sensor 90 and the Hall sensor 90 generates an output signal that can be used as a feedback signal in a closed-loop control of an actuator (e.g. 808a, 808aa, 808b, 808bb) that tilts the plate member 55 (e.g. so that the feedback signal approaches a desired reference value).

Particularly, for mounting the respective permanent magnet 91 to the inner reinforcing frame 312, the latter comprises a corresponding numbers of wings 92 protruding from the third and/or from the fourth arm 312b, 312bb of the inner reinforcing frame 312, wherein the respective magnet 91 is arranged on its associated wing as shown in FIG. 58 for a single magnet 91.

Particularly, the optical device 1 may comprise four Hall sensors 90 for determining the spatial position of the plate member 55 which Hall sensors 90 are connected to the support frame 51 via the PCB 94. Particularly, each of these Hall sensors 90 is configured to sense a magnetic field generated by the associated magnet 91 of the optical device 1, wherein the respective Hall sensor 90 faces the respective associated magnet 91 as shown in FIG. 85. Here, particularly, the inner reinforcing frame 312 comprises four wings 92, wherein each of said magnets 91 is connected to an associated wing 92 (of said four wings). Particularly, there are two opposing wings 92 protruding from the third arm 312b of the inner reinforcing frame 312 as well as two opposing wings 92 protruding from the fourth arm 312bb of the inner reinforcing frame 312. Particularly, as shown e.g. in FIG. 56 each of these two wings 92 protrudes from an end section of the third arm 312b of the inner reinforcing frame 312, wherein particularly the third arm 312b is connected via one of these end sections to the first arm 312a of the inner reinforcing frame 312, and wherein particularly the third arm 312b is connected via the other end section to the second arm 312aa of the inner reinforcing frame 312. Further, particularly, each of the two other opposing wings 92 protrude from an end section of the fourth arm 312bb of the inner reinforcing frame 312, wherein particularly the fourth arm 312bb is connected via one of these end sections to the first arm 312a of the inner reinforcing frame 312, and wherein particularly the fourth arm 312bb is connected via the other end section to the second arm 312aa of the inner reinforcing frame 312.

Different possible designs of the support frame 51 that supports the carrier 33 (with its spring structure 300 and reinforcing structure 310) and also holds the PCB 94 are particularly shown in FIGS. 50 to 52.

According thereto the support frame 51 comprises a first arm 51a and an opposing second arm 51aa, wherein the first and the second arm 51a, 51aa are connected by a third and a fourth arm 51b, 51bb of the support frame 51, and wherein one of said fastening regions 303 of the spring structure 300 (cf. FIG. 53) is connected to the first arm 51a while the other fastening region 304 of the spring structure 300 (cf. FIG. 53) is connected to the second arm 51aa of the support frame 51.

Furthermore, as shown in FIG. 50 and FIG. 51, the third and the fourth arm 51b, 51bb of the support frame 51 may each comprise an elongated opening 51c for increasing the field of view of light incident on the optical device 1. Alternatively, as shown in FIG. 52 these openings may also be omitted.

Furthermore, as shown in FIGS. 50 and 52, the first arm 51a of the support frame 51 and the second arm 51aa of the support frame 51 each comprise a bulge 51d on which the respective fastening region 303, 304 is mounted.

Alternatively, as shown in FIG. 51, each of the fastening regions 303, 304 can be mounted via an intermediate plate 51e to the associated first or second arm 51a, 51aa of the support frame 51.

Further, as indicated in FIGS. 50 to 52, the support frame 51 may comprise four legs 98 for mounting the support frame 51 to a further part, wherein two opposing legs 98 protrude from the first arm 51a of the support frame 51, and wherein two further opposing legs 98 protrude from the second arm 51aa of the support frame 51.

Particularly, each leg 98 protrudes from an associated end section of the respective arm 51a, 51aa.

Furthermore, particularly, each leg 98 comprises a mounting portion 98a for mounting the support frame 51 to said further part and a bridge portion 98b integrally connected to the mounting portion 98a, wherein the mounting portion 98a is connected to the support frame 51 via the bridge portion 98b, wherein the bridge portion 98b comprises a width that is smaller than a width of the mounting portion 98a so that the respective leg 98 can elastically flex with respect to the respective arm 51a, 51aa of the support frame 51 for noise decoupling and/or mechanic stress release upon mounting of the support frame 51 to said further part.

Furthermore, each mounting portion 98a comprises a recess 98c for receiving a grommet 99 through which a screw may extend for fastening the respective mounting portion 98a to a further part using said screw.

Furthermore, according to the embodiment shown in FIG. 49, the optical device 1 may comprise one or two opposing mass bodies 95, wherein the respective mass body is mounted on the support frame 51. Due to the at least one mass body 95 the moment of inertia of the support frame 51 can be increased which improves stability of the optical device 1.

In order to initiate transitions between the respective stable states, the optical device 1 may comprise an actuator means 66 comprising four individual actuators 808a, 808aa, 808b, 808bb as shown in FIGS. 46 and 48 in more detail.

Particularly, the optical device 1 comprises a first electromagnet 808a that forms a first gap G1 with a first magnetic flux guiding region 801a of the carrier 33 for holding the carrier 33 in the first stable state by exerting a reluctance force on said first magnetic flux guiding region 801a of the carrier 33. Particularly, in said first stable state said reluctance force balances a counterforce that acts on the carrier 33 such that the first electromagnet 808a does not contact said first magnetic flux guiding region 801a, and particularly such that when the reluctance force is turned off, the carrier 33 is moved to the second stable state by means of said counterforce.

Particularly, the first magnetic flux guiding region 801a protrudes from the third arm 301b of the outer frame 301 of the spring structure 300 and is particularly integrally connected to said third arm 301b.

Further, a second electromagnet 808aa is provided that forms a second gap G2 with a second magnetic flux guiding region 801aa of the carrier 33 for holding the carrier 33 in the second stable state by exerting a reluctance force on said second magnetic flux guiding region 801aa of the carrier 33, wherein particularly in said second stable state said reluctance force balances a counterforce that acts on the carrier 33 such that the second electromagnet 808aa does not contact said second magnetic flux guiding region 801aa, and particularly such that when the reluctance force is turned off, the carrier 33 is moved to the first stable state by means of said counterforce. Particularly, the second magnetic flux guiding region 801aa protrudes from the fourth arm 301bb of the outer frame 301 of the spring structure 300 and is particularly integrally connected to said fourth arm 301bb.

Thus, using the first and the second electromagnet 801a, 801aa, the carrier 33, particularly the first part 33A, can be tilted about the first axis 700 that is defined by the two aligned first torsion bars 30A. The respective counterforce is provided by the first torsion bars 30A and builds up when the first part 33A is tilted about the first axis 700.

In order to independently tilt the second part 33B of the carrier 33 about the second axis 701 defined by the two aligned second torsion bars 30B, the optical device 1 comprises a third and a fourth electromagnet 808b, 808bb.

Particularly, the third electromagnet 808b forms a third gap G3 with a third magnetic flux guiding region 801b of the second part 33B of the carrier 33 for holding the second part 33B of the carrier 33 in its first stable state by exerting a reluctance force on said third magnetic flux guiding region of the second part 33B of the carrier 33, wherein particularly in said first stable state said reluctance force balances a counterforce that acts on the second part 33B of the carrier 33 such that the third electromagnet 808b does not contact said third magnetic flux guiding region 801b, and particularly such that when the reluctance force is turned off, the second part 33B of the carrier 33 is moved to its second stable state by means of said counterforce. Particularly, the third magnetic flux guiding region 801b protrudes from the third arm 302b of the inner frame 302 of the spring structure 300 and is particularly integrally connected to said third arm 302b.

Furthermore, the fourth electromagnet 808bb forms a fourth gap G4 with a fourth magnetic flux guiding region 801bb of the second part 33B of the carrier 33 for holding the second part 33B of the carrier in the second stable state by exerting a reluctance force on said fourth magnetic flux guiding region 801bb of the second part 33B of the carrier 33, wherein particularly in said second stable state said reluctance force balances a counterforce that acts on the second part 33B of the carrier 33 such that the fourth electromagnet 808bb does not contact said fourth magnetic flux guiding region 801bb, and particularly such that when the reluctance force is turned off, the second part 33B of the carrier 33 is moved to its first stable state by means of said counterforce. Particularly, the fourth magnetic flux guiding region 801bb protrudes from the fourth arm 302bb of the inner frame 302 of the spring structure 300 and is particularly integrally connected to said fourth arm 302bb. Also here, the respective counterforce is provided by the second torsion bars and builds up when the second part 33B of the carrier 33 is tilted about the second axis 701.

Particularly the respective counterforce and the respective reluctance force are always dimensioned such that the respective gap G1, G2, G3, G4 is prevented from being closed completely, so as to prevent a snap-in of the respective actuator 808a, 808aa, 808b, 808bb to the associated magnetic flux guiding region 801a, 801aa, 801b, 801bb.

In the embodiment described above, each individual actuator/electromagnet 808a, 808aa, 808b, 808bb comprises an electrically conducting coil 813 that is wound around a coil core 814 (that is preferably formed out of a magnetically soft material), which coil core 814 comprises two opposing end sections 814a, 814b forming a pole shoe, respectively. Particularly said gaps G1, G2, G3, G4 are formed by said end sections 814a, 814b and the associated magnetic flux guiding region 801a, 801aa, 801b, 801bb.

As particularly shown in FIG. 46, the respective coil core 814 is connected to the support frame 51, wherein particularly the respective coil core 814 is glued to the support frame 51.

Particularly, cf. also FIGS. 48 and 50 to 52, the coil core 814 of the first electromagnet 808a is connected to the third arm 51b of the support frame 51, particularly to a wing 97 protruding from the third arm 51b. Further, particularly, the coil core 814 of the second electromagnet 808aa is connected to the fourth arm 51bb of the support frame 51, particularly to a wing 97 protruding from the fourth arm 51bb. Further, particularly, the coil core 814 of the third electromagnet 808b is connected to the first arm 51a of the support frame 51, particularly to a wing 97 protruding from the first arm 51a. Furthermore, particularly, the coil core 814 of the fourth electromagnet 808bb is connected to the second arm 51aa of the support frame 51, particularly to a wing 97 protruding from the second arm 51aa.

Furthermore, as indicated in FIG. 46 a glue connection GC can be provided merely to the end sections 814a, 814b of the respective coil core 814 or to an entire bottom side of the respective electromagnet 808a, 808aa, 808b, 808bb, i.e. to end sections 814a, 814b and coil 813, wherein particularly a gap between the coil core 814 and the support frame 51, particularly the respective wing 97, is smaller than 300 μm.

Particularly, the glue connection GC preferably comprises a high heat conductivity (e.g. larger than 0.5 W/mK, particularly larger than 1 W/mK) and a low heat expansion (e.g. smaller than 10 ppm/K, particularly smaller than 100 ppm/K, particularly smaller than 200 ppm/K).

Furthermore, as indicated in FIG. 72, the support frame 51 may comprise grooves 97a, 97b for receiving an electrical cable 97c, respectively. Due to the grooves 97a, 97b, the position of the cables 97c is defined and they are arranged such that a fast assembly process is ensured and the field of view of the tilting plate member 55 is not distorted. Particularly, the wings 97 protruding from the first and the second arm 51a, 51aa of the support frame 51 can each comprise such a groove 97a for receiving a cable 97c. Further, the wings 97 of the third and the fourth arm 51b, 51bb of the support frame 51 can each comprise such a groove 97b for receiving a cable 97c of the optical device 1.

Furthermore, according to an embodiment, the optical device according to FIGS. 46 to 49 may comprise four voice coil motors 815 according to FIG. 71 instead of the actuators 808a, 808aa, 808b, 808bb, wherein each coil 811 is connected to an associated arm 51a, 51aa, 51b, 51bb of the support frame 51 (cf. also FIGS. 50 to 52). Furthermore, the optical device 1 then may preferably comprises four magnetic structures 812 as described in conjunction with FIG. 71, wherein a first magnetic structure 812 is connected to the third arm 301b of the outer frame 301 of the spring structure 300 such that the first magnetic structure 812 faces its associated coil 811 mounted to the third arm 51b of the support frame 51. Further, particularly, a second magnetic structure 812 can be connected to the fourth arm 301bb of the outer frame 301 of the spring structure 300 such that the second magnetic structure 812 faces its associated coil 811 mounted to the fourth arm 51bb of the support frame 51. Further, particularly, a third magnetic structure 812 can be connected to the third arm 302b of the inner frame 302 of the spring structure 300 such that the third magnetic structure 812 faces its associated coil 811 mounted to the first arm 51a of the support frame 51. Further, particularly, a fourth magnetic structure 812 can be connected to the fourth arm 302bb of the inner frame 302 of the spring structure 300 such that the fourth magnetic structure 812 faces its associated coil 811 mounted to the second arm 51aa of the support frame 51. Also here, particularly, a magnetic flux return structure 812c is connected to each magnetic structure 812 as described in connection with FIG. 71.

Furthermore, as shown in FIG. 73 the individual actuators (e.g. electromagnets 808a, 808aa, 808b, 808bb) can be soldered to solder pads 94d of a flexible printed circuit board (also denoted as flex), wherein the respective flex 94d is electrically connected via an electrical connection 94f (e.g. by means of solder or a plug-in connection) to a (more rigid) substrate (e.g. printed circuit board) 94 of the optical device 1. Particularly, due to the soldering connection of the respective actuator the coil (e.g. 813) of the latter is electrically connected to the printed circuit board 94 for receiving the respective holding current pulse.

Furthermore, for actually generating said reluctance forces that hold the carrier parts 33A, 33B in the respective tilted position, the optical device 1 is configured to apply a corresponding holding current pulse HP to the respective coil 813 as shown in FIG. 63. Here AO, A1, BO, and B1 indicate channels to the respective coil, wherein A0 and A1 correspond to opposing coils of actuators 808a, 808aa and B0 and B1 correspond to opposing coils of actuators 808b, 808bb. When the respective holding puls HP ends, the counterforce tilts the respective carrier part (first part 33A or second part 33B) to the other (opposing) stable state where a further holding current pulse holds the respective carrier part 33A, 33B again.

In order to speed up transitions between stable states also accelerating and braking current pulses can be employed in addition as indicated in FIG. 64 for two opposing actuators A0, A1.

The specific parameters, i.e. global parameter like the Hold_Offset which defines the start time of the holding current pulses HP, as well as motor related parameter, such as
AccelerationPulse_Current (to increase transition time)
BrakePulse_Current (to increase transition time)
Hold_Current (angle of device)
AccelerationPulse_Duration (to increase transition time)
BrakePulse_Duration to increase transition time)
Hold_Jitter (adjust transition timing, avoid overshoots)
AccelerationPulse_Offset (expected 0), (adjust transition timing, avoid overshoots)
BrakePulse_Offset (expected 0), (adjust transition timing, avoid overshoots) can be stored in a memory of the optical device 1.

Furthermore, in order to reduce noise generated by the optical device 1 when actuating the tilting movements of the carrier, the optical device 1 can be configured to use holding current pulses HP, accelerating current pulses ΔP and/or braking current pulses BP in the form of a sine (or sinusoidal) signal, particularly in the form of a clipped sine (or sinusoidal) signal as indicated in FIG. 65. Further, as shown in FIGS. 66 (A) to (D) higher frequencies of the holding current pulses HP (and also of the acceleration current pulses ΔP and/or of the braking current pulses BP) may be suppressed, particularly by using one of a low pass filter, a notch filer, a band pass filter.

Here, in the panels from left to right ((A) to (D) of FIG. 66) an increasing fraction of higher frequencies is removed from the holding current pulse HP as can be seen by the increasing oscillatory shape of the respective signal. The original spectrum of excited mechanical frequencies of the 33 that are measured using a holding current pulse without a filter are shown in FIG. 67.

Furthermore, it is to be noted that the plate member 55 can have different optical functions, starting from a mere transparent (e.g. glass) plate for shifting a light beam (e.g. on an image sensor). Particularly, as indicated in FIG. 68 to FIG. 70, the plate member 55 can also be a prism 55 that is tilted by the optical device 1 as described herein about at least one axis so that an incident light angle i is adjusted to an angle of deviation d (beam angle d in FIG. 70) as shown in FIGS. 68 to 70.

Besides the applications already mentioned above, the optical device 1 according to the invention can be used for super resolution imaging but also super resolution projection and is then integrated in an optical assembly, particularly with multiple optical elements. Typical applications include microprojectors, home projectors, business projectors, cinema projectors, entertainment projectors, pico-projectors, head-up displays, head-mounted displays, digital cameras, mobile phone cameras, virtual reality displays, augmented reality displays and machine vision systems, optical witching (e.g. for fiber coupling), state defined optical attenuators, or image stitching.

1. Optical device (1), particularly for enhancing the resolution of an image, comprising:
a transparent plate member (55) configured for refracting a light beam (L) passing through the plate member (55),
a carrier (33) to which said transparent plate member (55) is rigidly mounted, wherein the carrier (33) is configured to be moved between at least a first and a second state, whereby said light beam (L) is shifted,
characterized in that
the carrier (33) is configured to be multistable, particularly bistable or tristable, wherein said first and said second state are stable states of the multistable carrier (33), and wherein the optical device (1) comprises an actuator means (66) that is configured to force or initiate a transition of the carrier (33) from the first stable state to the second stable state and vice versa.

2. Optical device according to claim 1, characterized in that said transition corresponds to a tilting movement of the carrier (33) about a first axis (700).

3. Optical device according to claim 1 or 2, characterized in that the first and the second stable state each correspond to a local minimum (1A, 1B) of the potential energy of the carrier (33), wherein said two stable states (1A, 1B) have the same potential energy or at least substantially the same potential energy.

4. Optical device according to claim 3, characterized in that said local minima (1A, 1B) are each formed by a potential well, wherein each potential well has a depth (2A) corresponding to an activation energy (2A).

5. Optical device according to one of the preceding claims, characterized in that the optical device (1) is configured such that the carrier (33) comprises a potential energy that comprises at least one local maximum (3, 3A, 3B) separating said two stable states (1A, 1B) so as to prevent spontaneous transitions between the two stable states.

6. Optical device according to one of the preceding claims, characterized in that said actuator means (66) is configured to force or initiate a transition between the two stable states by one of:
lowering a potential energy barrier (2A) between the two stable states such that one of the two stable states (1A, 1B) is transformed into an instable state (1k) and thus a transition to the other stable state (1B) is initiated, and by raising said lowered energy barrier back to its initial value after completion of said transition,
lowering a potential energy barrier (2A) between the two stable states to a smaller value and adding an amount of energy (2A′) to initiate the transition, and raising said lowered energy barrier back to its initial value after completion of said transition,
adding an amount of energy that corresponds to a potential energy barrier (2A) between the two stable states (1A, 1B),
applying a potential (15A, 15B, 15C) to force or initiate said transition from one stable state (1A, 1B) to the other stable state (1B, 1A) such that the local minimum of the respective initial stable state (1A, 1B) is raised and the initial stable state (1A) is transformed into an unstable state (1k) which triggers a transition of the carrier (33) to said other stable state (1B),
by applying at least one acceleration pulse or a plurality of acceleration pulses to the carrier (33) to force said transition from one stable state (1A, 1B) to the other stable state (1B, 1A) such that the carrier (33) obtains kinetic energy to climb out of the local minimum of the respective initial stable state (1A) and to overpass said local maximum which triggers a transition of the carrier (33) to said other stable state (1B), wherein optionally residual kinetic energy of the carrier is used to maintain some speed of the carrier upon overpassing of said local maximum.

7. Optical device according to claim 4 or one of the claims 5 to 6 when referring to claim 4, characterized in that said actuator means (33) is configured to a force or initiate a transition between the two stable states (1A, 1B) by adding energy (2C) to the carrier (33) that exceeds the respective activation energy (2A) by an excess energy (2B), wherein particularly said optical device (1) is configured to dissipate said excess energy (2B) after every single transition from one stable state (1A, 1B) to the other stable state (1B, 1A).

8. Optical device according to claim 7, characterized in that said optical device (1) is configured to dissipate said added energy (2C) at least partially or completely after every transition from one of the stable state to the other stable state (1A, 1B).

9. Optical device according to one of the preceding claims, characterized in that the carrier (33) is tristable, wherein said two stable states (1A, 1B) are connected via an intermediate stable state (7) in the form of an intermediate potential well (7) of the potential energy of the carrier (33), which intermediate potential well comprises a local intermediate minimum of the potential energy (4) of the carrier, wherein said intermediate potential (7) well comprises a depth (6), wherein particularly said intermediate potential well (7) forms a global minimum of the potential energy of the carrier (30), and wherein particularly said activation energy (2A) is at least 2 times, particularly at least 10 times, particularly at least 100 times smaller than the depth (6) of the intermediate potential well (7).

10. Optical device according to claim 9, characterized in that the optical device (1) is configured to repeatedly initiate transitions between said two stable states (1A,1B) at a frequency (f1) being at least 2 times, particularly at least 10 times, particularly at least 100 times, particularly at least 1000 times lower than an oscillator frequency (f0) of the carrier (33).

11. Optical device according to one of the claims 9 to 10, characterized in that the actuator means (66) is configured to generate at least one actuation pulse (16) or a plurality of actuation pulses (17A-17D) to force a transition of the carrier (33) from the intermediate stable state (7, 4) to the first or second stable state (1A, 1B), wherein particularly the actuator means (66) is configured to one of:
generating a single actuation pulse (16) that transfers a minimal energy (6) to the carrier (33) sufficient to directly force a transition of the carrier (33) from the intermediate stable state (4) to the first or to the second stable state (1A, 1B),
transferring a minimal energy (6) to the carrier (33) sufficient to force a transition of the carrier (33) from the intermediate stable state (4) to the first or to the second stable state (1A, 1B) in portions using said plurality of actuation pulses (17A-17D)
generating a periodic excitation, in particular a resonant excitation, so as to force a transition from the intermediate stable state (4) to one of the two stable states (1A, 1B) by feeding incremental amounts of energy into the carrier (33) until its kinetic energy is high enough to climb out of the intermediate potential well (7) and to settle into one of the two stable states (1A, 1B).

12. Optical device according to one of the preceding claims, characterized in that the actuator means (66) comprises a clamping means (32A, 33) configured to clamp the carrier (33) in the first stable state (1A) and/or in the second stable state (1B) by exerting a clamping force on the carrier (33).

13. Optical device according to claim 12, characterized in that the clamping means comprises at least one magnet (32A, 32AA), particularly a permanent magnet (32A, 32AA) that is configured to exert a clamping force on the carrier (33).

14. Optical device according to claim 12 or 13, characterized in that the actuator means (66) comprises a disengaging means (31A, 32B) that is configured to cancel said clamping of the carrier (33) in the first and/or in the second stable state (1A, 1B).

15. Optical device according to claim 14, characterized in that the disengaging means (31A, 32B) comprises one of:
at least one coil (31A) and at least one corresponding magnet (32B) for generating a Lorentz force for cancelling said clamping of the carrier (33),
at least one coil (31A) and a magnetic flux return structure provided on the carrier (33) for generating a reluctance force (102B) for cancelling said clamping of the carrier (33),
at least one coil (31A) being configured to superimpose a magnetic field of said at least one magnet (32A) of the clamping means for reducing an attractive reluctance force between the carrier and said at least one magnet (32A) so as to cancel said clamping of the carrier (33),
at least one coil (31A) and an electrically conducting structure on the carrier (33) for generating a Lorenz force by means of eddy currents induced in said structure so as to cancel said clamping of the carrier (33),
an actuator (31C) being configured to exert a force on the carrier (33) for cancelling said clamping of the carrier (33), particularly one of: a piezoelectric actuator, a magnetostrictive actuator, a phase change material, an electroactive polymer, a thermoelectric actuator, a bimetal.

16. Optical device according to one of the preceding claims, characterized in that the optical device (1) comprises a damping means (36) configured to dissipate kinetic energy of the carrier (33) upon movement of the carrier into the first or second stable state (1A, 1B).

17. Optical device according to claim 16, characterized in that, the damping means comprises at least one of:
a mechanical damper (36A, 39),
an eddy current damper (37),
a magnetic damper (38),
an active damper (41).

18. Optical device according to one of the preceding claims, characterized in that the actuator means (66) comprises a rest position defining means (34, 35, 663), wherein the rest position defining means (663) is configured to provide supporting points (61A) for the carrier (33) in the respective rest position of the carrier (33) that corresponds to a stable state (1A, 1B) of the carrier (33).

19. Optical device according to claim 18, characterized in that the rest position defining means (663) comprises for providing the respective supporting point (61A) at least one of: a spring (34), a stop (35), a means for generating a force.

20. Optical device according to claim 12 or 13 and according to claim 18, characterized in that the rest position defining means are formed by the clamping means.

21. Optical device according to one of the claims 12, 13, 20 and according to claim 16 or 17, characterized in that the damping means is integrated into the clamping means.

22. Optical device according to claim 12 or one of the claims 13 to 21 when referring to claim 12, characterized in that the clamping means comprises a magnetic flux guiding structure (73; 73A, 73B, 73C) for guiding the magnetic flux of at least one magnet (32A, 32AA), which structure (73; 73A, 73B, 73C) forms air gaps (G) with a magnetic flux guiding portion (72A, 72B) of the carrier (33) via which air gaps (G) the magnetic flux is guided, or which magnetic flux guiding structure (73A, 37B, 37C) forms an air gap (G) with a magnetic flux guiding portion (72b) of the carrier (33), wherein said magnetic flux guiding structure comprises a spring (30) via which the carrier (33) is elastically supported, wherein the magnetic flux is guided via said air gap (G) and said spring (30).

23. Optical device according to claims 18 to 22, characterized in that the carrier (33) of the optical device (1) comprises four rest positions, each corresponding to a different stable state of the carrier (33), as well as four supporting points (61A), wherein each supporting point (61A) is arranged at an associated edge region (331, 332, 332, 334) of the carrier (33), and wherein the carrier (33) is supported by means of a universal joint (30A, 30B), particularly in an area spanned by the carrier (33), and wherein the actuator means (66) comprises at least two disengaging means (662), particularly four disengaging means (662).

24. Optical device according to claims 18 to 22, characterized in that the carrier (33) of the optical device comprises four rest positions, each corresponding to a different stable state of the carrier (33), as well as two pairs of supporting points (61A), wherein in each pair the two supporting points (61A) are arranged on top of one another, and wherein said pairs (61) are arranged at opposing edge regions or corner regions of the carrier (33), and wherein the carrier (33) is supported by means of a universal joint (30C, 30D, 30E, 30F), particularly in an area spanned by the carrier (33) or outside said carrier (33), and wherein the actuator means (66) comprises at least two disengaging means (662), wherein particularly each disengaging means (662) is arranged at or adjacent an associated supporting point (61A).

25. Optical device according to claims 18 to 22, characterized in that the carrier (33) of the optical device (1) comprises four rest positions, each corresponding to a different stable state of the carrier (33), as well as four pairs of supporting points (61A), wherein in each pair the two supporting points (61A) are arranged on top of one another, and wherein each pair (61A) is arranged at an associated edge region of the carrier (33), and wherein the actuator means (66) comprises at least four disengaging means (662), wherein particularly each disengaging means is arranged at an associated edge region (331, 332, 333, 334) of the carrier (33).

26. Optical device according to claims 18 to 22, characterized in that the carrier (33) of the optical device (1) comprises two rest positions, each corresponding to a different stable state (1A, 1B) of the carrier (33), as well as two supporting points (61A) and a rotational axis (700) crossing an area spanned by the carrier (33), wherein the supporting points (61A) are arranged on opposite sides of the rotation axis (700), wherein each supporting point (61A) is arranged at an associated edge region or corner region of the carrier (33), and wherein the actuator means (66) comprises at least one disengaging means (662) that is particularly arranged on an edge region of the carrier (33).

27. Optical device according to claims 18 to 22, characterized in that the carrier (33) of the optical device (1) comprises two rest positions, each corresponding to a different stable state (1A, 1B) of the carrier (33), as well as two supporting points (61A) arranged on top of one another, and a rotational axis (700) crossing an area spanned by the carrier (33) or extending outside of the carrier (33), wherein the supporting points (61A) are arranged at an edge region or corner region of the carrier, wherein each supporting point (61A) is arranged at an associated edge region or corner region of the carrier (33), and wherein the actuator means (66) comprises at least one disengaging means (662) that is particularly arranged at an edge region or corner region of the carrier (33).

28. Optical device according to claims 18 to 22, characterized in that, the carrier (33) of the optical device (1) comprises two rest positions, each corresponding to a different stable state of the carrier (33), as well as two pairs of supporting points (61A), wherein in each pair the two supporting points (61A) are arranged on top of one another, and wherein each pair (61A) is arranged at an associated edge region or corner region of the carrier (33), and wherein the actuator means (66) comprises at least two disengaging means (662), wherein particularly each disengaging means (662) is arranged at an associated edge region or corner region of the carrier (33).

29. Optical device according to claim 25 or 28, characterized in that for reduction of ringing, the optical device (1) is configured to control two disengaging means (662) such that the control signals sent the two disengaging means (662) are delayed by a time span t_{delay}=1/(2*f_{ch}), where f_{ch} is a oscillation frequency of the carrier (33).

30. Optical device according to one of the preceding claims, characterized in that the carrier (33) is connected via springs (30, 30A) to a support frame (51) so that the carrier (33) can be tilted about a first axis (700) between said first and said second state with respect to said support frame (51).

31. Optical device according to claim 30, characterized in that the carrier (33) comprises a first part (33A) that is connected via said springs (30A) to said support frame (51) and a second part (33B) that is connected via springs (30B) to the first part (33A), so that the second part (33B) can be tilted about a second axis (701) with respect to the first part (33A) between a first and a second state of the second part (33B) whereby particularly said light beam (L) is shifted, and wherein the transparent plate member (55) is rigidly mounted to the second part (33B) of the carrier (33), wherein said second part (33B) is configured to be bistable or tristable, too, and wherein said first and said second state of the second part (33B) are stable states of the bistable or tristable second part (33B), and wherein the actuator means (66) is configured to force or initiate a transition of the second part (33B) from its first stable state to its second stable state and vice versa.

32. Optical device according one of the preceding claims, characterized in that the actuator means (66) comprises a plurality of electrically conducting coils (31A) and a corresponding plurality of magnets (32B).

33. Optical device according claims 30 and 32, characterized in that the coils are arranged on the support frame (51) and that the magnets (32B) are arranged on the carrier (33).

34. Optical device according claim 32 or 33, characterized in that each magnet (32B) is associated to exactly one of the coils (31A).

35. Optical device according to one of the claims 32 to 34, characterized in that the respective magnet (32B) is configured to move above the associated coil (31A), wherein the magnetic flux of the respective magnet extends parallel to the face side of the respective magnet and through the respective coil along an extension plane of the respective coil.

36. Optical device according to one of the claims 32 to 34, characterized in that a magnetic flux guiding member (40B) is attached to a face side (400B) of the respective magnet (32B), which face side faces the associated coil (31A), and wherein said magnetic flux guiding member (40B) forms a magnetic flux return structure with a region (40C) of the carrier (33) for the magnetic field of the respective magnet (32B), and wherein the respective magnetic flux guiding member (40B) is configured to move into a central opening of the associated coil (31A), wherein the magnetic flux of the respective magnet extends parallel to the face side of the magnet in said magnetic flux guiding member of the respective magnet and through the respective coil along an extension plane of the respective coil.

37. Optical device according to one of the claims 32 to 35, characterized in that the respective magnet (32B) is configured to generate a magnetic field that is oriented parallel to a winding axis (W) of the associated coil (31A) at the face side (400B) of the respective magnet (32B).

38. Optical device according to one of the preceding claims, characterized in that the actuator means (66) is a mechanical bistable actuator means (66) that comprises a middle plate (89A) that is connected, particularly integrally connected, via at least two angle plates (89A) to a support (88) such that the middle plate (89A) is bistable and comprises two stable states corresponding to two different positions of the middle plate with respect to the support (88), wherein the middle plate (89A) is connected to the carrier (33) and wherein an actuator (660) is provided that is configured to force a transition of the middle plate (89A) from one stable state to the other stable state of the middle plate (89A) which yields a corresponding transition of the carrier (33) between its two stable states (1A, 1B).

39. Optical device according to one of the preceding claims, characterized in that the carrier (69a) is connected, particularly integrally connected, to a support (68a, 68c) of the optical device (1) such that it is bistable and comprises two positions with respect to the support corresponding to a first and a second stable state (1A, 1B) or that it is quadristable and comprises four positions (66, 61, 62, 63) with respect to the support corresponding to four stable states.

40. Optical device according to claim 39, characterized in that the carrier (69a) is connected on a side of the carrier via a joint (64) to an angle plate (69b) which in turn is connected via a further joint (64) to the support (68a), and wherein the carrier is connected on an opposing side via a single joint (64) and a spring (67) to the support (68c), wherein particularly said spring may be integrally formed with said single joint (64).

41. Optical device according to claim 39, characterized in that the carrier (69a) is connected on a side of the carrier via a joint (64) to an angle plate (69b) which in turn is connected via a further joint (64) to the support (68a), and wherein the carrier is connected on an opposing side via a joint (64) to an angle plate (69b) which in turn is connected via a further joint (64) to the support (68c), wherein particularly a spring (67) may connect the further joint (64) to the support (68c) or may be integrally formed with the support (68b, 68c), or may be formed integrally with the joint (64) and/or the further joint (64) on said opposing side of the carrier (69a).

42. Optical device according to claim 41, characterized in that said joints (64) each comprise at least one torsion beam (64A).

43. Optical device according to one of the preceding claims, characterized in that the actuator means (66) comprises at least one electropermanent magnet (807) that forms a gap (G0) with a magnetic flux guiding region (801) of the carrier (33) for holding the carrier (33) in one of the stable states by exerting a reluctance force (102A) on said magnetic flux guiding region (801) of the carrier (33), wherein particularly in said stable state said reluctance force (102A) balances a counterforce (110A) acting on the carrier (33) such that the electropermanent magnet (807) does not contact said magnetic flux guiding region (801), and particularly such that when the reluctance force is turned off the carrier (33) is moved to the other stable state by means of said counterforce (100A).

44. Optical device according to one of the claims 1 to 42, characterized in that the actuator means (66) comprises at least one electromagnet (808) that forms a gap (G0) with a magnetic flux guiding region (801) of the carrier (33) for holding the carrier (33) in one of the stable states by exerting a reluctance force (102A) on said magnetic flux guiding region (801) of the carrier (33), wherein particularly in said stable state said reluctance force (102A) balances a counterforce (110A) acting on the carrier (33) such that the electromagnet (808) does not contact said magnetic flux guiding region (801), and particularly such that when the reluctance force is turned off the carrier (33) is moved to the other stable state by means of said counterforce (100A).

45. Optical device according to one of the claims 1 to 42, characterized in that the actuator means (66) comprises at least one voice coil motor (815), the voice coil motor comprising a coil (811) and an associated magnetic structure (812) comprising two permanent magnets or sections (812a, 812b) arranged on top of one another having an anti-parallel magnetization, wherein the magnetic structure (812) is connected to the carrier (33), wherein the voice coil motor is configured to hold the carrier (33) in one of the stable states by exerting a Lorentz force (102A) on said carrier (33), wherein particularly in said stable state said Lorentz force (102A) balances a counterforce (110A) acting on the carrier (33), particularly such that when the Lorentz force is turned off the carrier (33) is moved to the other stable state by means of said counterforce (100A), and wherein particularly a magnetic flux return structure (812c) is arranged on a side of the magnetic structure that faces away from the coil (811), wherein the magnetic flux return structure (812c) connects the two magnets or sections (812a, 812b) to one another.

46. Optical device according to claim 30, characterized in that the actuator means (66) comprises a first electropermanent magnet (807a) that forms a first gap (G1) with a first magnetic flux guiding region (801a) of the carrier (33) for holding the carrier in the first stable state by exerting a force on said first magnetic flux guiding region (801a) of the carrier (33), wherein particularly in said first stable state said force balances a counterforce that acts on the carrier (33) such that the first electropermanent magnet (807a) does not contact said first magnetic flux guiding region (801a), and particularly such that when the force is turned off, the carrier (33) is moved to the second stable state by means of said counterforce.

47. Optical device according to claim 46, characterized in that, the actuator means (66) comprises a second electropermanent magnet (807aa) that forms a second gap (G2) with a second magnetic flux guiding region (801aa) of the carrier (33) for holding the carrier (33) in the second stable state by exerting a force on said second magnetic flux guiding region (801aa) of the carrier (33), wherein particularly in said second stable state said force balances a counterforce that acts on the carrier (33) such that the second electropermanent magnet (807aa) does not contact said second magnetic flux guiding region (801aa), and particularly such that when the force is turned off, the carrier (33) is moved to the first stable state by means of said counterforce.

48. Optical device according to claims 31 and 47, characterized in that the actuator means comprises a third electropermanent magnet (807b) that forms a third gap (G3) with a third magnetic flux guiding region (801b) of the second part (33B) of the carrier (33) for holding the second part (33B) of the carrier in its first stable state by exerting a force on said third magnetic flux guiding region of the second part (33B) of the carrier (33), wherein particularly in said first stable state said force balances a counterforce that acts on the second part (33B) of the carrier (33) such that the third electropermanent magnet (807b) does not contact said third magnetic flux guiding region, and particularly such that when the force is turned off, the second part (33B) of the carrier is moved to its second stable state by means of said counterforce.

49. Optical device according to claim 48, characterized in that the actuator means comprises a fourth electropermanent magnet (807bb) that forms a fourth gap (G4) with a fourth magnetic flux guiding region (801bb) of the second part (33B) of the carrier (33) for holding the second part (33B) of the carrier in the second stable state by exerting a force on said fourth magnetic flux guiding region of the second part (33B) of the carrier, wherein particularly in said second stable state said force balances a counterforce that acts on the second part (33B) of the carrier (33) such that the fourth electropermanent magnet (807bb) does not contact said fourth magnetic flux guiding region (801bb), and particularly such that when the force is turned off, the second part of the carrier is moved to its first stable state by means of said counterforce.

50. Optical device according to claim 47, characterized in that the optical device comprises a further carrier (333) to which a further transparent plate member (555) is rigidly mounted, wherein the further carrier (333) is configured to be moved between at least a first and a second state, whereby said light beam (L) is shifted, and wherein the further carrier (333) is configured to be multistable, particularly bistable or tristable, wherein said first and said second state are stable states of the multistable further carrier (333), and wherein said actuator means (66) is configured to force a transition of the further carrier (333) from the first stable state to the second stable state of the further carrier (333) and vice versa, and wherein said further carrier (333) is connected via springs (30C) to the support frame (51) so that the further carrier (333) can be tilted about a second axis (701) between said first stable state and said second stable state with respect to said support frame (51), whereby particularly said light beam is shifted.

51. Optical device according to claim 50, characterized in that the actuator means (66) comprises a third electropermanent magnet (807b) that forms a third gap (G3) with a third magnetic flux guiding region (801b) of the further carrier (333) for holding the further carrier (333) in its first stable state by exerting a force on the said third magnetic flux guiding region (801b) of the further carrier (333), wherein particularly in said first stable state said force balances a counterforce that acts on the further carrier (333) such that the third electropermanent magnet does not contact said third magnetic flux guiding region, and particularly such that when the force is turned off the further carrier (333) is moved to its second stable state by means of said counterforce.

52. Optical device according to claim 51, characterized in that the actuator means (66) comprises a fourth electropermanent magnet (807bb) that forms a fourth gap (G4) with a fourth magnetic flux guiding region (801bb) of the further carrier (333) for holding the further carrier (333) in the second stable state by exerting a force on said fourth magnetic flux guiding region of the further carrier (333), wherein particularly in said second stable state said force balances a counterforce that acts on the further carrier (333) such that the fourth electropermanent magnet (807bb) does not contact said fourth magnetic flux guiding region (801bb), and particularly such that when the force is turned off the further carrier (333) is moved to its first stable state by means of said counterforce.

53. Optical device according to claims 43 to 52, characterized in that the respective electropermanent magnet (807, 807a, 807aa, 807b, 807bb) comprises a first magnet (805) having a first magnetization (M1) and a first coercivity, and a second magnet (804) having a second coercivity being smaller than the first coercivity, and wherein an electrically conducting conductor (803) is wound around the second magnet and/or around a magnetic flux guiding structure of the respective electropermanent magnet to form a coil (803), so that when a voltage pulse is applied to the coil (803) the magnetization (M2) of the second magnet (804) is switched and a magnetic flux is generated that generates said force.

54. Optical device according to claim 53, characterized in that the second magnet (804) extends around the first magnet (805) or vice versa.

55. Optical device according to one of the claims 53 to 54, characterized in that said conductor (803) is also wound around the first magnet (805) so that said coil (803) encloses the second magnet (804) and the first magnet (805).

56. Optical device according to claim 53 or 54, characterized in that said a further separate conductor (803a) is wound around the first magnet (805) to form a further coil (803a).

57. The optical device according to one of the claims 53 to 56, characterized in that the respective electropermanent magnet (807, 807a, 807aa, 807b, 807bb) comprises a magnetic flux guiding structure (802) connected to the magnets, which magnetic flux guiding structure (802) forms the respective gap (G0, G1, G2, G3, G4) with the respective magnetic flux guiding region (801, 801a, 801aa, 801b, 801bb).

58. The optical device according to claim 57, characterized in that the magnetic flux guiding structure comprises two spaced apart elements (802) between which said first magnet (805) and said second magnet (804) are arranged, such that each magnet (805, 804) contacts both elements (802), wherein each element (802) comprises a face side (802f) facing the respective magnetic flux guiding region (801, 801a, 801aa, 801b, 801bb), which face sides (802f) form the respective gap (G0, G1, G2, G3, G4) with the respective magnetic flux guiding region (801, 801a, 801aa, 801b, 801bb).

59. Optical device according to claim 53, characterized in that that the respective electropermanent magnet (807, 807a, 807aa, 807b, 807bb) comprises a further first magnet (805), wherein the second magnet (804) is arranged between the two first magnets (805), and wherein the second and the two first magnets (804, 805) are arranged with a bottom side on a magnetic flux guiding structure (802) respectively, and wherein the second and the two first magnets (804, 805) each comprise an opposing top side (804f, 805f), which top sides form the respective gap (G0, G1, G2, G3, G4) with the respective magnetic flux guiding region (801, 801a, 801aa, 801b, 801bb).

60. Optical device according to claim 56, characterized in that the second and the first magnet (804, 805) are arranged with a bottom side on a magnetic flux guiding structure (802), respectively, and wherein the second and the first magnet (804, 805) each comprise an opposing top side (804f, 805f), which top sides particularly form the respective gap (G0, G1, G2, G3, G4) with the respective magnetic flux guiding region (801, 801a, 801aa, 801b, 801bb).

61. Optical device according to claim 60, characterized in that the magnetic flux guiding structure (802) comprises lateral portions (802p), wherein said second and first magnet (804, 805) are arranged between said lateral portions, and wherein said lateral portions form the respective gap (G0, G1, G2, G3, G4) with the respective magnetic flux guiding region (801, 801a, 801aa, 801b, 801bb).

62. Optical device according to claim 60 or 61, characterized in that the top side (804f) of the second magnet (804) covers the top side (805f) of the first magnet (805).

63. Optical device according to claim 56, characterized in that the second and the first magnet (804, 805) each comprise a top side (804f, 805f) and an opposing bottom side (804g, 805g), wherein the top side (804f) of the second magnet (804) covers the top side (805f) of the first magnet (805) and wherein the bottom side (804g) of the second magnet (804) the bottom side (805g) of the first magnet (805), wherein the top side (804f) of the second magnet (804) forms the respective gap (G0, G1, G2, G3, G4) with the respective magnetic flux guiding region (801, 801a, 801aa, 801b, 801bb).

64. Optical device according to claims 53 to 63, characterized in that the respective electropermanent magnet (807, 807a, 807aa, 807b, 807bb) is arranged between a first and a second member (8011, 8012) of the respective magnetic flux guiding region (801) so that the respective electropermanent magnet (807, 807a, 807aa, 807b, 807bb) forms the respective gap (G0, G1, G2, G3, G4) with the first member (8011) and a further gap (GOO) with said second member (8012).

65. Optical device according to one of the claims 53 to 64, characterized in that at least one first permanent magnet (32) is connected to the respective magnetic flux guiding region (801) or to the carrier (33) for generating a repulsive or attractive force that pushes the respective magnetic flux guiding region (801) or carrier away from the respective electropermanent magnet (807) or towards the respective electropermanent magnet (807).

66. Optical device according to one of the preceding claims, characterized in that the respective electropermanent magnet (807, 807a, 807aa, 807b, 807bb) is connected to a support (809), particularly to said support frame (51).

67. Optical device according to claim 66, characterized in that at least one second permanent magnet (32) is connected to the support (809) adjacent the respective electropermanent magnet (807) for generating a repulsive force that pushes the respective magnetic flux guiding region (801) or carrier (33) away from the respective electropermanent magnet (807).

68. Optical device according to one claim 53, characterized in that the first magnet is formed as a ring magnet (805) comprising a central opening in which a magnetic flux guiding element (802m) is arranged, wherein the coil 803 is wound around the second magnet (804) that is arranged below said element (802m), and wherein the coil (803) is enclosed by a circumferential wall (802p) of a magnetic flux guiding structure (802), and wherein the coil (803) is arranged below said ring magnet (805).

69. Optical device according to one of the claims 53 to 68, characterized in that the optical device (1) comprises at least one voltage source (Vin) for generating said voltage pulse.

70. Optical device according to claim 69, characterized in that the respective electropermanent magnet (807, 807a, 807b, 807bb) comprises at least four switches (S1, S2, S3, S4) via which the voltage source (Vin) is connectable to the coil (803).

71. Optical device according to claim 69, characterized in that the optical device (1) comprises at least six switches (S1, S2, S3_1, S4_1, S3_2, S4_2) via which the at least one voltage source (Vin) is connectable to the at least two coils (803, 803a).

72. Optical device according to one of the claims 53 to 71, characterized in that the at least one voltage source (Vin) is configured to control the magnetization (M2) of the second magnet (804) by altering the length of the voltage pulses applied to the coil (803) and/or to the further coil (803a), or alternatively by altering the voltage of these voltage pulses while keeping the pulse length constant.

73. Optical device according to one of the claims 53 to 72, characterized in that the at least one voltage source (Vin) is configured to shape the current in said coil (803) and/or further coil (803a) so as to achieve noise reduction of the optical device (1), particularly by applying pulse-width modulation to the voltage applied to the coil (803) and/or to further coil (803a) by the voltage source (Vin).

74. Optical device according to claims 53, 56 and 69, characterized in that the voltage source (Vin) is configured to apply a voltage pulse to the further coil (803a) when applying said voltage pulse to said coil (803) so that upon switching of the magnetization (M2) of the second magnet (804) the magnetic flux through the respective magnetic field guiding region (801, 801a, 801aa, 801b, 801bb) is reduced or turned off.

75. Optical device according to claim 30 or 31, characterized in that the carrier (33) comprises a spring structure (300), which spring structure (300) comprises an outer frame (301), wherein said springs (30A) that connect the carrier (33) to the support frame (51) are integrally connected to the outer frame (301) of the spring structure (300).

76. Optical device according to claim 75, characterized in that said springs (30A) that connect the carrier (33) to the support frame (51) are formed by two first torsion bars (30A), wherein one first torsion bar (30A) protrudes from a first arm (301a) of the outer frame (301) of the spring structure (300) while the other first torsion bar (30A) protrudes from a second arm (301aa) of the outer frame (301) of the spring structure (300), which second arm (301aa) opposes the first arm (301a) of the outer frame (301) of the spring structure (300), and wherein said first torsion bars (30A) are aligned with each other and define said first axis (700), and wherein said first and said second arm (301a, 301aa) of the outer frame (301) are integrally connected by a third arm (301b) and a fourth arm (301bb) of the outer frame (301) of the spring structure (300).

77. Optical device according to claim 75 or 76, characterized in that the spring structure (300) comprises an inner frame (302), wherein the outer frame (301) surrounds the inner frame (302), and wherein said springs (30B) that connect the second part (33B) of the carrier (33) to the first part (33A) of the carrier (33) integrally connect the inner frame (302) of the spring structure (300) to the outer frame (301) of the spring structure (300).

78. Optical device according to claims 76 and 77, characterized in that said springs (30B) that connect the inner frame (302) of the spring structure (300) to the outer frame (301) of the spring structure (300) are formed by two second torsion bars (30B), wherein one second torsion bar (30B) extends from a first arm (302a) of the inner frame (302) of the spring structure (300) to the third arm (301b) of the outer frame (301) of the spring structure (300), and wherein the other second torsion bar (30B) extends from a second arm (302aa) of the inner frame (302) of the spring structure (300) to the fourth arm (301bb) of the outer frame (301) of the spring structure (300), and wherein said second torsion bars (30B) are aligned with each other and define said second axis (701), and wherein the first and the second arm (302a, 302aa) of the inner frame of the spring structure (300) are integrally connected by a third arm (302b) and by a fourth arm (302bb) of the inner frame (302) of the spring structure (300), wherein the third arm (302b) of the inner frame (302) of the spring structure (300) opposes the fourth arm (302bb) of the inner frame (302) of the spring structure (300).

79. Optical device according to claim 76 or according to one of the claims 77 to 78 when referring to claim 76, characterized in that each first torsion bar (30A) is integrally connected to a fastening region (303, 304), wherein the carrier (33) is connected via said fastening regions (303, 304) to the support frame (51).

80. Optical device according to claim 79, characterized in that one of said fastening regions (303) comprises elongated holes (303a) for mounting this fastening region (303) to the support frame (51) and wherein the other fastening region (304) comprises a marker (307), particularly in form of a recess.

81. Optical device according to one of the claims 75 to 80, characterized in that the carrier (33) comprises a reinforcing structure (310) that is connected to the spring structure (300).

82. Optical device according to claim 81, characterized in that the reinforcing structure (310) comprises an outer reinforcing frame (311) and an inner reinforcing frame (312), wherein the inner reinforcing frame (312) is connected to the inner frame (302) of the spring structure (300), and wherein the outer reinforcing frame (311) is connected to the outer frame (301) of the spring structure (300).

83. Optical device according to claim 82, characterized in that the plate member (55) is connected, particularly glued, to the inner reinforcing frame (312).

84. Optical device according to claim 82 or 83, characterized in that the outer reinforcing frame (311) is connected to the outer frame (301) of the spring structure (300) by one of: a glue connection, a weld connection, screws, rivets; and/or wherein the inner reinforcing frame is connected to the inner frame of the spring structure by one of: a glue connection, a weld connection, screws, rivets.

85. Optical device according to one of the claims 82 to 84, characterized in that the outer reinforcing frame (311) comprises a first arm (311a) and an opposing second arm (311aa), wherein the first and the second arm (311a, 311aa) of the outer reinforcing frame (311) are connected by a third and a fourth arm (311b, 311bb) of the outer reinforcing frame (311), wherein particularly at least one arm or each arm (311a. 311a, 311b, 311bb) of the outer reinforcing frame (311) comprises an angled section (313) having a height (H), which height (H) is larger than a thickness (B) of the angled section (313) perpendicular to said height (H).

86. Optical device according to claim 85, characterized in that a top side of the first arm (311a) of the outer reinforcing frame (311) is connected to a bottom side of the first arm (301a) of the outer frame (301) of the spring structure (300), and wherein a top side of the second arm (311aa) of the outer reinforcing frame (311) is connected to a bottom side the second arm (301aa) of the outer frame (301) of the spring structure (300), and wherein a top side of the third arm (311b) of the outer reinforcing frame (311) is connected to a bottom side of the third arm (301b) of the outer frame (301) of the spring structure (300), and wherein a top side of the fourth arm (311bb) of the outer reinforcing frame (311) is connected to a bottom side of the fourth arm (301bb) of the outer frame (301) of the spring structure (300).

87. Optical device according to one of the claims 82 to 86, characterized in that the inner reinforcing frame (312) comprises a first arm (312a) and an opposing second arm (312aa), wherein the first and the second arm (312a, 312aa) of the inner reinforcing frame (312) are connected by a third and a fourth arm (312b, 312bb) of the inner reinforcing frame (312), wherein particularly at least one arm or each arm (312a. 312a, 312b, 312bb) of the inner reinforcing frame (312) comprises an angled section (314) having a height (H′), which height (H′) is larger than a thickness (B′) of the angled section (314) perpendicular to said height (H′).

88. Optical device according to claim 87, characterized in that a top side of the first arm (312a) of the inner reinforcing frame (312) is connected to a bottom side of the first arm (302a) of the inner frame (302) of the spring structure (300), and wherein a top side of the second arm (312aa) of the inner reinforcing frame (312) is connected to a bottom side of the second arm (302aa) of the inner frame (302) of the spring structure (300), and wherein a top side of the third arm (312b) of the inner reinforcing frame (312) is connected to a bottom side of the third arm (302b) of the inner frame (302) of the spring structure (300), and wherein a top side of the fourth arm (312bb) of the inner reinforcing frame (312) is connected to a bottom side of the fourth arm (302bb) of the inner frame (302) of the spring structure (300).

89. Optical device according to one of the claims 82 to 88, characterized in that an inner edge (311c) of the outer reinforcing frame (311) comprises recesses (311d) for welding the outer reinforcing frame (311) to the outer frame (301) of the spring structure (300).

90. Optical device according to one of the claims 82 to 89, characterized in that an outer edge (312c) of the inner reinforcing frame (312) comprises recesses (312d) for welding the inner reinforcing frame (312) to the inner frame (302) of the spring structure (300).

91. Optical device according to claim 76 and according to one of the claims 82 to 90, characterized in that an inner edge (311c) of the outer reinforcing frame (311) comprises two opposing recesses (311e) for avoiding a contact between the first torsion bars (30A) and the outer reinforcing frame (311).

92. Optical device according to claim 30 or one of the claims 75 to 91 when referring to claim 30, characterized in that for determining the spatial position of the plate member (55) the optical device (1) comprises at least one Hall sensor (90) connected to the support frame (51), which Hall sensor (90) is configured to sense a magnetic field generated by a magnet (91) of the optical device (1), wherein the at least one Hall sensor (90) faces said magnet (91).

93. Optical device according to claims 87 and 92, characterized in that the inner reinforcing frame (312) comprises at least one wing (92) protruding from the third or from the fourth arm (312b, 312bb) of the inner reinforcing frame (312), wherein said magnet (91) is arranged on said at least one wing (92).

94. Optical device according to claim 79 or according to one of the claims 80 to 93 when referring to claim 79, characterized in that the support frame (51) comprises a first arm (51a) and an opposing second arm (51aa), wherein the first and the second arm (51a, 51aa) are connected by a third and a fourth arm (51b, 51bb), and wherein one of said fastening regions (303) is connected to the first arm (51a) while the other fastening region (304) is connected to the second arm (51aa).

95. Optical device according to claim 94, characterized in that the third and the fourth arm (51b, 51bb) each comprise an opening (51c) for increasing the field of view of light incident on the optical device (1).

96. Optical device according to claim 94 or 95, characterized in that the first arm (51a) of the support frame (51) and the second arm (51aa) of the support frame (51) each comprise a bulge (51d) on which the respective fastening region (303, 304) is mounted, or that one of the fastening regions (303) is mounted via an intermediate plate (51e) to the first arm (51a) of the support frame (51) and that the other fastening region (304) is mounted via an intermediate plate (51e) to the second arm (51aa) of the support frame (51).

97. Optical device according to one of the claims 94 to 96, characterized in that the support frame (51) comprises four legs (98) for mounting the support frame (51) to a further part, wherein two opposing legs (98) protrude from the first arm (51a) of the support frame (51), and wherein two further opposing legs (98) protrude from the second arm (51aa) of the support frame (51).

98. Optical device according to claim 97, characterized in that each leg (98) comprises a mounting portion (98a) for mounting the support frame (51) to said further part and a bridge portion (98b) integrally connected to the mounting portion (98a) wherein the mounting portion (98a) is connected to the support frame (51) via the bridge portion (98b), wherein the bridge portion (98b) comprises a width that is smaller than a width of the mounting portion (98a).

99. Optical device according to claim 98, characterized in that each mounting portion comprises a recess (98c) for receiving a grommet (99).

100. Optical device according to one of the claims 30 to 99, characterized in that at least one separate mass (95) body is mounted on the support frame (51), particularly for increasing the moment of inertia of the support frame and therewith particularly stability of the optical device (1).

101. Optical device according to one of the claims 30 to 100, characterized in that the support frame (51) comprises grooves (97a, 97b), wherein each of said grooves (97a, 97b) is configured to receive at least one electrical cable (97c) of the optical device (1).

102. Optical device according to claim 30 or according to one of the claims 75 to 101 when referring to claim 30, characterized in that the actuator means (66) comprises a first electromagnet (808a) that forms a first gap (G1) with a first magnetic flux guiding region (801a) of the carrier (33) for holding the carrier (33) in the first stable state by exerting a reluctance force on said first magnetic flux guiding region (801a) of the carrier (33), wherein particularly in said first stable state said reluctance force balances a counterforce that acts on the carrier (33) such that the first electromagnet (808a) does not contact said first magnetic flux guiding region (801a), and particularly such that when the reluctance force is turned off, the carrier (33) is moved to the second stable state by means of said counterforce.

103. Optical device according to claim 102, characterized in that, the actuator means (66) comprises a second electromagnet (808aa) that forms a second gap (G2) with a second magnetic flux guiding region (801aa) of the carrier (33) for holding the carrier (33) in the second stable state by exerting a reluctance force on said second magnetic flux guiding region (801aa) of the carrier (33), wherein particularly in said second stable state said reluctance force balances a counterforce that acts on the carrier (33) such that the second electromagnet (808aa) does not contact said second magnetic flux guiding region (801aa), and particularly such that when the reluctance force is turned off, the carrier (33) is moved to the first stable state by means of said counterforce.

104. Optical device according to claim 31 and according to claim 103, characterized in that the actuator means comprises a third electromagnet (808b) that forms a third gap (G3) with a third magnetic flux guiding region (801b) of the second part (33B) of the carrier (33) for holding the second part (33B) of the carrier in its first stable state by exerting a reluctance force on said third magnetic flux guiding region of the second part (33B) of the carrier (33), wherein particularly in said first stable state said reluctance force balances a counterforce that acts on the second part (33B) of the carrier (33) such that the third electromagnet (808b) does not contact said third magnetic flux guiding region, and particularly such that when the reluctance force is turned off, the second part (33B) of the carrier is moved to its second stable state by means of said counterforce.

105. Optical device according to claim 104, characterized in that the actuator means comprises a fourth electromagnet (808bb) that forms a fourth gap (G4) with a fourth magnetic flux guiding region (801bb) of the second part (33B) of the carrier (33) for holding the second part (33B) of the carrier in the second stable state by exerting a reluctance force on said fourth magnetic flux guiding region of the second part (33B) of the carrier, wherein particularly in said second stable state said reluctance force balances a counterforce that acts on the second part (33B) of the carrier (33) such that the fourth electro magnet (808bb) does not contact said fourth magnetic flux guiding region (801bb), and particularly such that when the reluctance force is turned off, the second part (33B) of the carrier is moved to its first stable state by means of said counterforce.

106. Optical device according to one of the claims 102 to 105, characterized in that the respective counterforce and the respective reluctance force are dimensioned such that the respective gap (G1, G2, G3, G4) is prevented from being closed completely.

107. Optical device according to one of the claims 102 to 106, characterized in that the respective electromagnet (808a, 808aa, 808b, 808bb) comprises an electrically conducting coil (813) wound around a coil core (814), which coil core (814) comprises two opposing end sections (814a, 814b), which end sections (814a, 814b) form the respective gap (G1, G2, G3, G4) with the associated magnetic flux guiding region (801a, 801aa, 801b, 801bb).

108. Optical device according to claims 30 and 107, characterized in that the respective coil core (814) is connected to the support frame (51), wherein particularly the respective coil core (814) is glued to the support frame (51).

109. Optical device according to one of the preceding claims, characterized in that the optical device (1) comprises a rigid substrate (94), particularly a printed circuit board, wherein at least one or a plurality of flexible printed circuit boards (94d) protrude from said substrate (94), wherein the respective flexible printed circuit board (94d) comprises solder pads (94e) for making an electrical connection to an actuator of the optical device (1), particularly to the respective electromagnet (808a, 808aa, 808b, 808bb).

110. Optical device according to claim 107 or according to one of the claims 108 to 109 when referring to claim 107, characterized in that the optical device (1) is configured to apply a holding current pulse (HP) to the respective coil (813) to generate the respective reluctance force, wherein a maximal tilting angle of the plate member (55) is adjustable by adjusting a magnitude of the holding current pulse (HP).

111. Optical device according to claim 110, characterized in that the optical device (1) is configured to apply an accelerating current pulse (AP) before the holding current pulse (HP) to the respective coil (813) to accelerate a transition between two stable states of the first or second part (33A, 33B) of the carrier (33).

112. Optical device according to claim 111, characterized in that the optical device (1) is configured to apply a braking current pulse (BP) before the holding current pulse (HP) and after the accelerating current pulse (AP) to a coil (813) opposing the respective coil (813) to which said accelerating current pulse (AP) and/or holding current pulse (HP) are applied to slow down a transition between two stable states of the first or second part (33A), (33B) of the carrier (33).

113. The optical device according to one of the claims 110 to 112, characterized in that the optical device (1) is configured to reduce noise generated by the optical device by at least one of:
suppressing higher frequencies of the holding current pulses (HP), the acceleration current pulses (AP), and/or the braking current pulses (BP), particularly using one of a low pass filter, a notch filer, a band pass filter,
using holding current pulses (HP), accelerating current pulses (AP) and/or braking current pulses (BP) in the form of a sine signal, particularly in the form of a clipped sine signal.

114. Optical device according to one of the preceding claims, characterized in that the plate member (55) is a rigid prism.
